(19) United States
(12) Patent Application Publication
(10) Pub. No.: US 2024/0427152 A1
(43) Pub. Date: Dec. 26, 2024

(54) Anamorphic directional illumination device

(71) Applicant: RealD Spark, LLC, BOULDER, CO (US)

(72) Inventors: Michael G Robinson, BOULDER, CO (US); Graham J. Woodgate, Henley-on-Thames (GB)

(21) Appl. No.: 18/734,193

(22) Filed: Jun. 5, 2024

Related U.S. Application Data
(60) Provisional application No. 63/521,906, filed on Jun. 20, 2023.

(51) Int. Cl. G02B 27/01; F21V 8/00; G02B 1/11; G02B 13/08; G02B 27/00

(52) U.S. Cl. CPC G02B 27/0172; G02B 1/11; G02B 6/003; G02B 6/0041; G02B 6/0078; G02B 13/08; G02B 27/0068; G02B 2027/0112

(57) ABSTRACT

An anamorphic near-eye display apparatus comprises a spatial light modulator with asymmetric pixels; an input transverse anamorphic lens; an input waveguide that passes input light in a first direction to a partially reflective mirror, an intermediate waveguide comprising a reflective lateral anamorphic component arranged to receive light from the partially reflective mirror and to provide imaging of the spatial light modulator in the lateral direction; and an extraction waveguide arranged to receive light from the reflective lateral anamorphic component. Reflective extraction elements are arranged to extract the imaged light towards the pupil of an observer, maintaining the directionality of the fan of light rays from the spatial light modulator and anamorphic imaging system. A thin, transparent and efficient anamorphic display apparatus for Augmented Reality and Virtual Reality displays is provided.

### TECHNICAL FIELD

This disclosure generally relates to near-eye display apparatuses and illumination systems therefor.

### BACKGROUND

Head-worn displays incorporating a near-eye display apparatus may be arranged to provide fully immersive imagery such as in virtual reality (VR) displays or augmented imagery overlayed over views of the real world such as in augmented reality (AR) displays. If the overlayed imagery is aligned or registered with the real-world image it may be termed Mixed Reality (MR). In VR displays, the near-eye display apparatus is typically opaque to the real world, whereas AR displays the optical system is partially transmissive to light from the real world.

The near-eye display apparatuses of AR and VR displays aim to provide images to at least one eye of a user with full colour, high resolution, high luminance and high contrast; and with wide fields of view (angular size of image), large eyebox sizes (the geometry over which the eye can move while having visibility of the full image field of view). Such displays are desirable in thin form factors, low weight and with low manufacturing cost and complexity.

Further, AR near-eye display apparatuses aim to have high transmission of real-world light rays without image distortions or degradations and reduced glare of stray light away from the display wearer. AR optics may broadly be categorised as reflective combiner type or waveguide type. Waveguide types typically achieve reduced form factor and weight due to the optical path folding within the waveguide. Known methods for injecting images into a waveguide may use a spatial light modulator and a projection lens arrangement with a prism or grating to couple light into the waveguide. Pixel locations in the spatial light modulator are converted to a fan of ray directions by the projection lens. In other arrangements a laser scanner may provide the fan of ray directions. The angular locations are propagated through the waveguide and output to the eye of the user. The eye's optical system collects the angular locations and provides spatial images at the retina.

### BRIEF SUMMARY

According to a first aspect of the present disclosure, there is provided an anamorphic near-eye display apparatus comprising: an illumination system comprising a spatial light modulator, the illumination system arranged to output light; and an optical system arranged to direct light from the illumination system to a viewer's eye, wherein the optical system has an optical axis and has anamorphic properties in a lateral direction and a transverse direction that are perpendicular to each other and perpendicular to the optical axis, wherein the spatial light modulator comprises pixels distributed in the lateral direction, and the optical system comprises: a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction; an input waveguide arranged to receive light from the transverse anamorphic component; a partially reflective mirror, the input waveguide arranged to guide light from the transverse anamorphic component to the partially reflective mirror along the input waveguide, and the partially reflective mirror arranged to reflect at least some of that light; an intermediate waveguide arranged to receive at least some of the light reflected by the partially reflective mirror, a lateral anamorphic component having positive optical power in the lateral direction, the intermediate waveguide arranged to guide the light received from the partially reflective mirror to the lateral anamorphic component along the intermediate waveguide in a first direction; a light reversing reflector that is arranged to reflect light that has been guided along the intermediate waveguide in the first direction so that the reflected light is guided along the intermediate waveguide in a second direction opposite to the first direction to the partially reflective mirror, the partially reflective mirror arranged to transmit at least some of that light; and an extraction waveguide arranged to receive at least some of the light transmitted by the partially reflective mirror that has been guided in the second direction along the intermediate waveguide, wherein the extraction waveguide comprises an array of reflective extraction features, the reflective extraction features arranged to extract light guided along the extraction waveguide towards an eye of a viewer, the array of reflective extraction features distributed along the extraction waveguide so as to provide exit pupil expansion.

The anamorphic near-eye display apparatus may provide images with wide field of view with high brightness and high efficiency. Compact physical size and low weight of the anamorphic near-eye display apparatus may be achieved to provide high comfort of use and extend viewing times. High transparency may be provided. In at least one axis, images may be provided with reduced colour blur. A large size eyebox may be achieved for relaxing limitations of pupil positioning at desirable eye relief distances may achieve vignetting free images over a wide range of observer pupil positions and for a wide field of view. The anamorphic near-eye display apparatus may be suitable for augmented reality and virtual reality applications. Light is not passed through the extraction waveguide in a second direction that is opposite to the first direction. Efficiency is increased and glare reduced. The appearance of missing angular regions in the received image may be reduced. The length of the input waveguide may be different to the length of the extraction waveguide. Desirable exit pupil size may be achieved and desirable focal length of the light reversing reflector provided to achieve reduced aberrations and improved for desirable image blur.

The reflective extraction features may be disposed internally within the extraction waveguide. Advantageously the extraction features may be less susceptible to damage such as scratching. The extraction features may be polarisation sensitive, achieving increased efficiency when operated in polarised light. Light scatter from the extraction features may be reduced, achieving increased image contrast. The size of the extraction features may be increased, to achieve reduced image blur due to diffraction at the extraction features.

The reflective extraction features may comprise extraction reflectors that extend across at least part of the extraction waveguide. Advantageously chromatic aberrations may be reduced and the size of the eyebox increased.

The array of reflectors may have reflectivities defined across their overall area that increase with increasing distance along the optical axis. Advantageously uniformity of output image with viewing angle may be improved.

The extraction reflectors may comprise extraction surfaces spaced apart by a partially reflective coating. Advantageously images may be provided without missing angular regions. Efficiency, brightness and contrast may be increased and the visibility of artefacts arising from stray light including double images and ghost images reduced.

The partially reflective coating may comprise at least one dielectric layer. Advantageously the cost of the fabrication may be reduced. The at least one dielectric layer may comprise a stack of dielectric layers. Advantageously brightness and uniformity may be increased. The partially reflective coating may be metallic. Advantageously cost of manufacture may be reduced.

The extraction reflectors may comprise extraction surfaces spaced apart by a gap. Advantageously the cost of manufacture may be reduced and image uniformity increased. The extraction surfaces may have an anti-reflection coating. Advantageously the visibility of stray light may be reduced. Efficiency, brightness and contrast may be increased and the visibility of stray light, double images and ghost images reduced. The extraction reflectors may extend partially across the extraction waveguide between opposing rear and front guide surfaces of the extraction waveguide with successively shifted positions. Advantageously the cost of manufacture of the extraction waveguide may be reduced. High uniformity with viewing angle may be achieved for pupil locations across the headbox. The extraction reflectors may extend to opposing rear and front guide surfaces of the extraction waveguide. Advantageously extraction efficiency may be increased. The extraction reflectors may not extend to opposing rear and front guide surfaces of the extraction waveguide. Rear and front guide surfaces may be provided to advantageously reduce the visibility of stray light artefacts.

The anamorphic near-eye display apparatus may further comprise intermediate reflectors extending along the extraction waveguide between adjacent pairs of extraction reflectors. Advantageously manufacturing cost may be reduced.

The intermediate reflectors may further comprise intermediate surfaces spaced apart by a partially reflective coating. Advantageously increased efficiency of operation may be achieved.

The partially reflective coating may comprise at least one dielectric layer or the at least one dielectric layer may comprise a stack of dielectric layers. The partially reflective coating may be metallic. The intermediate reflectors may comprise intermediate surfaces spaced apart by a gap. The intermediate surfaces may have an anti-reflection coating. The efficiency and brightness may be modified, and the visibility of stray light artefacts reduced. Cost may be reduced.

The extraction waveguide may comprise plural constituent parts having facing stepped surfaces attached together, the stepped surfaces shaped with alternating extraction surfaces extending in the transverse direction and intermediate surfaces extending along the extraction waveguide, wherein the extraction reflectors comprise the facing extraction surfaces. Advantageously cost and complexity may be reduced.

The intermediate surfaces may be optically coupled together. The efficiency of light propagation towards the light reversing reflector may be increased.

The extraction reflectors may comprise plural sets of extraction reflectors, wherein, within each set of extraction reflectors, in the transverse direction the extraction reflectors extend partially across the extraction waveguide with successively shifted positions, the extraction reflectors of different sets overlapping in extent in the transverse direction. The size of the eyebox may be increased. The size of the extraction reflectors may be increased and the image blur due to diffraction from the extraction reflectors may be reduced.

At least part of the extraction waveguide may comprise plural constituent plates optically coupled together, wherein the extraction reflectors may be formed between the constituent plates. The extraction reflectors may extend between opposing rear and front guide surfaces of the extraction waveguide. The extraction reflectors may have the same reflective area. The thickness of the extraction waveguide may be reduced. The visibility of diffraction blur from the extraction reflectors may be reduced.

The extraction reflectors may be patterned to have different reflective areas providing reflectivities defined across their overall area that increase with increasing distance along the optical axis. Advantageously the uniformity of the perceived image may be increased.

The extraction reflectors may have a surface normal direction that may be inclined with respect to the direction along the waveguide by an angle in the range 20 to 40 degrees, preferably by an angle in the range 25 to 35 degrees and most preferably by an angle in the range 27.5 degrees to 32.5 degrees. Advantageously stray light rays may be reduced and the visibility of double images reduced.

The extraction waveguide may comprise a transmissive element and a diffractive optical element optically coupled together, wherein the reflective extraction features comprise portions of the diffractive optical element. Advantageously the complexity of the waveguide manufacture may be reduced.

The diffractive optical element may be a volume hologram. Advantageously efficiency of reflection may be increased.

The extraction waveguide may have opposing rear and front guide surfaces having an anti-reflection coating. Advantageously stray light may be reduced.

The extraction waveguide may have a front guide surface and a rear guide surface, and the rear guide surface may comprise extraction facets that are the reflective extraction features. Advantageously fabrication cost and complexity may be reduced. Facet reflectivity may be increased.

The light reversing reflector may be a reflective end of the intermediate waveguide. The lateral anamorphic component may comprise the light reversing reflector. Advantageously the cost and complexity of manufacture may be reduced. Interfacial losses may be reduced.

The lateral anamorphic component may comprise: a reflective linear polariser disposed between the light reversing reflector and the array of reflective extraction features; and a polarisation conversion retarder disposed between the reflective polariser and the light reversing reflector, the polarisation conversion retarder arranged to convert a polarisation state of light passing therethrough between a linear polarisation state and a circular polarisation state. The reflective linear polariser may be curved in the lateral direction. The light reversing reflector may be curved in the lateral direction. Curvature of the light reversing reflector may be reduced for desirable optical power and aberrations may be controlled to achieve increased modulation transfer function and advantageously reduce image blur.

The light reversing reflector may be not curved in the lateral direction. Advantageously the length of the intermediate waveguide in the first direction may be reduced and smaller near-eye display apparatus achieved.

The polarisation conversion retarder may be curved in the lateral direction. The complexity of assembly of the intermediate waveguide may be reduced and advantageously cost may be reduced. Additional reduction of aberrations may be achieved. The polarisation conversion retarder may have a retardance of a quarter wavelength at a wavelength of visible light, for example 550 nm. Advantageously image contrast may be increased and efficiency improved.

The optical system may comprise an input linear polariser disposed between the spatial light modulator and the array of extraction reflectors. The input linear polariser and the reflective linear polariser of the lateral anamorphic component may be arranged to pass a common polarisation state. Stray light may be reduced and image contrast advantageously improved.

The lateral anamorphic component may further comprise: a polarisation control retarder disposed between the reflective polariser and the array of reflective extraction features, the polarisation control retarder arranged to change a polarisation state of light passing therethrough; and an absorbing linear polariser disposed between the polarisation control retarder and the reflective polariser, wherein the absorbing linear polariser and the linear polariser may be arranged to pass a common linear polarisation state that is a component of the polarisation state output from the polarisation control retarder in the direction along the waveguide. The polarisation control retarder may have a retardance of a quarter wavelength or a half wavelength at a wavelength of visible light, for example 550 nm. The optical system may comprise an input linear polariser disposed between the spatial light modulator and the array of extraction reflectors. Light output that passes in the first direction along the waveguide and is reflected from the extraction reflectors is reduced and light output that passes in the second direction along the waveguide and is reflected from the extraction reflectors is increased. Advantageously glare to external observers is reduced and image contrast increased.

The optical system may comprise an input linear polariser disposed between the spatial light modulator and the partially reflective mirror and a polarisation conversion retarder disposed between the light reversing reflector and the array of reflective extraction features, the polarisation conversion retarder arranged to convert a polarisation state of light passing therethrough between a linear polarisation state and a circular polarisation state. The polarisation conversion retarder may have a retardance of a quarter wavelength at a wavelength of visible light, for example 550 nm.

Polarisation-selective extraction reflectors may be provided and advantageously stray light may be reduced. Polarised light may propagate within the extraction waveguide with low extraction efficiency in a first direction along the extraction waveguide and higher extraction efficiency in the second direction opposite to the first direction. Light output that passes in the first direction along the waveguide and is reflected from the extraction reflectors is reduced and light output that passes in the second direction along the waveguide and is reflected from the extraction reflectors is increased. Advantageously glare to external observers is reduced and image contrast increased. Efficiency and brightness is increased and power consumption for a desirable brightness reduced.

The optical system may comprise a polarisation conversion retarder disposed between the partially reflective mirror and the extraction waveguide, the polarisation conversion retarder arranged to convert a polarisation state of light passing therethrough between a linear polarisation state and an orthogonal linear polarisation state. The polarisation conversion retarder may have a retardance of a half wavelength at a wavelength of visible light. The input linear polariser and polarisation conversion retarders may be arranged to pass light that is in a s-polarisation state in the extraction waveguide. The s-polarisation state may be preferentially reflected by the light extraction features. Advantageously efficiency and brightness are increased and power consumption for a desirable brightness reduced.

The lateral anamorphic component may comprise a lens. Advantageously improved aberrations may be achieved across the field of view and for a larger exit pupil.

The input waveguide and the intermediate waveguide may comprise no extraction features that are arranged to extract light guided therealong. Advantageously efficiency may be increased and glare reduced.

The optical system may comprise an input section comprising an input reflector that is the transverse anamorphic component and may be arranged to reflect the light from the illumination system and direct it along the input waveguide. Advantageously complexity, cost of fabrication and weight may be reduced.

The transverse anamorphic component may further comprise a lens. Advantageously aberrations may be reduced, image fidelity increased and headbox increased in size.

The input section may further comprise an input face disposed on a front or rear side of the input waveguide and facing the input reflector, and the input section may be arranged to receive the light from the illumination system through the input face. The input face may extend at an acute angle to the front guide surface in the case that the input face is on the front side of the input waveguide or to the rear guide surface in the case that the input face is on the rear side of the input waveguide. The input face may extend parallel to the front guide surface in the case that the input face is on the front side of the input waveguide or to the rear guide surface in the case that the input face is on the rear side of the input waveguide. The input face may be coplanar with the front guide surface in the case that the input face is on the front side of the input waveguide or with the rear guide surface in the case that the input face is on the rear side of the input waveguide. The input face may be disposed outwardly of one of the front or rear guide surfaces. The input section may further comprise a separation face extending outwardly from the one of the front or rear guide surfaces to the input face. Advantageously improved mechanical arrangements of the illumination system and optical system may be achieved.

The input section may be integral with the input waveguide. Advantageously complexity of manufacture may be reduced, and lower cost achieved.

The input waveguide may have an end that is an input face through which the input waveguide is arranged to receive light from the illumination system, and the input section may be a separate element from the input waveguide that may further comprise an output face and is arranged to direct light reflected by the input reflector through the output face and into the input waveguide through the input face of the input waveguide. Advantageously improved aberrations may be achieved. Reflective surfaces may be protected.

The lens of the lateral anamorphic component may comprise an air gap and a surface facing the air gap. Control of aberrations may be increased and advantageously the modulation transfer function for off-axis directions may be increased and the image blur reduced.

The air gap may have edges, and the anamorphic near-eye display apparatus may comprise reflectors extending across the edges of the air gap. Advantageously light losses may be reduced and image uniformity increased.

The transverse anamorphic component may comprise a lens. The lens of the transverse anamorphic component may be a compound lens. Advantageously aberrations in the transverse direction may be reduced.

The pixels of the spatial light modulator may also be distributed in the transverse direction so that the light output from the transverse anamorphic component may be directed in the directions that are distributed in the transverse direction. Advantageously, image rows may be provided simultaneously. Image break-up artefacts may be reduced.

The spatial light modulator may comprise pixels having pitches in the lateral and transverse directions with a ratio that may be the same as the inverse of the ratio of optical powers of the lateral and transverse anamorphic optical elements. Advantageously the observer may perceive square pixels. Image fidelity may be increased.

The illumination system may further comprise a deflector element arranged to deflect light output from the transverse anamorphic component by a selectable amount, the deflector element selectively operable to direct the light output from the transverse anamorphic component in the directions that are distributed in the transverse direction. Advantageously the complexity of the illumination system may be reduced.

The input waveguide may have opposing rear and front guide surfaces that are planar and parallel. The intermediate waveguide may have opposing rear and front guide surfaces that are planar and parallel. The extraction waveguide may have opposing rear and front guide surfaces that are planar and parallel. Advantageously the visibility of double images, ghost and other stray light artefacts may be reduced. Image contrast may be improved.

The reflective extraction features may be inclined with respect to the first and second directions along the optical axis. Light rays may be extracted near to normal to the extraction waveguide. The eyebox may be arranged at desirable distances from the output surface of the extraction waveguide.

The reflective extraction features may be inclined at the same angle. Advantageously the appearance of ghost and double images may be reduced.

The reflective extraction features may have a varying pitch along the extraction waveguide. The reflective extraction features may have a varying extent between opposing rear and front guide surfaces of the extraction waveguide. Reduced diffraction blur may be achieved in most common viewing directions and image quality improved. The eyebox may be extended while achieving reduced waveguide thickness.

The anamorphic near-eye display apparatus may further comprise a control system arranged to operate the illumination system to provide light input in accordance with image data representing an image. Advantageously image data may be perceived to provide an augmented reality or virtual reality image.

The reflective extraction arrangement may comprise two separated regions, each region arranged to extract light guided along the extraction waveguide towards a respective eye of the viewer. Advantageously the weight, cost and complexity of head wear may be reduced.

At least one of an input end of the input waveguide, the transverse anamorphic component and the spatial light modulator may have a curvature in the lateral direction that compensates for Petzval field curvature of the lateral anamorphic component. Advantageously the modulation transfer function for off-axis directions may be increased and the image blur reduced.

According to a second aspect of the present disclosure there is provided a head-worn display apparatus comprising an anamorphic near-eye display apparatus according to the first aspect arranged to mount the anamorphic near-eye display apparatus on a head of a wearer with the anamorphic near-eye display apparatus extending across at least one eye of the wearer. Virtual reality and augmented reality images may be conveniently provided to moving observers.

The head-worn display apparatus may further comprise lenses having optical power, the anamorphic near-eye display apparatus overlying one or each lens. The nominal viewing distance of the virtual image may be adjusted to achieve reduced discrepancy between accommodation and convergence depth cues in a stereoscopic display apparatus. Correction for visual characteristics of the observer's eyes may be provided.

The head-worn display apparatus may comprise a pair of spectacles. Advantageously a low weight transparent head-worn display apparatus suitable for augmented reality applications may be achieved.

The anamorphic near-eye display apparatus may be a first anamorphic near-eye display apparatus and the head-worn display apparatus may further comprise a second anamorphic near-eye display apparatus, wherein the second anamorphic near-eye display apparatus is arranged in series with the first anamorphic near-eye display apparatus. Increased image resolution, increased brightness, increased exit pupil size; reduced image diffraction; and increased field of view may be provided.

A virtual image distance for light from the second anamorphic near-eye display apparatus may be different to a virtual image distance for light from the first anamorphic near-eye display apparatus. Discrepancy between stereoscopic and accommodation depth cues may be reduced and advantageously user comfort increased.

The head-worn display apparatus may further comprise a non-anamorphic near-eye display apparatus, wherein the non-anamorphic near-eye display apparatus may comprise a non-anamorphic spatial light modulator and a non-anamorphic magnifying optical system; and wherein the non-anamorphic near-eye display apparatus is arranged in series with the anamorphic near-eye display apparatus. Increased image resolution, increased brightness, increased exit pupil size; reduced image diffraction; and increased field of view may be provided.

A virtual image distance for light from the non-anamorphic near-eye display apparatus may be different to a virtual image distance for light from the anamorphic near-eye display apparatus. Discrepancy between stereoscopic and accommodation depth cues may be reduced and advantageously user comfort increased.

According to a third aspect of the present disclosure there is provided an anamorphic directional illumination device comprising: an illumination system comprising a light source array, the illumination system arranged to output light; and an optical system arranged to direct light from the illumination system, wherein the optical system has an optical axis and has anamorphic properties in a lateral direction and a transverse direction that are perpendicular to each other and perpendicular to the optical axis, wherein the light source array comprises light sources distributed in the lateral direction, and the optical system comprises: a transverse anamorphic component having positive optical power in the transverse direction, wherein the transverse anamorphic component is arranged to receive light from the light source array and the illumination system is arranged so that light output from the transverse anamorphic component is directed in directions that are distributed in the transverse direction; an input waveguide arranged to receive light from the transverse anamorphic component; a partially reflective mirror, the input waveguide arranged to guide light from the transverse anamorphic component to the partially reflective mirror along the input waveguide, and the partially reflective mirror arranged to reflect at least some of that light; an intermediate waveguide arranged to receive at least some of the light reflected by the partially reflective mirror, a lateral anamorphic component having positive optical power in the lateral direction, the intermediate waveguide arranged to guide the light received from the partially reflective mirror to the lateral anamorphic component along the intermediate waveguide in a first direction; a light reversing reflector that is arranged to reflect light that has been guided along the intermediate waveguide in the first direction so that the reflected light is guided along the intermediate waveguide in a second direction opposite to the first direction to the partially reflective mirror, the partially reflective mirror arranged to transmit at least some of that light; and an extraction waveguide arranged to receive at least some of the light transmitted by the partially reflective mirror that has been guided in the second direction along the intermediate waveguide, wherein the extraction waveguide comprises at least one reflective extraction feature, the at least one reflective extraction feature arranged to extract light guided along the extraction waveguide. A directional illumination device may be provided in a compact arrangement with low cost. High resolution output light beams may be provided that may be controllable.

According to a fourth aspect of the present disclosure there is provided a vehicle external light apparatus comprising: an anamorphic directional illumination device according to the third aspect. The height of the emitting aperture may be reduced to advantageously achieve desirable aesthetic appearance. High illuminance of illuminated scenes may be achieved with high resolution imaging of addressable light cones in one or two dimensions. High image contrast may be achieved for adjustable beam shaping. Image glare to oncoming viewers of the illumination device may be reduced while improved visibility of scenes around the oncoming viewers may be achieved.

Any of the aspects of the present disclosure may be applied in any combination.

Embodiments of the present disclosure may be used in a variety of optical systems. The embodiments may include or work with a variety of projectors, projection systems, optical components, displays, microdisplays, computer systems, processors, self-contained projector systems, visual and/or audio-visual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in optical systems, devices used in visual and/or optical presentations, visual peripherals and so on and in a number of computing environments and automotive environments.

Before proceeding to the disclosed embodiments in detail, it should be understood that the disclosure is not limited in its application or creation to the details of the particular arrangements shown, because the disclosure is capable of other embodiments. Moreover, aspects of the disclosure may be set forth in different combinations and arrangements to define embodiments unique in their own right. Also, the terminology used herein is for the purpose of description and not of limitation.

These and other advantages and features of the present disclosure will become apparent to those of ordinary skill in the art upon reading this disclosure in its entirety.

### BRIEF DESCRIPTION OF THE DRAWINGS

Embodiments are illustrated by way of example in the accompanying FIGURES, in which like reference numbers indicate similar parts, and in which:

FIG. 1A is a schematic diagram illustrating a front perspective view of an anamorphic near-eye display apparatus;

FIG. 1B is a schematic diagram illustrating a top view of the anamorphic near-eye display of FIG. 1A;

FIG. 1C is a schematic diagram illustrating a front view of the anamorphic near-eye display of FIG. 1A;

FIG. 1D is a schematic diagram illustrating a top view of the near-eye display of FIG. 1A;

FIG. 1E is a schematic diagram illustrating a top view of an alternative arrangement of anamorphic near-eye display;

FIG. 1F is a schematic diagram illustrating a top view the operation of a near-eye display in a transverse plane;

FIG. 1G is a schematic diagram illustrating a top view the operation of a near-eye display in a lateral plane orthogonal to the transverse plane;

FIG. 1H is a schematic diagram illustrating a front perspective view of a coordinate system mapping for the anamorphic near-eye display apparatus of FIG. 1A;

FIG. 1I is a schematic diagram illustrating a field-of-view plot of the output of the anamorphic near-eye display apparatus of FIG. 1A for polychromatic illumination;

FIG. 2A, FIG. 2B, and FIG. 2C are schematic diagrams illustrating in front view arrangements of a spatial light modulator for use in the anamorphic near-eye display apparatus of FIG. 1A comprising spatially multiplexed red, green and blue sub-pixels;

FIG. 2D is a schematic diagram illustrating in front view a spatial light modulator for use in the anamorphic near-eye display apparatus of FIG. 1A for use with temporally multiplexed spectral illumination;

FIG. 3A is a schematic diagram illustrating a top view of light input into an extraction waveguide;

FIG. 3B is a schematic diagram illustrating a top view of light propagation along a first direction in an extraction waveguide;

FIG. 3C is a schematic diagram illustrating a perspective view of light extraction from the anamorphic near-eye display apparatus of FIG. 1A;

FIG. 4A is a schematic diagram illustrating a top view of light output from an anamorphic near-eye display apparatus for a single extraction reflector;

FIG. 4B is a schematic diagram illustrating a top view of light output from an anamorphic near-eye display apparatus for multiple extraction reflectors to achieve a full ray cone input in the transverse direction into an observer's pupil:

FIG. 4C is a schematic diagram illustrating a top view of light output from an anamorphic near-eye display apparatus for multiple locations for a moving observer in the transverse direction;

FIG. 5A is a schematic diagram illustrating a front view of light output from the anamorphic near-eye display apparatus of FIG. 1A;

FIG. 5B is a schematic diagram illustrating a front view of the anamorphic near-eye display apparatus of FIG. 1A for a single pupil position;

FIG. 5C is a schematic diagram illustrating a front view of the anamorphic near-eye display apparatus of FIG. 1A for multiple pupil positions;

FIG. 5D is a schematic diagram illustrating a top view of an imaging system arranged to image in the transverse direction wherein no reflective extraction features are provided;

FIG. 5E is a schematic diagram illustrating a top view of an imaging system arranged to image in the lateral direction;

FIG. 5F is a schematic diagram illustrating a top view of an imaging system arranged to image in the transverse direction wherein an array of extraction reflectors is provided as the reflective extractions features;

FIG. 6A is a schematic diagram illustrating a side perspective view of an alternative anamorphic near-eye display apparatus;

FIG. 6B is a schematic diagram illustrating an exploded perspective view of an alternative near-eye anamorphic display apparatus wherein the partially reflective mirror is provided between the light guiding surfaces of the extraction waveguide and the extraction features are provided on a light guiding side of the extraction waveguide;

FIG. 6C is a schematic diagram illustrating a front perspective view of an alternative near-eye anamorphic display apparatus wherein the partially reflective mirror and extraction features are provided between the light guiding surfaces of the extraction waveguide;

FIG. 6D is a schematic diagram illustrating an exploded front perspective view the embodiment of FIG. 6C;

FIG. 6E is a schematic diagram illustrating a top view of a folded near-eye anamorphic display apparatus comprising a further turning prism wherein the extraction waveguide is arranged between the input waveguide and the eye;

FIG. 6F is a schematic diagram illustrating a top view of a folded near-eye anamorphic display apparatus comprising an input waveguide further comprising a light turning surface wherein the input waveguide is arranged between the extraction waveguide and the eye;

FIG. 6G is a schematic diagram illustrating a top view of a turning prism arranged to redirect guided light cones through angles different to 90 degrees;

FIG. 6H is a schematic diagram illustrating a top view of a turning prism with air gaps arranged to redirect guided light cones through 90 degrees;

FIG. 6I is a schematic diagram illustrating a top view of turning prisms with air gaps arranged to redirect guided light cones through 180 degrees;

FIG. 6J is a schematic diagram illustrating a top view of a turning prism with no air gaps arranged to redirect guided light cones through 90 degrees;

FIG. 6K is a schematic diagram illustrating a top view of a turning prism with no air gaps arranged to redirect guided light cones through 180 degrees;

FIG. 7A is a schematic diagram illustrating a top view of polarisation state propagation in an alternative arrangement of anamorphic near-eye display apparatus;

FIG. 7B is a schematic diagram illustrating a top view of polarisation state propagation in an alternative arrangement of anamorphic near-eye display apparatus;

FIG. 7C is a schematic diagram illustrating a top view of an extraction waveguide;

FIG. 7D is a schematic diagram illustrating a top view of propagation of polarised light after reflection from the reflective end around an extraction reflector comprising a single dielectric layer;

FIG. 7E is a schematic diagram illustrating a top view of propagation of polarised light after reflection from the reflective end around an extraction reflector comprising a stack of dielectric layers;

FIG. 8A is a schematic graph illustrating the variation of reflectivity against wavelength for light rays propagating through an extraction reflector comprising dielectric layers set out in TABLE 2;

FIG. 8B is a flowchart illustrating compensation of pixel data for pixel location in the transverse direction;

FIG. 9A, FIG. 9B, FIG. 9C, FIG. 9D, and FIG. 9E are schematic diagrams illustrating top views of alternative arrangements of extraction waveguides comprising partially reflective coatings;

FIG. 10 is a schematic diagram illustrating a top view of an extraction waveguide comprising a gap;

FIG. 11 is a schematic diagram illustrating a top view near an extraction reflector comprising partially reflective material and adjacent intermediate surfaces comprising intermediate surface material;

FIG. 12A is a schematic graph of the variation of stepped surface height with position along the waveguide for various illustrative arrangements of steps for a stepped surface;

FIG. 12B is a schematic graph of alternative variations of facet width w with position along an extraction waveguide;

FIG. 13A is a schematic diagram illustrating a perspective front view of an extraction waveguide comprising an attached surface relief structure that is not stepped;

FIG. 13B is a schematic diagram illustrating a top view of an extraction waveguide comprising an attached surface relief structure that is not stepped;

FIG. 13C is a schematic diagram illustrating a perspective front view of an extraction waveguide comprising a surface relief structure that is not stepped;

FIG. 13D is a schematic diagram illustrating a top view of an extraction waveguide comprising a surface relief structure that is not stepped;

FIG. 13E is a schematic diagram illustrating a perspective front view of an extraction waveguide comprising a surface relief diffractive structure that is not stepped;

FIG. 13F is a schematic diagram illustrating a top view of an extraction waveguide comprising a surface relief diffractive structure that is not stepped;

FIG. 13G is a schematic diagram illustrating a top view of an extraction waveguide comprising a surface relief light extraction structure, a stepped surface relief extraction structure and partial reflectors arranged between the front and rear light guiding surfaces;

FIG. 14A is a schematic diagram illustrating in front view an arrangement of chirped extraction reflectors for a monocular near-eye anamorphic display apparatus;

FIG. 14B is a schematic diagram illustrating in front view an arrangement of chirped extraction reflectors for a binocular near-eye anamorphic display apparatus;

FIG. 15A is a schematic diagram illustrating in perspective front view an augmented reality head-worn display apparatus comprising a right-eye anamorphic display apparatus arranged with spatial light modulator in brow position;

FIG. 15B is a schematic diagram illustrating in perspective front view an augmented reality head-worn display apparatus comprising left-eye and right-eye anamorphic display apparatuses arranged with spatial light modulator in brow position;

FIG. 16A is a schematic diagram illustrating in front view a virtual reality head-worn display apparatus comprising left-eye and right-eye anamorphic display apparatuses;

FIG. 16B is a schematic diagram illustrating in top view a virtual reality head-worn display apparatus comprising an anamorphic near-eye display apparatus;

FIG. 16C is a schematic diagram illustrating in front view an anamorphic near-eye display apparatus comprising a single waveguide suitable for use by both eyes of a display user;

FIG. 16D is a schematic diagram illustrating in top view a head-worn display apparatus comprising two anamorphic near-eye display apparatuses;

FIG. 16E is a schematic diagram illustrating a composite image;

FIG. 16F is a schematic diagram illustrating in top view a virtual reality head-worn display apparatus comprising an anamorphic near-eye display apparatus arranged to receive light from a magnifying lens and additional spatial light modulator;

FIG. 16G is a schematic diagram illustrating in top view a virtual reality head-worn display apparatus comprising an anamorphic near-eye display apparatus arranged between the anamorphic spatial light modulator and magnifying lens of a non-anamorphic near-eye display apparatus;

FIG. 16H is a schematic diagram illustrating in top view an arrangement of virtual image distances for a virtual reality display apparatus;

FIG. 16I and FIG. 16J are schematic diagrams illustrating displayed images for the arrangement of FIG. 16F;

FIG. 17A is a schematic diagram illustrating in perspective front view an alternative arrangement of the anamorphic near-eye display apparatus wherein the extraction reflectors comprises plural constituent plates;

FIG. 17B is a schematic diagram illustrating a top view of light input into the anamorphic near-eye display apparatus of FIG. 17A;

FIG. 17C is a schematic diagram illustrating in perspective front view an alternative arrangement of the anamorphic near-eye display apparatus comprising an extraction member and a partially reflective layer arranged on the rear surface of the waveguide member;

FIG. 17D is a schematic diagram illustrating in perspective front view an alternative arrangement of the anamorphic near-eye display apparatus comprising an extraction member and a partially reflective layer arranged on the front surface of the waveguide member;

FIG. 18A is a schematic diagram illustrating a top view of polarised light propagation after reflection from the reflective end in the anamorphic near-eye display apparatus of FIG. 17A;

FIG. 18B is a schematic diagram illustrating a top view of the variation of reflectivity of polarising beam splitters along the waveguide of FIG. 17A;

FIG. 19A is a schematic diagram illustrating in perspective front view an alternative arrangement of the anamorphic near-eye display apparatus of FIG. 17A wherein some of the polarising beam splitters do not extend the entirety of the thickness of the waveguide;

FIG. 19B is a schematic diagram illustrating in top view the operation of the anamorphic near-eye display apparatus of FIG. 19A;

FIG. 20A is a schematic diagram illustrating in perspective front view an alternative arrangement of the anamorphic near-eye display apparatus of FIG. 17A wherein the polarising beam splitters are patterned;

FIG. 20B is a schematic diagram illustrating in top view the operation of the anamorphic near-eye display apparatus of FIG. 20A;

FIG. 21A is a schematic diagram illustrating in perspective front view an alternative arrangement of the anamorphic near-eye display apparatus of FIG. 17A comprising a plurality of partially reflective metal interfaces;

FIG. 21B is a schematic diagram illustrating in top view the operation of the anamorphic near-eye display apparatus of FIG. 21A;

FIG. 22A is a schematic diagram illustrating a top view of an extraction waveguide comprising a plurality of stepped interface layers;

FIG. 22B is a schematic diagram illustrating a top view of a method to manufacture the extraction region of the extraction waveguide of FIG. 22A;

FIG. 22C and FIG. 22D are schematic diagrams illustrating top views of alternative arrangements of extraction waveguides comprising two types of partially reflective extraction reflectors;

FIG. 23A is a schematic diagram illustrating in perspective front view an alternative arrangement of an anamorphic near-eye display apparatus comprising a diffractive optical element;

FIG. 23B is a schematic diagram illustrating in top view the operation of the anamorphic near-eye display apparatus of FIG. 23A;

FIG. 24A is a schematic diagram illustrating in front view the operation of the anamorphic near-eye display apparatus of FIG. 23A;

FIG. 24B is a schematic diagram illustrating in top view operation of a waveguide comprising a diffractive optical element;

FIG. 24C is a schematic diagram illustrating in top view a full colour anamorphic display apparatus comprising a stack of three extraction waveguides comprising diffractive optical elements;

FIG. 24D is a schematic diagram illustrating in top view a full colour anamorphic display apparatus comprising a stack of two extraction waveguides comprising diffractive optical elements;

FIG. 24E, FIG. 24F, and FIG. 24G are schematic diagrams illustrating top views of alternative arrangements of extraction waveguides comprising combinations of reflective extraction features;

FIG. 25A is a schematic diagram illustrating in front view an anamorphic near-eye display apparatus comprising a lateral anamorphic component that is refractive and reflective;

FIG. 25B is a schematic diagram illustrating in front view an anamorphic near-eye display apparatus comprising a lateral anamorphic component that is a reflective end of a waveguide comprising a Fresnel reflector;

FIG. 25C is a schematic diagram illustrating in front view an anamorphic near-eye display apparatus comprising a lateral anamorphic component that is a refractive component comprising an air gap and air gap mirrors;

FIG. 25D is a schematic diagram illustrating in top view the anamorphic near-eye display apparatus of FIG. 25D;

FIG. 26A is a schematic diagram illustrating in front view an anamorphic near-eye display apparatus wherein an input end of the extraction waveguide has curvature in the lateral direction;

FIG. 26B is a schematic diagram illustrating in front view an anamorphic near-eye display apparatus wherein an input end of the extraction waveguide has curvature in the lateral direction and a transverse anamorphic component has curvature in the lateral direction;

FIG. 26C is a schematic diagram illustrating in front view an anamorphic near-eye display apparatus wherein an input end of the extraction waveguide has curvature in the lateral direction, a transverse anamorphic component has curvature in the lateral direction, and a spatial light modulator has curvature in the lateral direction;

FIG. 26D is a schematic diagram illustrating in front view an anamorphic near-eye display apparatus wherein an input end of the extraction waveguide has curvature in the lateral direction, a transverse anamorphic component has curvature in the lateral direction, and a spatial light modulator has curvature in the lateral direction, where the direction of curvature is in an opposite direction to that of FIG. 26C;

FIG. 26E is a schematic diagram illustrating in front view an anamorphic near-eye display apparatus wherein an input end of the extraction waveguide has curvature in the lateral direction, a transverse anamorphic component has curvature in the lateral direction, and a spatial light modulator has curvature in the lateral direction, where the direction of curvature of these components is different;

FIG. 27A is a schematic diagram illustrating in front view an anamorphic near-eye display apparatus wherein the lateral anamorphic component further comprises a planar reflective polariser and a quarter wave retarder arranged between the reflective end and the reflective polariser;

FIG. 27B is a schematic diagram illustrating optical axis alignment directions through the polarisation control components of FIG. 27A;

FIG. 27C is a schematic diagram illustrating in front view an anamorphic near-eye display apparatus wherein the lateral anamorphic component further comprises a curved reflective polariser and a quarter wave retarder arranged between the reflective end and the reflective polariser;

FIG. 27D is a schematic diagram illustrating in front view an anamorphic near-eye display apparatus wherein the lateral anamorphic component further comprises a planar reflective end, a curved reflective polariser and a quarter wave retarder arranged between the planar reflective end and the reflective polariser;

FIG. 27E is a schematic diagram illustrating in front view an anamorphic near-eye display apparatus wherein the lateral anamorphic component comprises a curved reflective end, a curved reflective polariser; a quarter wave retarder arranged between the planar reflective end and the reflective polariser and a refractive lens arranged between the input end and the reflective polariser;

FIG. 27F is a schematic diagram illustrating in front view an anamorphic near-eye display apparatus wherein the lateral anamorphic component further comprises a planar reflective polariser, a quarter wave retarder arranged between the reflective end and the reflective polariser and a further quarter wave retarder arranged between the input end and the reflective polariser wherein the input linear polariser is incorporated in the extraction waveguide;

FIG. 27G is a schematic diagram illustrating optical axis alignment directions through the polarisation control components of FIG. 27F;

FIG. 27H is a schematic diagram illustrating in front view an anamorphic near-eye display apparatus wherein the lateral anamorphic component further comprises a planar reflective polariser, a quarter wave retarder arranged between the reflective end and the reflective polariser and a further half wave retarder arranged between the input end and the reflective polariser;

FIG. 27I is a schematic diagram illustrating optical axis alignment directions through the polarisation control components of FIG. 27H;

FIG. 28A is a schematic diagram illustrating in side view the operation of an anamorphic near-eye display apparatus further comprising a corrective spectacle lens;

FIG. 28B is a schematic diagram illustrating in side view the operation of an anamorphic near-eye display apparatus further comprising a corrective Pancharatnam-Berry lens and a corrective spectacle lens;

FIG. 29A is a schematic diagram illustrating in side view a head-worn display apparatus comprising first and second focal plane modifying lenses;

FIG. 29B is a schematic diagram illustrating in side view a head-worn display apparatus comprising plural extraction waveguides and further comprising first and second focal plane modifying lenses;

FIG. 29C is a schematic diagram illustrating in side view a head-worn display apparatus comprising plural extraction waveguides and three focal plane modifying lenses;

FIG. 29D is a schematic diagram illustrating in side view a head-worn display apparatus comprising a non-anamorphic near-eye display apparatus and an anamorphic extraction waveguide;

FIG. 29E is a schematic diagram illustrating in side view a head-worn display apparatus comprising a non-anamorphic near-eye display apparatus; an anamorphic extraction waveguide; and a focal plane modifying lens arranged between the non-anamorphic near-eye display apparatus and the anamorphic near-eye display apparatus;

FIG. 29F is a schematic diagram illustrating in side view a head-worn display apparatus comprising a non-anamorphic near-eye display apparatus; an anamorphic extraction waveguide; and a focal plane modifying lens arranged to receive light from the non-anamorphic near-eye display apparatus and the anamorphic near-eye display apparatus;

FIG. 29G is a schematic diagram illustrating in side view a head-worn display apparatus comprising a non-anamorphic near-eye display apparatus; an anamorphic extraction waveguide; and two focal plane modifying lenses;

FIG. 29H is a schematic diagram illustrating in side view a head-worn display apparatus comprising a non-anamorphic near-eye display apparatus; two anamorphic extraction waveguides; and focal plane modifying lenses;

FIG. 30A is a schematic diagram illustrating in top view a detail of an arrangement of an input focusing lens;

FIG. 30B is a schematic diagram illustrating in side view a detail of the arrangement of the input focusing lens of FIG. 30A;

FIG. 30C is a schematic diagram illustrating in top view a spatial light modulator arrangement for use in the anamorphic near-eye display apparatus of FIG. 1 comprising separate red, green and blue spatial light modulators and a beam combining element;

FIG. 30D is a schematic diagram illustrating in top view an illumination system for use in the anamorphic near-eye display apparatus of FIG. 1 comprising a birdbath folded arrangement;

FIG. 31A is a schematic diagram illustrating a front perspective view of an input waveguide comprising an input reflector;

FIG. 31B is a schematic diagram illustrating a top view of the input waveguide of FIG. 31A;

FIG. 31C is a schematic diagram illustrating a front view of the input waveguide of FIG. 31A;

FIG. 31D is a schematic diagram illustrating a top view of an alternative anamorphic near-eye display apparatus comprising an input reflector;

FIG. 31E is a schematic diagram illustrating a top view of an anamorphic near-eye display apparatus comprising an alternative input reflector;

FIG. 31F is a schematic diagram illustrating a top view of an anamorphic near-eye display apparatus comprising an alternative input reflector;

FIG. 31G is a schematic diagram illustrating a top view of an anamorphic near-eye display apparatus comprising an alternative input reflector;

FIG. 32A is a schematic diagram illustrating in perspective front view an alternative arrangement of an input focusing lens;

FIG. 32B is a schematic diagram illustrating in top view a spatial light modulator arrangement for use in the anamorphic near-eye display apparatus of FIG. 1 comprising a spatial light modulator comprising a laser scanner and light diffusing screen;

FIG. 33A is a schematic diagram illustrating in top view input to the extraction waveguide comprising a laser sources and scanning arrangement;

FIG. 33B is a schematic diagram illustrating in front view a spatial light modulator arrangement comprising an array of laser light sources for use in the arrangement of FIG. 33A;

FIG. 33C is a schematic diagram illustrating in top view a spatial light modulator arrangement comprising an array of laser light sources, a beam expander and a scanning mirror;

FIG. 34A is a schematic diagram illustrating a front perspective view of an anamorphic directional illumination device; and

FIG. 34B is a schematic diagram illustrating a front perspective view a vehicle comprising a vehicle external light apparatus comprising the anamorphic directional illumination device of FIG. 34A.

### DETAILED DESCRIPTION

Terms related to optical retarders for the purposes of the present disclosure will now be described.

In a layer comprising a uniaxial birefringent material there is a direction governing the optical anisotropy whereas all directions perpendicular to it (or at a given angle to it) have equivalent birefringence.

The optical axis of an optical retarder refers to the direction of propagation of a light ray in the uniaxial birefringent material in which no birefringence is experienced. This is different from the optical axis of an optical system which may for example be parallel to a line of symmetry or normal to a display surface along which a principal ray propagates.

For light propagating in a direction orthogonal to the optical axis, the optical axis is the slow axis when linearly polarized light with an electric vector direction parallel to the slow axis travels at the slowest speed. The slow axis direction is the direction with the highest refractive index at the design wavelength. Similarly the fast axis direction is the direction with the lowest refractive index at the design wavelength.

For positive dielectric anisotropy uniaxial birefringent materials the slow axis direction is the extraordinary axis of the birefringent material. For negative dielectric anisotropy uniaxial birefringent materials the fast axis direction is the extraordinary axis of the birefringent material.

The terms half a wavelength and quarter a wavelength refer to the operation of a retarder for a design wavelength λ₀ that may typically be between 500 nm and 570 nm. In the present illustrative embodiments exemplary retardance values are provided for a wavelength of 550 nm unless otherwise specified.

The retarder provides a phase shift between two perpendicular polarization components of the light wave incident thereon and is characterized by the amount of relative phase, Γ, that it imparts on the two polarization components: which is related to the birefringence Δn and the thickness d of the retarder with retardance Δn·d by:

$$Γ = 2 \cdot π \cdot Δ n \cdot d / {λ}_{0} \qquad eqn . 1$$

In eqn. 1, Δn is defined as the difference between the extraordinary and the ordinary index of refraction, i.e.

$$Δ n = {n}_{e} - {n}_{o} \qquad eqn . 2$$

For a half-wave retarder, the relationship between d, Δn, and λ₀ is chosen so that the phase shift between polarization components is Γ=π. For a quarter-wave retarder, the relationship between d, Δn, and λ₀ is chosen so that the phase shift between polarization components is Γ=π/2.

Some aspects of the propagation of light rays through a transparent retarder between a pair of polarisers will now be described.

The state of polarisation (SOP) of a light ray is described by the relative amplitude and phase shift between any two orthogonal polarization components. Transparent retarders do not alter the relative amplitudes of these orthogonal polarisation components but act only on their relative phase. Providing a net phase shift between the orthogonal polarisation components alters the SOP whereas maintaining net relative phase preserves the SOP. In the current description, the SOP may be termed the polarisation state.

A linear SOP has a polarisation component with a non-zero amplitude and an orthogonal polarisation component which has zero amplitude. A p-polarisation state is a linear polarisation state that lies within the plane of incidence of a ray comprising the p-polarisation state and a s-polarisation state is a linear polarisation state that lies orthogonal to the plane of incidence of a ray comprising the p-polarisation state. For a linearly polarised SOP incident onto a retarder, the relative phase I is determined by the angle between the optical axis of the retarder and the direction of the polarisation component.

A linear polariser transmits a unique linear SOP that has a linear polarisation component parallel to the electric vector transmission direction of the linear polariser and attenuates light with a different SOP. The term “electric vector transmission direction” refers to a non-directional axis of the polariser parallel to which the electric vector of incident light is transmitted, even though the transmitted “electric vector” always has an instantaneous direction. The term “direction” is commonly used to describe this axis.

Absorbing polarisers are polarisers that absorb one polarisation component of incident light and transmit a second orthogonal polarisation component. Examples of absorbing linear polarisers are dichroic polarisers.

Reflective polarisers are polarisers that reflect one polarisation component of incident light and transmit a second orthogonal polarisation component. Examples of reflective polarisers that are linear polarisers are multilayer polymeric film stacks such as DBEF™ or APF™ from 3M Corporation, or wire grid polarisers such as ProFlux™ from Moxtek. Reflective linear polarisers may further comprise cholesteric reflective materials and a quarter wave retarder arranged in series.

A retarder arranged between a linear polariser and a parallel linear analysing polariser that introduces no relative net phase shift provides full transmission of the light other than residual absorption within the linear polariser.

A retarder that provides a relative net phase shift between orthogonal polarisation components changes the SOP and provides attenuation at the analysing polariser.

Achromatic retarders may be provided wherein the material of the retarder is provided with a retardance Δn·d that varies with wavelength λ as

$$Δ n \cdot d / λ = κ \qquad eqn . 3$$

where K is substantially a constant.

Examples of suitable materials include modified polycarbonates from Teijin Films. Achromatic retarders may be provided in the present embodiments to advantageously minimise colour changes between polar angular viewing directions which have low luminance reduction and polar angular viewing directions which have increased luminance reductions as will be described below.

In the present disclosure an ‘A-plate’ refers to an optical retarder utilizing a layer of birefringent material with its optical axis parallel to the plane of the layer. The optical axis direction of the optical retarder is arranged to provide retardance in correspondence to the SOP of the incident light ray, for example to convert linearly polarised light to circularly polarised light, or to convert circularly polarised light to linearly polarised light.

The structure and operation of various anamorphic near-eye display apparatuses will now be described. In this description, common elements have common reference numerals. It is noted that the disclosure relating to any element applies mutatis mutandi to each device in which the same or corresponding element is provided. Accordingly, for brevity such disclosure is not repeated. Similarly, the various features of any of the following examples may be combined together in any combination.

It would be desirable to provide an anamorphic near-eye display apparatus 100 with a thin form factor, large freedom of movement, high resolution, high brightness and wide field of view. An anamorphic near-eye display apparatus 100 will now be described.

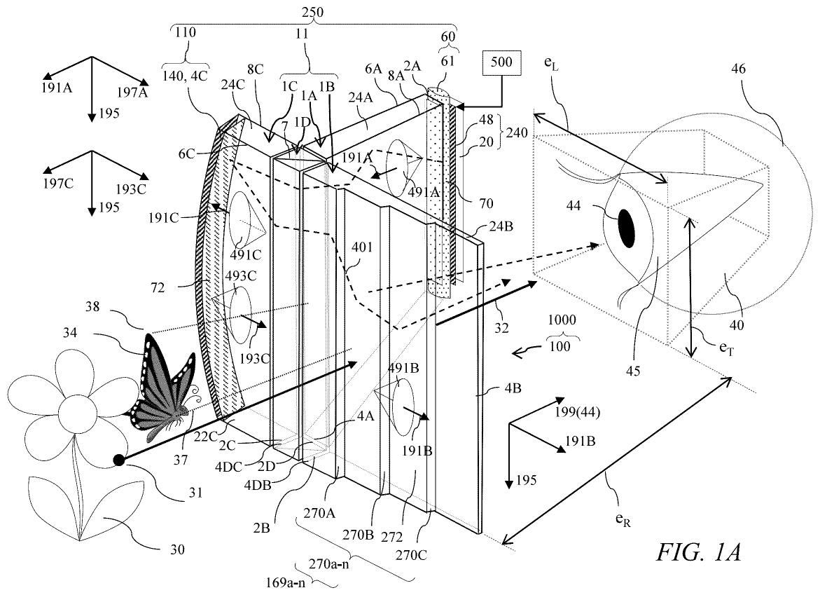

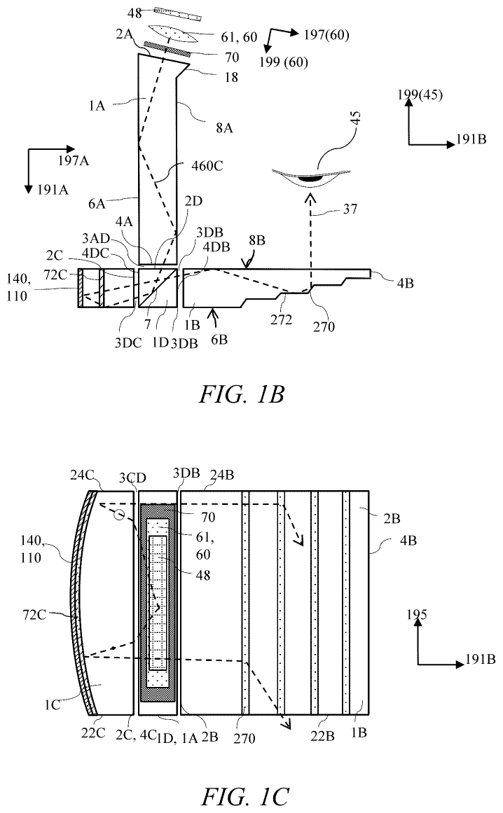

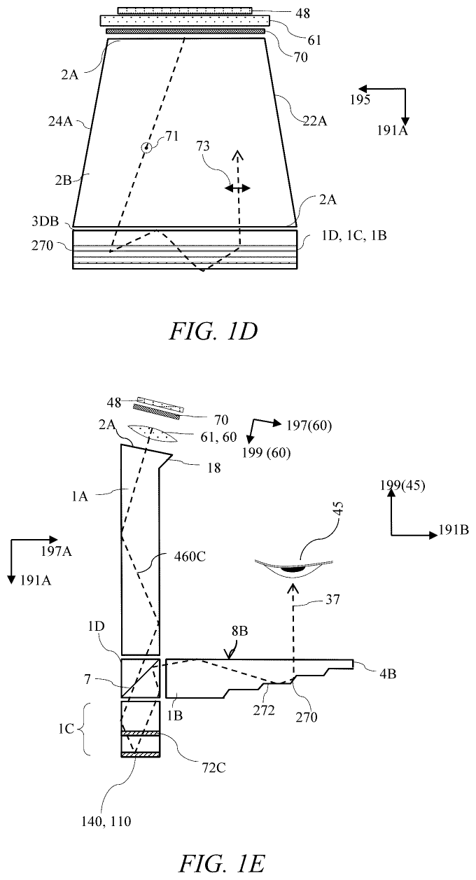

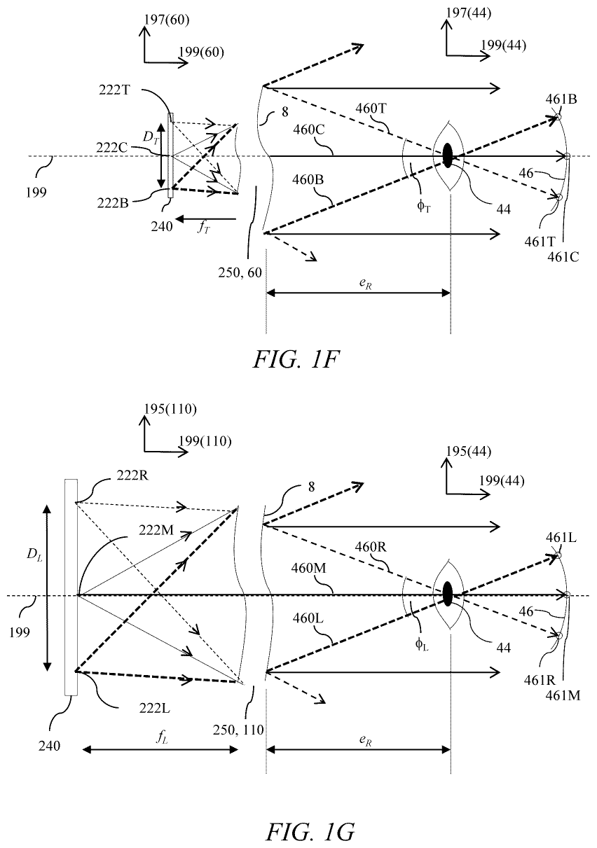

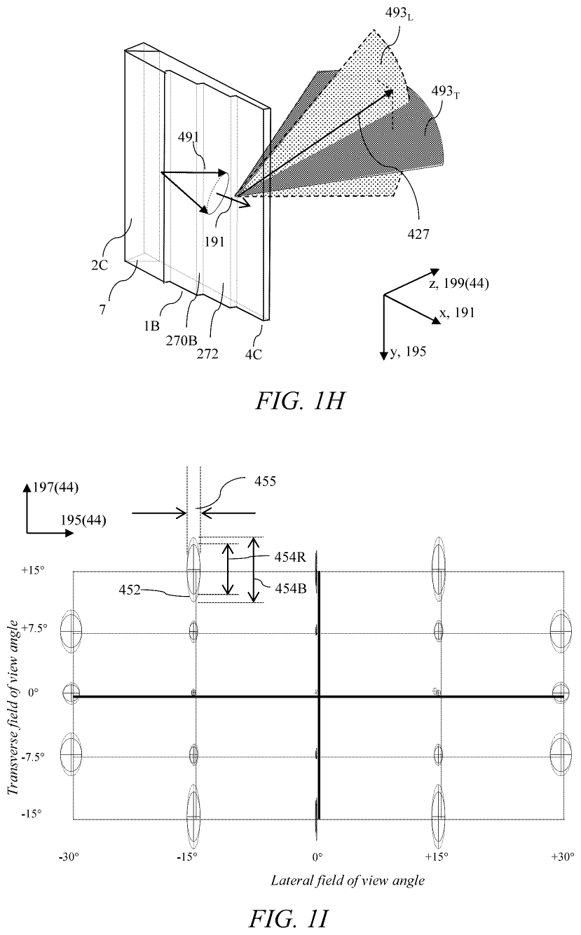

FIG. 1A is a schematic diagram illustrating a front perspective view of an anamorphic near-eye display apparatus 100; FIG. 1B is a schematic diagram illustrating a top view of the near-eye display 100 of FIG. 1A; FIG. 1C is a schematic diagram illustrating a front view of the near-eye display 100 of FIG. 1A; and FIG. 1D is a schematic diagram illustrating a top view of the near-eye display 100 of FIG. 1A.

FIG. 1A illustrates an anamorphic directional illumination device 1000 which is an anamorphic near-eye display apparatus 100. In the present description, an anamorphic near-eye display apparatus 100 is provided near to an eye 45, to provide light to the pupil 44 of the eye 45 of an observer 47. In an illustrative embodiment, the eye 45 may be arranged at a nominal viewing distance e_{R} of between 5 mm and 100 mm and preferably between 8 mm and 20 mm from the output surface of the anamorphic near-eye display apparatus 100. Such displays are distinct from direct view displays wherein the viewing distance is typically greater than 100 mm. The nominal viewing distance e_{R} may be referred to as the eye relief.

FIG. 1A illustrates an anamorphic near-eye display apparatus 100 comprising: an illumination system 240 comprising a spatial light modulator 48, the illumination system 240 being arranged to output light (for example light ray 401); and an optical system 250 arranged to direct light from the illumination system 240 to a viewer's eye 45, wherein the optical system 250 has an optical axis 199 and has anamorphic properties in a lateral direction 195 and a transverse direction 197 that are perpendicular to each other and perpendicular to the optical axis 199, wherein the spatial light modulator 48 comprises pixels 222 distributed in the lateral direction 195, and the optical system 250 comprises: a transverse anamorphic component 60 having positive optical power in the transverse direction 197, wherein the transverse anamorphic component 60 is arranged to receive light 401 from the spatial light modulator 48 and the illumination system 250 is arranged so that light output from the transverse anamorphic component 60 is directed in directions that are distributed in the transverse direction 197; an input waveguide 1A arranged to receive light from the transverse anamorphic component 60; a partially reflective mirror 7, the input waveguide 1A being arranged to guide light from the transverse anamorphic component 60 to the partially reflective mirror 7 along the input waveguide 1A, and the partially reflective mirror 7 being arranged to reflect at least some of that light; an intermediate waveguide 1C arranged to receive at least some of the light reflected by the partially reflective mirror 7, a lateral anamorphic component 110 having positive optical power in the lateral direction 195, the intermediate waveguide 1C being arranged to guide the light received from the partially reflective mirror 7 to the lateral anamorphic component 110 along the intermediate waveguide 1C in a first direction 191C; a light reversing reflector 140 that is arranged to reflect light that has been guided along the intermediate waveguide 1C in the first direction 191C so that the reflected light is guided along the intermediate waveguide 1C in a second direction 193C opposite to the first direction 191C to the partially reflective mirror 7, the partially reflective mirror 7 being arranged to transmit at least some of that light; and an extraction waveguide 1B arranged to receive at least some of the light transmitted by the partially reflective mirror 7 that has been guided in the second direction 193C along the intermediate waveguide 1C, wherein the extraction waveguide 1B comprises an array of reflective extraction features 170a-n, the reflective extraction features 170a-n being arranged to extract light guided along the extraction waveguide 1B towards an eye 45 of a viewer, the array of reflective extraction features 170a-n being distributed along the extraction waveguide 1B so as to provide exit pupil 40 expansion.

In other words, the anamorphic near-eye display apparatus 100 comprises an illumination system 240 arranged to provide output light comprising illumination from a spatial light modulator 48 and an optical system 250 arranged to direct light from the illumination system 240 to the eye 45 of an observer 47. The illumination system 240 is arranged to output light rays 400 including illustrative light rays 401, 402 that are input into the optical system 250.

In operation, it is desirable that the spatial pixel data provided on the spatial light modulator 48 is directed to the pupil 44 of the eye 45 as angular pixel data. The lens of the observer's eye 45 relays the angular spatial data to spatial pixel data at the retina 46 of the eye 45 such that an image is provided by the anamorphic near-eye display apparatus 100 to the observer 47.

The pupil 44 is located in a spatial volume near to the anamorphic near-eye display apparatus 100 commonly referred to as the exit pupil 40, or eyebox. When the pupil 44 is located within the exit pupil 40, the observer 47 is provided with a full image without missing parts of the image, that is the image does not appear to be vignetted at the observer's retina 46. The shape of the exit pupil 40 is determined at least by the anamorphic imaging properties of the anamorphic near-eye display apparatus and the respective aberrations of the anamorphic optical system. The exit pupil 40 at a nominal eye relief distance e_{R} may have dimension e_{R} in the lateral direction 195 and dimension e_{R} in the transverse direction 197. The maximum eye relief distance e_{Rmax} refers to the maximum distance of the pupil 44 from the anamorphic near-eye display apparatus 100 wherein no image vignetting is present. In the present embodiment, increasing the size of the exit pupil 40 refers to increasing the dimensions e_{L}, e_{T}. Increased exit pupil 40 achieves an increased viewer freedom and an increase in e_{Rmax} as will be described further hereinbelow.

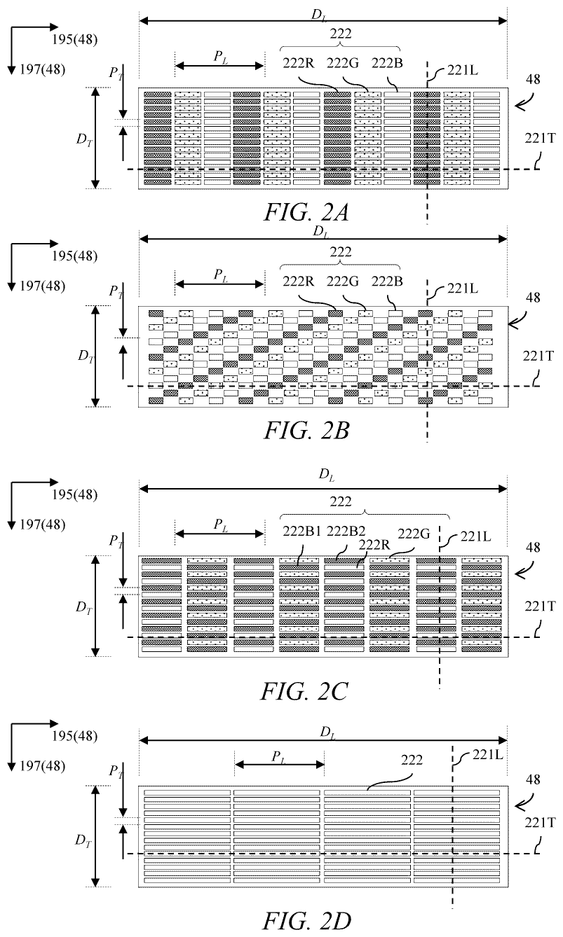

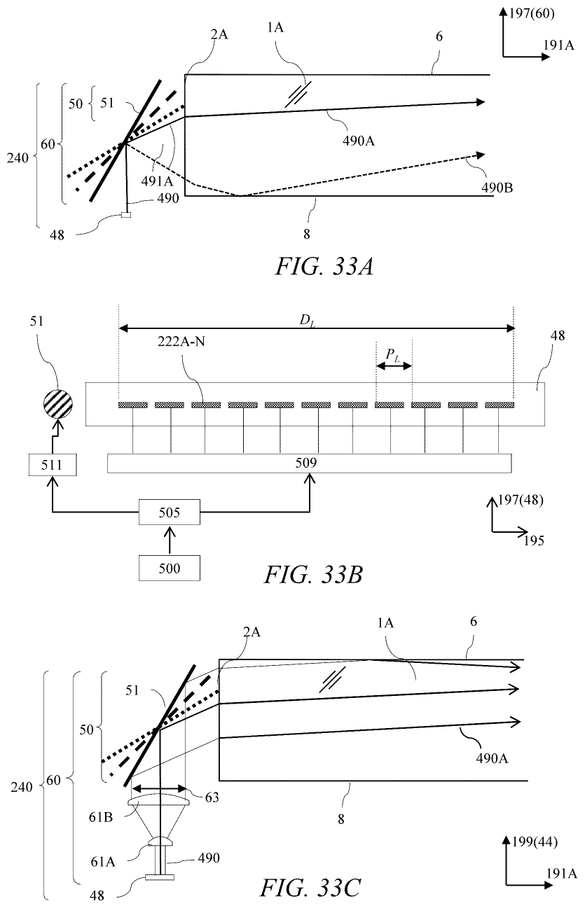

The spatial light modulator 48 comprises pixels 222 distributed at least in the lateral direction 195 as will be described further hereinbelow, for example in FIGS. 2A-D and FIG. 33A. In the illustrative embodiment of FIG. 1A, the illumination system 240 comprises a transmissive spatial light modulator 48 comprising an array of spatially separated pixels 222 distributed in a lateral direction 195(48) and transverse direction 197(48). In the embodiment of FIG. 1A, the spatial light modulator 48 is a TFT-LCD and illumination system 240 further comprises a backlight 20 arranged to illuminate the spatial light modulator 48.

The anamorphic near-eye display apparatus 100 further comprises a control system 500 arranged to operate the illumination system 240 to provide light that is spatially modulated in accordance with image data representing an image.

The optical system 250 comprises a transverse lens 61 that forms a transverse anamorphic component 60 in the embodiment of FIG. 1A, as discussed below. The transverse lens 61 comprises a cylindrical lens in this example.

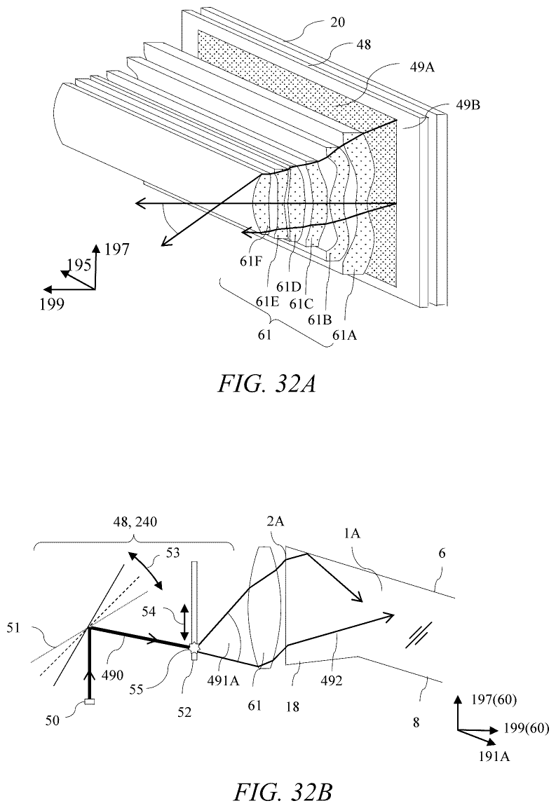

In the present disclosure, the term lens most generally refers to a single lens element or most commonly a compound lens (group of lens elements) as will be described hereinbelow in FIG. 32A for example; and is arranged to provide optical power. A lens may comprise a single refractive surface, multiple refractive surfaces, or reflective surfaces such that the lens may comprise a catadioptric lens element that combines refractive and reflective surfaces. A lens may further or alternatively comprise diffractive optical elements. A transverse lens is a lens that provides optical power in the transverse direction and may provide substantially no optical power in the lateral direction. A transverse lens may be termed a cylindrical lens, although the profile in cross section of the surface or surfaces providing optical power may be different to a segment of a circle, for example paraboloidal, elliptical or aspheric.

The transverse lens 61 in the embodiment of FIG. 1A is extended in a lateral direction 195(60) parallel to the lateral direction 195(48) of the spatial light modulator 48. The transverse anamorphic component 60 has positive optical power in a transverse direction 197(60) that is parallel to the direction 197(48) and orthogonal to the lateral direction 195(60); and no optical power in the lateral direction 195(60). The transverse anamorphic component 60 is arranged to receive light rays 400 from the spatial light modulator 48. The optical system 250 is arranged so that light output from the transverse anamorphic component 60 is directed in directions that are distributed in the transverse direction 197(60).

Mathematically expressed, for any location within the anamorphic near-eye display apparatus 100, the optical axis direction 199 may be referred to as the O unit vector, the transverse direction 197 may be referred to as the T unit vector and the lateral direction 195 may be referred to as the L unit vector wherein the optical axis direction 199 is the crossed product of the transverse direction 197 and the lateral direction 195:

$$O = T \times L \qquad eqn . 4$$

Various surfaces of the anamorphic near-eye display apparatus 100 transform or replicate the optical axis direction 199; however, for any given ray the expression of eqn. 4 may be applied.

The optical system 250 further comprises waveguide arrangement 111 comprising input waveguide 1A, intermediate waveguide 1C and extraction waveguide 1B.

Input waveguide 1A is arranged to guide light rays 400 in cone 491A from the transverse anamorphic component 60 to partially reflective mirror 7 along the input waveguide 1A in direction 191A. The input waveguide 1A has opposing rear and front guide surfaces 6A, 8A that are planar and parallel. The input waveguide 1A further has an input face 2A extending in the lateral and transverse directions 195(60). 197(60), the input waveguide 1A being arranged to receive light 400 from the illumination system 240 through an input face 2A. The input face 2A extends in the lateral direction 195 between edges 22A, 24A of the input waveguide 1A, and extends in the transverse direction 197 between opposing rear and front guide surfaces 6A, 8A of the input waveguide 1A. The output face 4A of the input waveguide 1B is arranged to output light towards the partially reflective mirror 7.

The input waveguide 1A and the intermediate waveguide 1C comprise no extraction features that are arranged to extract light guided therealong. In operation input waveguide 1A arranged to guide light rays 400 between the opposing rear and front guide surfaces 6, 8 as illustrated by the zig-zag paths of guided rays 401 in both input waveguide 1A. Advantageously light may be directed with high efficiency from the transverse anamorphic component 60 to the partially reflective mirror 7 and images may be provided with reduced image blur.

Partially reflective mirror 7 is arranged to receive light from the input waveguide 1A. Partially reflective mirror 7 may be arranged within a mirror waveguide 1D with edges 22D. 24D, input face 2D, waveguide output face 4DC and waveguide output face 4DB.

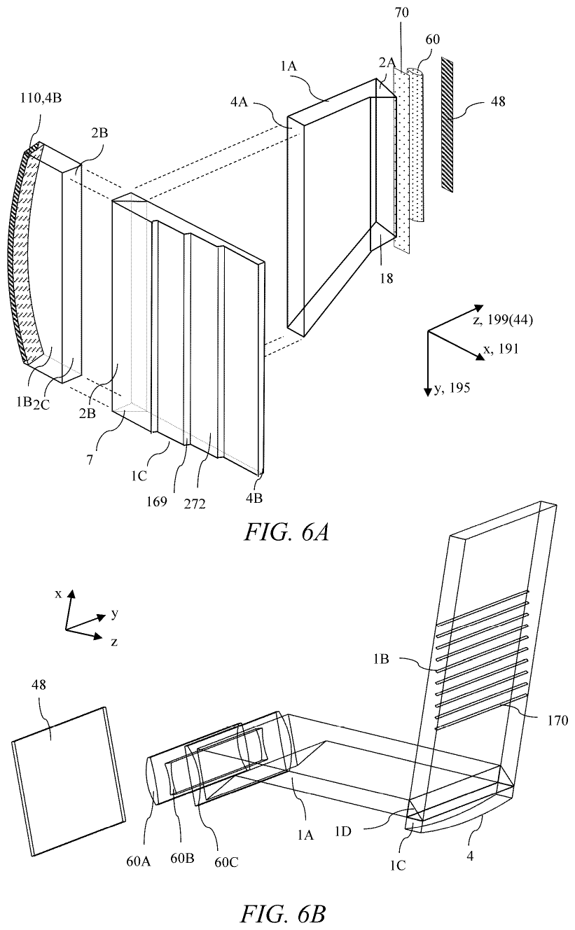

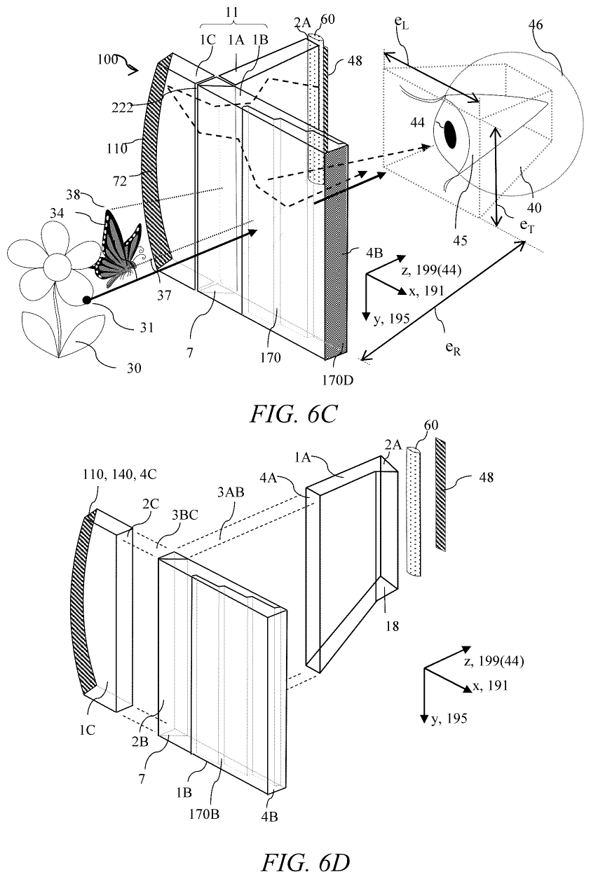

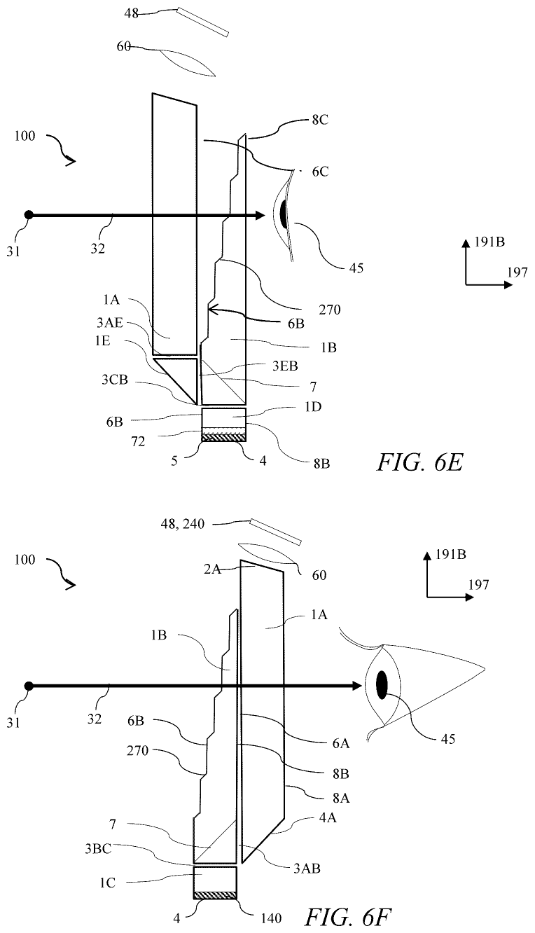

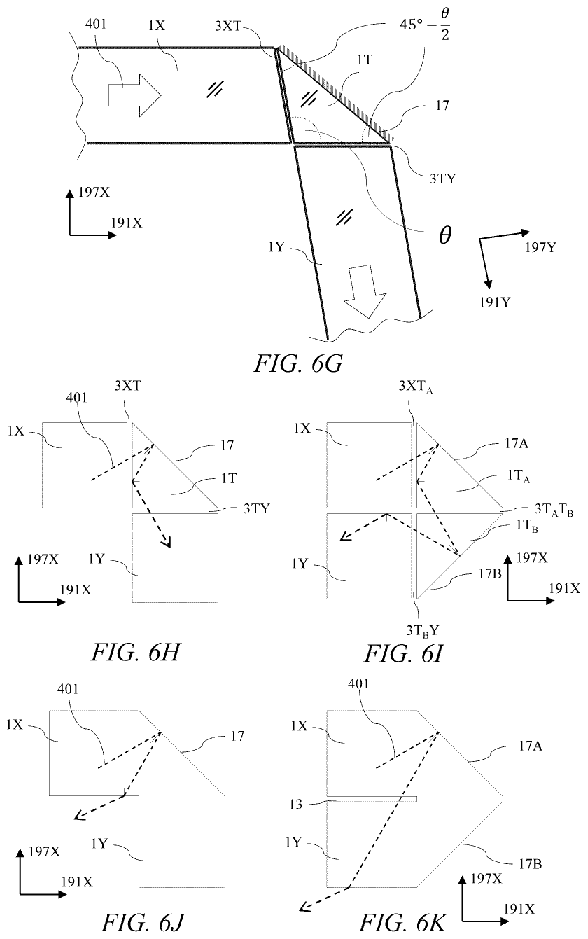

Air gaps 3AD. 3DC and 3DB are arranged between mirror waveguide 1D and input waveguide 1A, intermediate waveguide 1C and extraction waveguide 1B respectively. Some light rays may guide within the mirror waveguide 1D. The operation of the air gaps 3 will be described further hereinbelow with respect to FIGS. 6G-K.

In general, the mirror 7 of the mirror waveguide 1D is arranged to direct at least some of the light from the input waveguide 1A into the intermediate waveguide 1C.

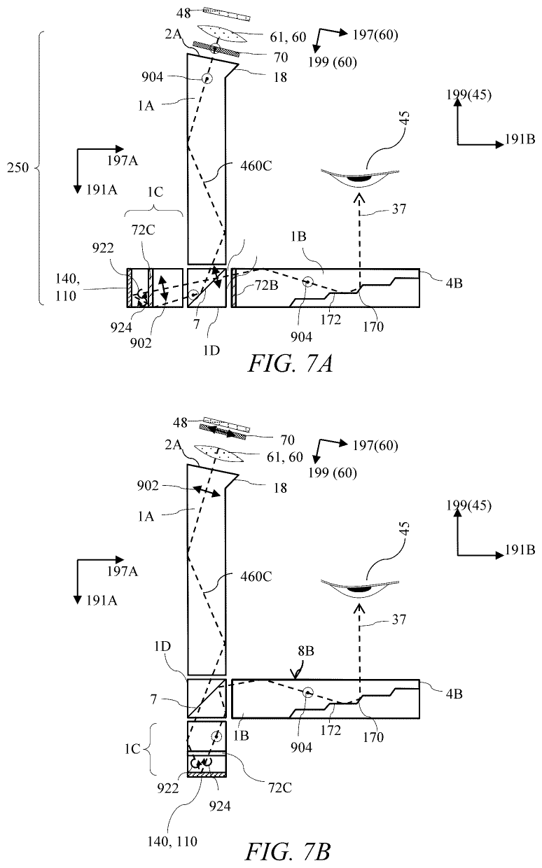

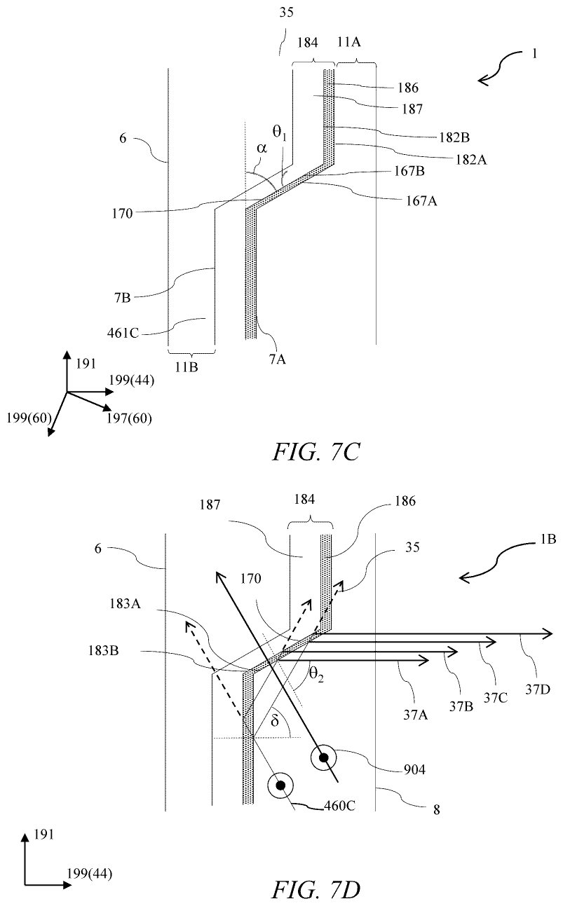

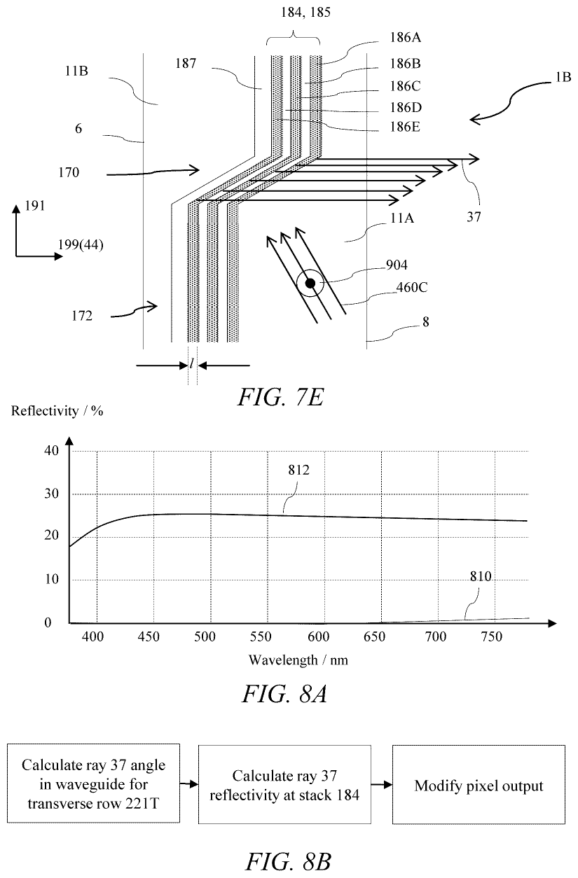

Partially reflective mirror 7 may comprise partially reflective layers such as air gaps, reflective polarisers or dielectric layers. Partially reflective mirror 7 may provide a polarisation sensitive reflectivity and polariser 70 may be provided as described hereinbelow in FIGS. 7A-B for example.

Partially reflective mirror 7 may be further arranged to transmit light that is reflected by light reversing reflector 140 of the intermediate waveguide 1C. In alternative embodiments the partially reflective mirror 7 may be arranged to transmit light from the input waveguide 1A and reflect light from the intermediate waveguide 1C.

Intermediate waveguide 1C is arranged to receive at least some of the light from the partially reflective mirror 7 and comprises a light reversing reflector 140 that is arranged to reflect light in light cones 491C that has been guided in the first direction 191C along the intermediate waveguide 1C in the first direction 191C so that the reflected light in light cone 493C is guided along the intermediate waveguide 1C in a second direction 193C opposite to the first direction 191C, and towards the partially reflective mirror 7 and extraction waveguide 1B.

The intermediate waveguide 1C further has an input face 2C extending in the lateral and transverse directions 195(60), 197(60), the intermediate waveguide 1C being arranged to receive light 400 from the partially reflective mirror 7. The input face 2C extends in the lateral direction 195 between edges 22C, 24A of the intermediate waveguide 1C, and extends in the transverse direction 197C between opposing rear and front guide surfaces 6C, 8C of the intermediate waveguide 1C.

The intermediate waveguide 1C may comprise no extraction features that are arranged to extract light guided therealong. The front and rear guide surfaces 8C, 6C of the intermediate waveguide 1C are planar and parallel. Advantageously light may be transmitted along the intermediate waveguide 1C with high efficiency and image blur of the output image is reduced.

In the embodiment of FIG. 1A, the light reversing reflector 140 is a reflective end 4C of the intermediate waveguide 1C. Furthermore, the light reversing reflector 140 forms the lateral anamorphic component 110. In particular, the reflective end 4C of the intermediate waveguide 1C has a curved shape and further comprising a reflective material in the lateral direction 195 that provides positive optical power, affecting the light rays in cone 491C in the lateral direction 195(110), and no power in the transverse direction 197(110). The reflective material may be a reflective film such as ESR™ from 3M or may be an evaporated or sputtered metal material. In the embodiment of FIG. 1A, the lateral anamorphic component 110 is thus a curved mirror with positive optical power in the lateral direction 195 and no optical power in the transverse direction 197.

The optical system 250 is thus arranged so that light output from the lateral anamorphic component 110 is directed in directions that are distributed in the transverse direction 197(110) and the lateral direction 195(110). The curved shape of the reflective end 4C may be a shape that is the cross section of a sphere, ellipse, parabola or other aspheric shape to achieve desirable imaging of light rays from the spatial light modulator 48 to the pupil 44 of the eye 45 as will be described further hereinbelow.

The reflected light from the light reversing reflector 140 is output from the intermediate waveguide 1C and incident on the mirror waveguide 1D with a polarisation state 902 that is preferentially transmitted by the partially reflective mirror 7. Advantageously efficiency may be increased.

Extraction waveguide 1B is arranged to receive light from the lateral anamorphic component, 110.

The extraction waveguide 1B further has an input face 2B extending in the lateral and transverse directions 195(60), 197(60), the extraction waveguide 1B being arranged to receive light 400 from the partially reflective mirror 7. The input face 2B extends in the lateral direction 195 between edges 22B, 24B of the extraction waveguide 1B, and extends in the transverse direction 197B between opposing rear and front guide surfaces 6B, 8B of the extraction waveguide 1B. The output face 4B of the extraction waveguide 1B may for example comprise a light absorbing material. Advantageously stray light may be reduced.

The extraction waveguide 1B has a front guide surface and a rear guide surface 8B, 6B, and the rear guide surface 6B comprises extraction facets 270 that are the reflective extraction features 169. The extraction waveguide comprises an array of reflective extraction features 170a-n, the reflective extraction features 170a-n being arranged to extract light guided along the extraction waveguide 1B towards an eye 45 of a viewer, the array of reflective extraction features 170a-n being distributed along the extraction waveguide 1B so as to provide exit pupil expansion.

The extraction waveguide 1B comprises extraction facets 270 and intermediate surfaces 272 extending along the extraction waveguide between adjacent pairs of extraction reflectors 270 and that are arranged on the rear light guide surface 6B. In the embodiment of FIG. 1A, intermediate surfaces 272 are arranged between pairs of extraction reflectors 170A-B. 170B-C. 170C-D and 170D-E. Such external surfaces may reflect guided light 401 to the eye 45 by means of total internal reflection at intermediate surface 272 and total internal reflection at the extraction facet 270 and thus are polarisation independent so that polarisation conversion retarder 72B may be omitted and polarisation state 904 may propagate within the extraction waveguide 1B. The input linear polariser is thus arranged to pass light that is in an s-polarisation state 904 in the extraction waveguide. Advantageously increased efficiency may be achieved.

In the embodiment of FIG. 1A, the directions 193C, 191B are the same. In other embodiments described hereinbelow, the directions 193C, 191B may be different. The extraction reflectors 270 are arranged to extract at least some of light cone 491B guided along the extraction waveguide 1B in the direction 191B towards an eye 45 of a viewer 47 as will be described further hereinbelow.

The coordinate system and principle of operation of the anamorphic near-eye display apparatus 100 will now be further described. The optical system 250 has an optical axis 199 and has anamorphic properties in a lateral direction 195 and in a transverse direction 197 that are perpendicular to each other and perpendicular to the optical axis 199.

The variation of optical axis 199 direction, lateral direction 195 and transverse direction 197 as light rays propagate through the optical system 250. In the present description, the lateral and transverse directions 195, 197 are defined relative to the optical axis 199 direction in any part of the illumination system 240 or optical system 250, and are not in constant directions in space. The transverse direction 197(60) illustrates the transverse direction 197 at the transverse anamorphic component 60 formed by the transverse lens 61; the transverse direction 197(110) illustrates the transverse direction 197 at the lateral anamorphic component 110; and the transverse direction 197(44) illustrates the transverse direction 197 at the eye 45 of the observer 47. The transverse anamorphic component 60 has lateral direction 195(60) that is the same as the lateral direction 195(110) of the lateral anamorphic component 110 and the lateral direction 195(44) at the pupil 44 of the eye 45. The Euclidian coordinate system illustrated by x, y, z directions is invariant, whereas the transverse direction 197, lateral direction 195 and optical axis direction 199 may be transformed at various optical components, in particular by reflection from optical components, of the anamorphic near-eye display apparatus 100.

Further features of the arrangement of FIG. 1A will now be described.

The operation of the near-eye display device 100 as an augmented reality display will now be further described.

The extraction waveguide 1B is transmissive to light that passes through the intermediate surfaces 272 such that on-axis real image point 31 on a real-world object 30 is directly viewed through the extraction waveguide 1B by light ray 32. Similarly virtual image 34 with aligned on-axis virtual pixel 36 is desirably viewed with virtual ray 37. Such virtual ray 37 is provided by on-axis light ray 401 after reflection from extraction reflector 170C to the pupil 44 of eye 45. Similarly off-axis virtual ray 39 for viewing of virtual pixel 38 is provided by off-axis ray 402 after reflection from the extraction reflector 170D. An augmented reality display with advantageously high transmission of external light rays 32 may be provided.

The operation of the near-eye display device 100 as an augmented reality display will now be further described.

The extraction waveguide 1B is transmissive to light that passes through the intermediate surfaces 272 such that on-axis real image point 31 on a real-world object 30 is directly viewed through the extraction waveguide 1 by light ray 32. Similarly virtual image 34 with aligned on-axis virtual pixel 36 is desirably viewed with virtual ray 37. Such virtual ray 37 is provided by on-axis light ray 401 after reflection from extraction reflector 170C to the pupil 44 of eye 45. Similarly off-axis virtual ray 39 for viewing of virtual pixel 38 is provided by off-axis ray 402 after reflection from the extraction reflector 170D. An augmented reality display with advantageously high transmission of external light rays 32 may be provided.

The embodiment of FIGS. 1A-D thus illustrates an anamorphic near-eye display apparatus 100 that provides (i) an input waveguide 1A with no extraction features to achieve high transmission efficiency and low stray light for input light; (ii) a reflective lateral anamorphic component 110 that may achieve wide field of view operation with reduced image blur; and (iii) a light extraction waveguide 1B that provides high efficiency of light extraction with low stray light and reduced double images.

FIG. 1E is a schematic diagram illustrating a top view of an alternative arrangement of anamorphic near-eye display 100 wherein the intermediate waveguide 1C is arranged to receive light that is transmitted through the partially reflective mirror 7. Features of the embodiment of FIG. 1E not discussed in further detail may be assumed to correspond to the features with equivalent reference numerals as discussed above, including any potential variations in the features.

By way of comparison with FIG. 1B, the alternative embodiment of FIG. 1E illustrates that the intermediate waveguide receives light that is transmitted through the partially reflective mirror 7. As will be described with respect to FIG. 7B hereinbelow, for some arrangements of light extraction features 169 then improved efficiency may be achieved. Further, the mechanical arrangement of FIG. 1E may achieve a desirable location for the intermediate waveguide 1C.

The imaging properties of the anamorphic near-eye display apparatus 100 will now be further described using a schematic representation wherein said transformations of coordinates are removed for purposes of explanation.

FIG. 1F is a schematic diagram illustrating a top view the operation of an anamorphic near-eye display apparatus 100 in a transverse plane; and FIG. 1G is a schematic diagram illustrating a top view the operation of an anamorphic near-eye display apparatus 100 in a lateral plane orthogonal to the transverse plane; and FIG. 1H is a schematic diagram illustrating a front perspective view of the mapping of the coordinate system for the anamorphic near-eye display apparatus 100 of FIG. 1A. Features of the embodiment of FIGS. 1F-H not discussed in further detail may be assumed to correspond to the features with equivalent reference numerals as discussed above, including any potential variations in the features.

For illustrative purposes, in FIGS. 1F-H, the variation of optical axis direction 199 as illustrated in FIGS. 1A-B is omitted. FIGS. 1F-H illustrate the principle of operation of the anamorphic near-eye display apparatus 100 of FIG. 1A in illustrative arrangements to achieve a near-eye image with lateral and transverse fields of view Ør and Ør that are the same to the observer 47, that is for illustrative purposes a square image is provided to the retina 46. The pupil 44 is shown as at the common viewing distance e_{R} from the output light guiding surface 8 of the optical system 250.

FIG. 1F illustrates the transverse imaging property of the anamorphic near-eye display apparatus 100. Illumination system 240 is provided with top, centre and bottom illuminated pixels 222T. 222C. 222B across the transverse direction 197 with light rays output into the transverse anamorphic component 60 with optical power only in the transverse direction that collimates the output from each pixel 222L, 222C. 222R and directs towards the eye 45. Light rays 460T pass through the pupil 44 of the eye 45 onto the retina 46 of the eye 45 and create an off-axis image point 461T. Light rays 460C pass onto the retina 46 and create centre image point 461C and light rays 460B pass onto the retina 46 and create off-axis image point 461B.

FIG. 1G illustrates the lateral imaging property of the anamorphic near-eye display apparatus 100. Illumination system 240 is provided with right, middle and left illuminated pixels 222L, 222M, 222R across the lateral direction 195 with light rays output into the lateral anamorphic component 110 with optical power only in the lateral direction that collimates the output from each pixel 222L, 222M, 222R and directs towards the pupil 44 of the eye 45. Light rays 460L pass through the pupil 44 of the eye 45 onto the retina 46 of the eye 45 and create an off-axis image point 461L. Light rays 460M pass onto the retina 46 and create image point 461M and light rays 460R pass onto the retina 46 and create an image point 461R.

The observer perceives a magnified virtual image with the optical system 250 arranged between the virtual image 34 and the eye 45, with the same field of view ø in each of lateral and transverse directions 195, 197.

In the anamorphic near-eye display apparatus 100 of the present embodiments, the distance f_{T} between the first principal plane of the transverse anamorphic component 60 of the optical system 250 is different to the distance f_{L} between the first principal plane of the lateral anamorphic component 110 of the optical system 250. Similarly, for a square output field of view (or is the same as ØL), the separation D_{T} of pixels 222T, 222B in the transverse direction is different to the separation DL of pixels 222R, 222L in the lateral direction 195.

In the present description, the lateral angular magnification M_{L} provided by the lateral anamorphic component 110 of the optical system 250 may be given as

$${M}_{L} = ϕ {p}_{L} / {P}_{L} \qquad eqn . 5$$

and the transverse angular magnification MT provided by the transverse anamorphic component 60 of the optical system 250 may be given as:

$${M}_{T} = ϕ {p}_{T} / {P}_{T} \qquad eqn . 6$$

where ϕp_{L} is the angular size of a virtual pixel 36 seen by the eye in the lateral direction 195, P_{L} is the pixel pitch in the lateral direction 195, ϕp_{T} is the angular size of a virtual pixel 36 seen by the eye in the transverse direction 197, and P_{T} is the pixel pitch in the transverse direction 197. In the case that the angular virtual pixels 36 are square, then ϕp_{L} and ϕp_{T} are equal and the angular magnification provided by the lateral anamorphic component 110 may be given as:

$${M}_{L} = {M}_{T} * {P}_{T} / {P}_{L} \qquad eqn . 7$$

The angular magnification M_{L}, M_{T} of the lateral and transverse anamorphic optical elements 110, 60 is proportional to the respective optical power K_{L}, K_{T} of said elements 60, 110. The spatial light modulator 48 may comprise pixels 222 having pitches P_{L}, P_{T} in the lateral and transverse directions 195, 197 with a ratio P_{L}/P_{T} that is the same as K_{T}/K_{L}, being the inverse of the ratio of optical powers of the lateral and transverse anamorphic optical elements 110, 60.

The output coordinate system is illustrated in FIG. 1H wherein output light from a central pixel 225 is directed along optical axis 199(60) through the transverse anamorphic component 60 and into the extraction waveguide 1B, from which it is visible along the optical axis 199(44) at the pupil 44.

The row 221Tc of pixels 222 through the central pixel 225 that is extended in the lateral direction 195 is output as fan 491B_{L} of rays, each ray representing the angle at which a virtual pixel 38 is provided to the pupil 44 across the lateral direction 195.

The column 221Lc of pixels 222 through the central pixel 225 that is extended in the transverse direction 197 is output as fan 491B_{T} of rays, each ray representing the angle at which a virtual pixel 38 is provided to the eye 45 across the transverse direction 197.

For a pixel 227 arranged in a quadrant of the spatial light modulator 48 an output ray 427 is provided to the pupil 44 that is imaged first by the transverse anamorphic component 60 and then by the lateral anamorphic component 110.

Illustrative imaging properties of the anamorphic near-eye display apparatus 100 of FIG. 1A will now be described.

FIG. 1I is a schematic diagram illustrating a field-of-view plot of the output of the anamorphic near-eye display apparatus 100 of FIG. 1A for polychromatic illumination.

FIG. 1I is a graph of the transverse viewing angle against the lateral viewing angle. The lateral field of view ϕ_{L} is 60 degrees and the transverse field of view ϕ_{T} is 60 degrees.

Points with 0 degrees lateral field of view lie in the transverse light cone 491B_{L} while points with 0 degrees transverse field of view lie in the transverse light cone 491B_{T}. The relative aberrations at various image points are illustrated by blur point spread functions 452.

The lateral size 454_{L} and transverse size 454_{T} of the blur PSF 452 is determined by aberrations of the optical system 250. The elliptical blur PSF 452 is an illustrative profile of the relative blurring from a point at a pixel 227 on the spatial light modulator 48 when output as an angular cone to the eye 45 and thus represents the relative PSF size and location at the retina 46 of the eye 45 in the lateral and transverse directions 195, 197.

For illustrative purposes the blur point spread function (PSF) 452 is illustrated in FIG. 1I as an ellipse with lateral and transverse sizes 454_{L}, 454_{T}. More generally the shape of the blur PSF may be circular, elliptical, comatic, astigmatic or other profile, which may include scatter artefacts. The blur elliptical PSF 452 profile as illustrated may be used to describe the weighted blur PSF 452 in the lateral and transverse directions 195, 197. For illustrative reasons, the sizes 454_{T}, 454_{L} of the blur PSF 452 are illustrated as magnified on the scale of the plot of FIG. 1I, and do not represent the actual angular size of the blurring of each angular pixel at the pupil 44.

The sizes 454_{T}R, 454_{L}R of the blur PSF 452R for red pixels 222R may be different to the sizes 454_{T}B, 454_{L}B for the blur PSF 452B for blue pixels 222B. Further the centre of gravity of the blur PSF 452B may be displaced in lateral and transverse directions 195, 197 by colour blur 455_{L}, 455_{T} respectively.

Illustrative arrangements of pixels 222 of the spatially multiplexed spatial light modulator 48 will now be described.

FIGS. 2A-C are schematic diagrams illustrating in front view a spatial light modulator 48 for use in the anamorphic near-eye display apparatus 100 of FIG. 1A comprising spatially multiplexed red, green and blue sub-pixels 222R, 222G, 222B. Features of the embodiments of FIGS. 2A-C not discussed in further detail may be assumed to correspond to the features with equivalent reference numerals as discussed above, including any potential variations in the features.

The spatial light modulator 48 may be a transmissive spatial light modulator 48 such as an LCD as illustrated in FIG. 1A. Alternatively the spatial light modulator 48 may be a reflective spatial light modulator 48 such as Liquid Crystal on Silicon (LCOS) or a Microoptoelectromechanical (MOEMS) array of micro-mirrors such as the DMD from Texas Instruments. Alternatively the spatial light modulator 48 may be an emissive spatial light modulator 48 using material systems such as OLED or inorganic micro-LED. A silicon backplane may be provided to achieve high speed addressing of high resolution arrays of pixels 222.

In FIGS. 2A-C, the pixels 222 of the spatial light modulator 48 are distributed in the lateral direction 195(48) and also distributed in the transverse direction 197(48) so that the light output from the transverse anamorphic component 60 is directed in the directions that are distributed in the transverse direction 197 and the light output from the lateral anamorphic component 110 is directed in the directions that are distributed in the lateral direction 195 when output towards the pupil 44 of the eye 45.

White pixels 222 comprising red, green and blue sub-pixels 222R, 222G, 222B are provided spatially separated in the lateral direction 195 and the sub-pixels 222R, 222G, 222B are elongate with a pitch P_{L} in the lateral direction that is greater than the pitch P_{T} in the transverse direction 197.

Considering FIGS. 1C-D and the embodiments of FIGS. 2A-D, it may be desirable to provide square white pixels in the final perceived virtual image 34. The pitch P_{L} is magnified by the lateral anamorphic component to an angular size ϕ_{L} (with spatial pitch δ_{L} at the retina 46) and the pitch P_{T} is magnified by the transverse anamorphic component to an angular size ϕ_{T} (with spatial pitch or at the retina 46). The pitches P_{L}, P_{T} may be determined by said different angular magnifications to advantageously achieve square angular pixels from the anamorphic near-eye display apparatus 100.

The pixels 222 are arranged as columns 221L, wherein the columns 221L are distributed in the lateral direction 195, and the pixels along the columns 221L are distributed in the transverse direction 197; and the pixels 222 are further arranged as rows 221T, wherein the rows 221T are distributed in the transverse direction 197, and the pixels along the rows 221T are distributed in the lateral direction 195.

In FIG. 2A, the sub-pixels 222R, 222G, 222B are distributed in columns of red, green, and blue pixels. Advantageously vertical and horizontal image lines may be provided with high fidelity.

In the alternative embodiment of FIG. 2B, the sub-pixels 222R, 222G, 222B are distributed along diagonal lines. Advantageously reproduction of natural imagery may be improved in comparison to the embodiment of FIG. 2A.

The sub-pixels 222R, 222G, 222B may be provided by white light emission and patterned colour filters, or may be provided by direct emission of respective coloured light. The present embodiments comprise sub-pixel 222 pitch P_{L} that is larger than other known arrangements comprising a symmetric input lens for thin waveguides.

In the alternative embodiment of FIG. 2C, multiple blue pixels 222B1 and 222B2 may be provided. The blue pixels 222B1, 222B2 may be driven with reduced current for a desirable output luminance. Advantageously the lifetime of the pixels may be improved, for example when the spatial light modulator 48 is provided by an OLED microdisplay. In other embodiments, additional or alternative white pixels (for example with no colour filters) or a fourth colour such as yellow may be provided. Colour gamut and/or brightness and efficiency may advantageously be achieved.

FIG. 2D is a schematic diagram illustrating in front view a spatial light modulator 48 for use in the anamorphic near-eye display apparatus 100 of FIG. 1A with pixels 222 for use with temporally multiplexed spectral illumination. Features of the embodiment of FIG. 2D not discussed in further detail may be assumed to correspond to the features with equivalent reference numerals as discussed above, including any potential variations in the features.

The spatial light modulator 48 may be used for monochromatic illumination. In alternative embodiments wide colour gamut imagery may be provided by time sequential illumination, for example by red, green and blue illumination in synchronisation with red, green and blue image data provided on the spatial light modulator 48. Advantageously image resolution may be increased.

In comparison to non-anamorphic image projectors in which equal angular magnification is provided between the lateral direction 195 and transverse direction 197, the present embodiments provide pixel pitch P_{L} that is substantially increased in size for a given angular image size and magnification in the transverse direction 197. Such increased size may advantageously achieve increased brightness, increased efficiency and reduced alignment tolerances for the spatial light modulator 48 and illumination system 240.

In colour filter type spatial light modulators 48, the size of colour filters may be increased. Advantageously cost and complexity of colour filters may be reduced. The aperture ratio of the pixels 222 may be increased. In direct emission displays the size of the emitting region may be increased. Advantageously cost and complexity of fabricating the pixels may be reduced and brightness increased. In inorganic micro-LED spatial light modulators 48, efficiency loss due to recombination losses at the edges of pixels may be reduced and system efficiency and brightness advantageously increased.

Input of light into the anamorphic near-eye display apparatus 100 of FIG. 1A will now be further described.

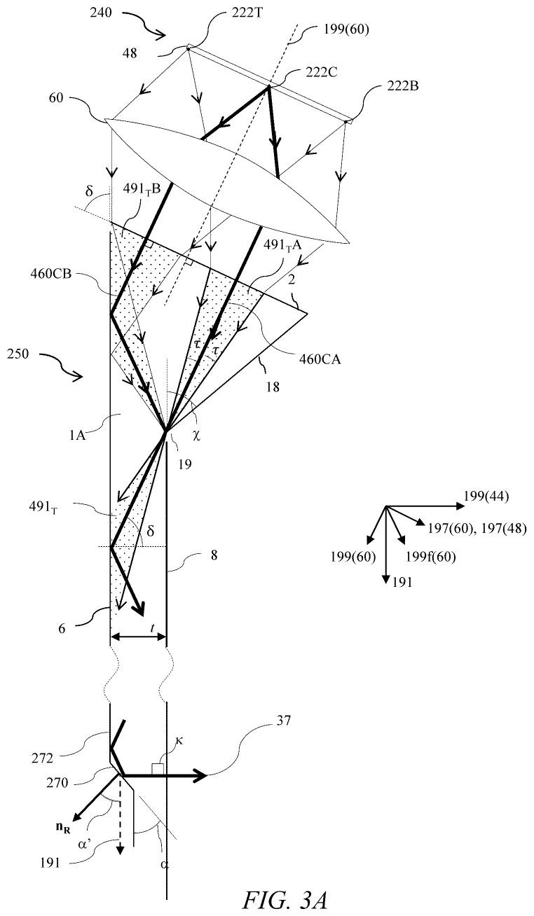

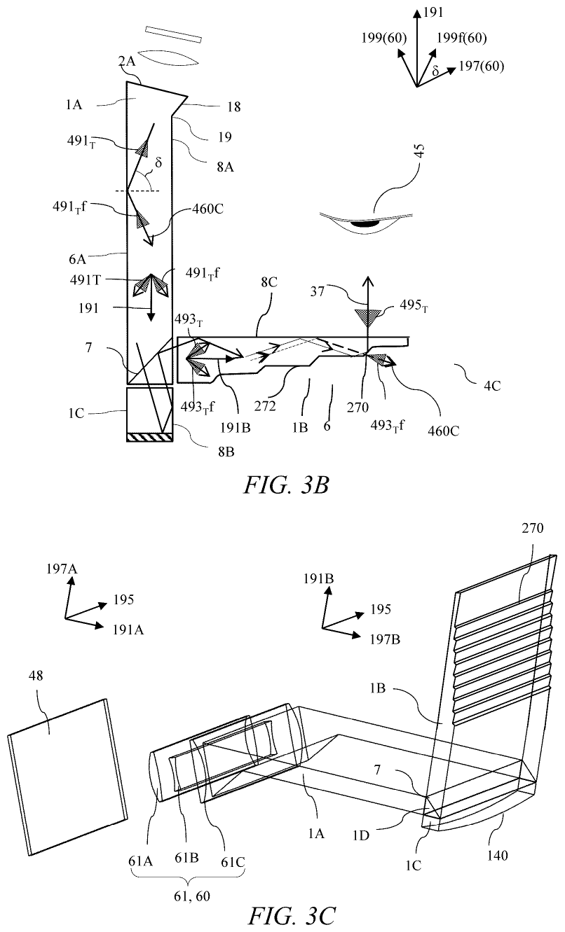

FIG. 3A is a schematic diagram illustrating a top view of light input into the input waveguide 1A; FIG. 3B is a schematic diagram illustrating a top view of light propagation along the first direction 191A in the input waveguide 1A and a different direction 191B in the extraction waveguide 1B; and FIG. 3C is a schematic diagram illustrating a perspective view of anamorphic near-eye display apparatus 100 of FIG. 1A. Features of the embodiments of FIGS. 3A-C not discussed in further detail may be assumed to correspond to the features with equivalent reference numerals as discussed above, including any potential variations in the features.

The input of transverse light cones 491A_{T} into the input waveguide 1A will now be described with reference to FIG. 3A.

In the illustrative embodiment of FIG. 3A, the input face 2A of the input waveguide 1A is inclined, in particular having a surface normal that is inclined at angle δ with respect to the surface normal to the rear and front guide surfaces 6, 8, that is the input face 2A is inclined at angle δ with respect to the first direction 191A along the input waveguide 1A.

Spatial light modulator 48 and transverse anamorphic component 60 formed by the transverse lens 61 are inclined at the angle δ with respect to the normal to the rear and front guide surfaces 6, 8. The direction of the optical axis 199(60) through the transverse anamorphic component 60 is thus inclined with respect to the first direction 191A along the input waveguide 1A. The optical axis 199(60) direction is typically parallel to the surface normal of the input face 2A, such that the optical axis direction 199(60) is inclined at the angle 90-δ with respect to the first direction 191A. Referring to FIG. 1I, advantageously improved aberrations may be achieved and the height 454 of the pixel blur ellipse 452 may be reduced in at least the transverse direction 197.

The optical system 250 further comprises a tapered surface 18 that is a surface inclined at angle χ provided near the input face 2A to direct light bundles in the transverse direction 197 from the transverse anamorphic component 60 into the input waveguide 1A at desirable angles of propagation. The tapered surface 18 is arranged between the input face 2A and the light guiding surface 8, with surface normal direction inclined at an angle χ with respect to the surface normal to the light guiding surface 8. In alternative embodiments, the tapered surface 18 may be arranged on the first light guiding surface 6.

TABLE 1 shows an illustrative embodiment of the geometry of the arrangement of FIG. 3A for an extraction waveguide 1B refractive index of 1.5.

TABLE 1

| Angle compared to direction 191A along | |
|---|---|
| the input waveguide 1A and direction | Illustrative |
| 191B along the extraction waveguide 1B | embodiment |
| Input side 2 inclination δ | 60° |
| Tapered surface 18 inclination χ | 44° |
| Cone 491A_{T} half angle in the material of the waveguide, τ | 10° |
| Extraction reflector 270 tilt angle α | 60° |
| Intermediate surface 272 tilt angle ν | 0° |
| Angle of incidence of central output ray 460C at output | 90° |
| surface, 8 κ | |

Central pixel 222C provides illumination to the transverse anamorphic component 60 with illustrative light rays 460CA, 460CB. Light ray 460CA is input through the input face 2A without deflection and is directed to just miss the interface 19 of the tapered surface 18 and the second light guiding surface 8, and is thus undeflected. Light ray 460CB is however incident on the region of the first light guiding surface 6 opposite the tapered surface 18 and is reflected by total internal reflection to the same interface 19, at which it is just totally internally reflected, such that the rays 460CA, 460CB overlap and are guided in the first direction 191A along the input waveguide 1A.

The extraction reflectors 270 desirably have a surface normal direction n_{R} that is inclined with respect to the direction 191B along the extraction waveguide 1B by an angle α′(which in FIG. 3A is 90-α) in the range 20 to 40 degrees, preferably by an angle in the range 25 to 35 degrees and most preferably by an angle in the range 27.5 degrees to 32.5 degrees. Advantageously such an arrangement reduces stray light rays.

In alternative embodiments, the extraction reflectors may have an angle α′ that is in the range 50 to 70 degrees, preferably have an angle in the range 55 to 65 degrees and most preferably have an angle in the range 57.5 degrees to 62.5 degrees. Such arrangement directs light ray 460C through the light guiding surface 8 when the ray has not reflected from the intermediate surface 272 after reflection from the light guiding surface 8.

The embodiment of TABLE 1 illustrates a design for refractive index of 1.5. The refractive index of the input waveguide 1A and extraction waveguide 1B may be increased, for example to a refractive index of 1.7 or greater. Advantageously the size of the light cone ϕ_{T} may be increased and a larger angular image seen in the transverse direction.

The outer pixels 222T, 222B in the lateral direction 195(48) define the outer limit of light cones 491A_{T}A, 491A_{T}B that propagate at angles τ either side of rays 460CA, 460CB. The tapered surface 18 is provided such that the whole of the light cone 491A_{T}A is not deflected near to the input face 2A, advantageously achieving reduced cross-talk and high efficiency. After the light cones 491A_{T}A, 491A_{T}B pass the interface 19, then they recombine to propagate along the extraction waveguide 1B.

The propagation of transverse light cones 491A_{T} along the input waveguide 1A in the first direction 191A will now be described with reference to FIG. 3B for which the extraction reflectors 270 are omitted for clarity of explanation.

FIG. 3B further illustrates the propagation of corresponding reflected light cones 493_{T}, 493_{T}f after reflection at the light reversing component 140. On-axis light ray 37 from a central pixel 222 of the spatial light modulator 48 is directed through the transverse anamorphic component 60 into the input waveguide 1A.

The direction of the optical axis 199(60) through the transverse anamorphic component 60 is inclined at angle δ that is inclined at angle 90-δ to the first direction 191A along the input waveguide 1A.

After the interface 19, the light cone 491A_{T} is incident on the first light guiding surface 6 with an angle of incidence δ and is reflected by total internal reflection such that a replicated light cone 491A_{T}f is provided propagating along the input waveguide 1A in the direction 191A.

In the transverse direction, the lateral anamorphic component 110 has no optical power and has a surface normal direction n₄ that is desirably parallel to the direction 191A. The visibility of artefacts arising from stray light including double images and ghost images may be reduced.

The reflected light cones 491B_{T}. 491B_{T}f propagate along the second direction 191B with angle τ about optical axes 199(60) and 199f(60). Corresponding transverse directions 197(60), 197f(60) are also indicated.

Both cones 491B_{T}, 491B_{T}f comprise image data that between the cones 491B_{T}. 491B_{T}f is flipped about the direction 191A and thus provides degeneracy of ray directions for a given pixel 222 on the spatial light modulator 48. It is desirable to remove such degeneracy so that only one of the cones 491B_{T}, 491B_{T}f is extracted and a secondary image is not directed to the pupil 44 of the eye 45.

Central output light ray 37 propagates by total internal reflection of opposing surfaces 6, 8 until it is incident on an intermediate surface 272 at which at least some light is reflected, and then at extraction reflector 270 at which at least some light is further reflected as will be described further hereinbelow such that light cone 491B_{T} is preferentially directed towards the second light guiding surface 8. After refraction at the light guiding surface 8, light in the cone 495T is extracted towards the eye 45, with a cone angle that has increased size compared to the cone 491B_{T}.

The extraction reflectors 170A-E are inclined at the same angle, a such that for each of the light extraction reflectors 170A-E of FIG. 1A, the light cones 491B_{T} are parallel and image blur for light extracted to the pupil 44 from different extraction reflectors 270 across the waveguide is advantageously reduced.

By way of comparison, the light cone 491B_{T}f around central light rays 460C which are incident on the surface 8 and then are directly incident on extraction reflector 270 without first reflecting from the intermediate surface 272 have an angle of incident that is different to the angle of incident 8. The difference in angle of incidence provides for preferential transmission through the extraction reflector 270, and light cone 491B_{T}f is not directed towards the eye 45. Degeneracy is reduced or removed and image cross-talk advantageously reduced.

The inclined input face 2A and inclined transverse anamorphic component 60 thus provide cones 491B_{T}. 491B_{T}f that are not overlapping with one of said cones preferentially extracted towards the eye 45 and the other cone preferentially retained within the extraction waveguide. The tilted input face 2A and tilted transverse anamorphic component 60 thus advantageously achieve a single image visible to the eye 45 and double images are minimised. In some of the illustrative embodiments hereinbelow, the surface normal of the input face 2A is not inclined to the first direction 191A, however that is to simplify the illustrations hereinbelow rather than a typical arrangement.

In alternative embodiments (not shown), the central output ray 37 may be inclined to the surface normal to the light guiding surface 8, for example to adjust the angular location of the centre of the field of view of the extracted light cone 495T.

FIG. 3C is similar to the embodiment of FIG. 1A, comprising input taper 18 and a transverse anamorphic component 60 comprising compound lens 61 comprising lens elements 61A, 61B, 61C. Advantageously improved aberrations may be provided in the transverse direction 197 in comparison to the singlet of FIG. 1A.

Pupil expansion in the transverse direction will now be described.

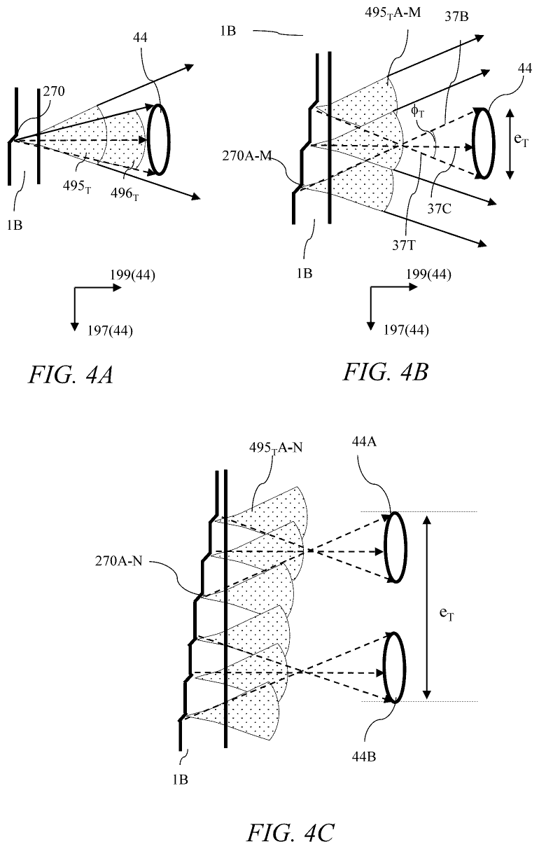

FIG. 4A is a schematic diagram illustrating a top view of light output from the anamorphic near-eye display apparatus 100 for a single extraction reflector 270; FIG. 4B is a schematic diagram illustrating a top view of light output from the anamorphic near-eye display apparatus 100 for multiple extraction reflectors 170A-N to achieve a full ray cone input in the transverse direction 197(44) into the observer's pupil 44; FIG. 4C is a schematic diagram illustrating a top view of light output from the anamorphic near-eye display apparatus 100 for multiple locations for a moving observer 47 in the transverse direction 197(44). Features of the embodiments of FIGS. 4A-C not discussed in further detail may be assumed to correspond to the features with equivalent reference numerals as discussed above, including any potential variations in the features.

The array of extraction reflectors 270 are distributed along the extraction waveguide 1B so as to provide exit pupil 40 expansion that is increasing the size e_{R} of the eyebox 40 in the transverse direction 197 as will now be described.

Considering FIG. 4A, a single extraction reflector 170 is arranged to output light cone 495T towards the pupil 44. However, the limited size of the pupil 44 determines that only those light rays within the partial light cone 496T are received by the eye 45 and the field of view of the image observed on the retina in the transverse direction 197(44) is smaller than that input into the extraction waveguide 1B. It would be desirable to increase the field of view of observation.

Considering FIG. 4B, multiple extraction reflectors 170A-M are provided sufficient to provide light rays 37C, 37T, 37B from the full cone 495T. The pupil 44 has a height greater than the pitch of the extraction reflectors 270. For example the pitch of the extraction reflectors 270 may be 1 mm and the nominal diameter of the pupil 44 may be 3 mm to 6 mm. The pupil receives light from multiple extraction reflectors 170A-M, and the field of view ϕ_{T} observed is the same as that input into the extraction waveguide 1B at the input end. The exit pupil 40 has a size e_{T} that is the same as the pupil 44 height in this limiting case.

Considering FIG. 4C, further extraction reflectors 170A-N are provided sufficient to provide movement of the pupil 44 between pupil 44A location and pupil 44B location. In this manner e_{R} is increased and exit pupil expansion in the transverse direction is achieved. A transverse field of view or is provided over an extended pupil 44 location advantageously achieving increased comfort of use and full image visibility.

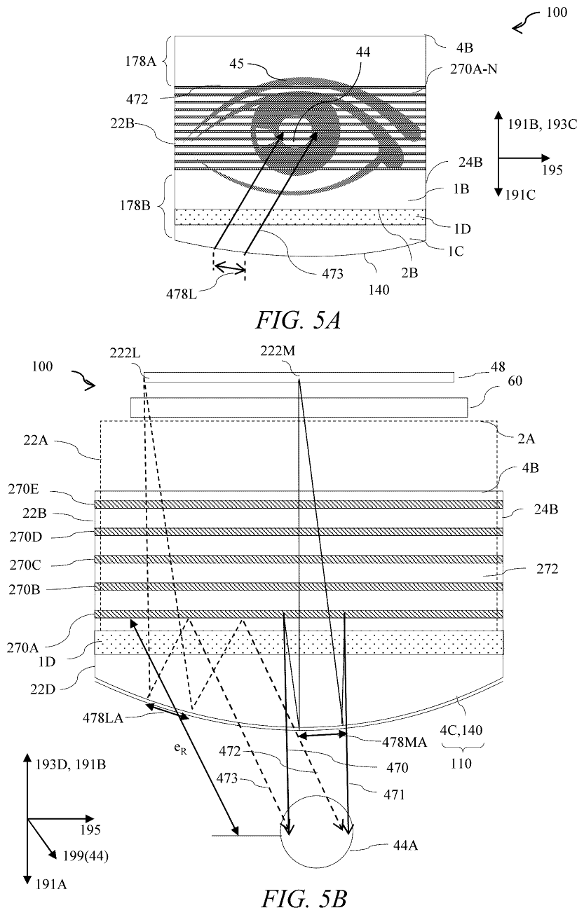

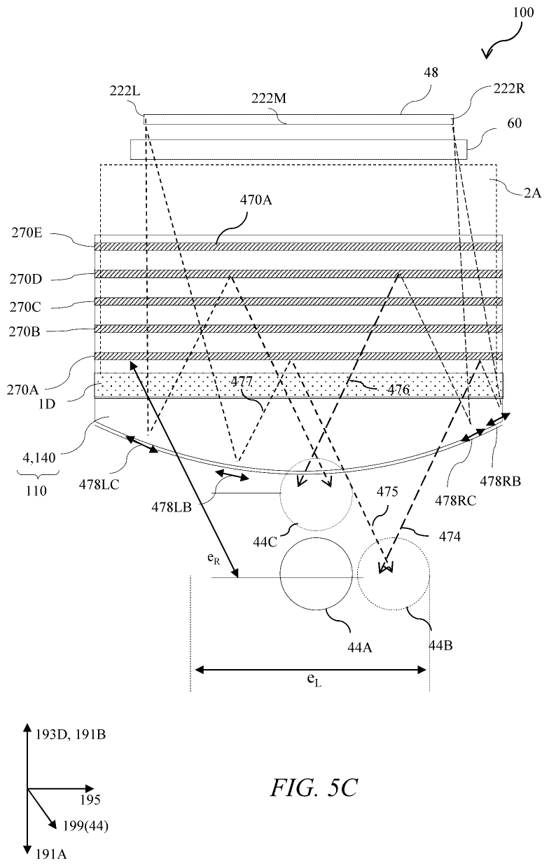

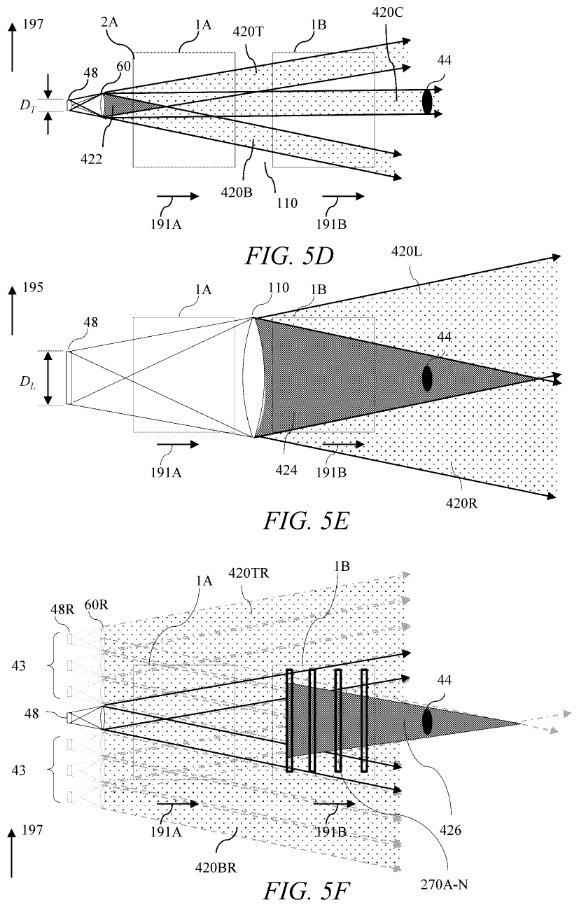

As will be described in FIGS. 5A-E hereinbelow, the lateral anamorphic component 110 further provides exit pupil 40 expansion in the lateral direction 195, that is increasing the size ϕ_{T} of the eyebox 40 in the lateral direction 195.

The imaging properties of the anamorphic near-eye display apparatus 100 in the lateral direction 195 will now be considered further.

FIGS. 5A-C are schematic diagrams illustrating front views of light output from the anamorphic near-eye display apparatus of FIG. 1A. Features of the embodiments of FIGS. 5A-C not discussed in further detail may be assumed to correspond to the features with equivalent reference numerals as discussed above, including any potential variations in the features.

FIG. 5A illustrates that a non-extracting light guiding region 178A is arranged between the input face 2B of the extraction waveguide 1B and the first extraction reflector 270 of the array of extraction reflectors 170A-N; and a non-extracting light guiding region 178B is arranged between the array of extraction reflectors 170A-N and the lateral anamorphic component 110. Non-extracting guiding sections 178A, 178B may provide increased height of the extraction waveguide 1B in the direction 191B without extraction reflectors 270. Efficiency of extraction is advantageously improved, and aberrational performance of the lateral anamorphic component 110 is further improved.

In the embodiment of FIG. 5A, the eye 45 is aligned in plan view and out-of-plane rays are not shown, however such a description provides an insight into the operation of the anamorphic near-eye display apparatus 100 in the lateral direction 195. More than one extraction reflector 270 overlays the pupil 44 of the eye 45. For example, the pitch of the extraction reflector 270 is 1 mm and three to six extraction reflectors 270 are provided across the pupil 44 of the eye 45 depending on the dilation of the pupil 44 of the eye 45. Advantageously luminance variation with eye position 45 may be reduced.

The pupil 44 sees the off-axis rays from pixel 222L at the edge of the spatial light modulator 48 after reflection from a region 478L of the lateral anamorphic component 110. While the lateral anamorphic component 110 in its entirety is a relatively fast optical element and thus prone to aberrations, particularly from its edges, the region 478 of the lateral anamorphic component 110 that is directing light into the pupil 44 for any one eye 45 location is small, and thus aberrations from the lateral anamorphic component 110 are correspondingly reduced. Considering FIG. 1I, desirably small width 455 of the blur ellipse 452 may be achieved.

In the embodiment of FIG. 5B, the eye 45 is aligned with out-of-plane rays to illustrate exit pupil 40 expansion in the lateral direction 195. FIGS. 5B-C further illustrate that the length and width of the extraction waveguide 1B may be different to those of the input waveguide 1C. Advantageously the display apparatus 100 may be arranged to provide desirable physical size and pupil 40 size.

Light rays 470, 471 are directed from a central pixel 222M across the lateral direction 195 of the spatial light modulator 48 and transmitted through the transverse anamorphic component 60 formed by the transverse lens 61 without optical power in the lateral direction 195 and into the extraction waveguide 1B. Said light rays 470, 471 propagate in the direction 191A of the input waveguide 1A to the input face 2B of the extraction waveguide 1B which provides positive optical power in the lateral direction 195 by means of the light reversing reflector which provides the lateral anamorphic component 110.

Such light rays 470, 471 are reflected at the extraction reflector 170A away from the plane of the extraction waveguide 1B to the pupil 44 of the eye 45A at the viewing distance e_{R}. The eye 45 collects the rays 470, 471 and directs them to the same point on the retina 46 to provide a virtual pixel location as described elsewhere herein.

Similarly for off-axis pixel 222L offset in the lateral direction 195(48), at the edge of the spatial light modulator 48 provides rays 472, 473 that are directed into the extraction waveguide 1B, directed at region 478LA of the lateral anamorphic component 110 and reflected by extraction reflector 170A to the eye 45A to provide an off-axis image point in the lateral direction 195(44) on the retina 46.

The lateral anamorphic component 110 has a positive optical power that provides collimated optical rays from each image point 222L, 222M in the lateral direction 195. In this manner the lateral distribution of field points are provided across the retina 46 by means of the optical power of the lateral anamorphic component 110, while the transverse anamorphic component 60 has optical power to provide the transverse distribution of field points across the retina 46. At diagonal field angles, such as illustrated in FIG. 1H with regards to the imaging of pixel 227, the field points are provided by a combination of the lateral and transverse optical powers of the lateral anamorphic component 110 and transverse anamorphic component 60 respectively.

FIG. 5C illustrates exit pupil expansion in the lateral direction 195 and in the transverse direction 197. Rays 474, 475 for pixels 222R. 222L are directed to pupil 44B by reflection from regions 478RB, 478LB respectively of the lateral anamorphic component 110. Pupil 44B is offset from the pupil 44A in the lateral direction 195, wherein the rays 474, 475 are reflected at least by the extraction reflector 170A. The width e_{L} of the exit pupil 40 is thus increased by the relatively large width of the lateral anamorphic component 110 allowing the regions 478 to be arranged over a desirable width. The viewing freedom of the eye 45 in the exit pupil 40 is increased, advantageously increasing viewing comfort for the eye 45 while achieving full field of view in the lateral direction.

FIG. 5C further illustrates the pupil expansion in the transverse direction 197. Light that is reflected from extraction reflectors 170D is directed to pupil 44C that has a different height to the pupil 44A, as discussed hereinbefore with respect to FIG. 4C.

Exit pupil 40 expansion will now be further illustrated.

FIG. 5D is a schematic diagram illustrating a top view of the imaging system arranged to image in the transverse direction 197 wherein reflective extraction features 169 (for example extraction reflectors 270) are provided; FIG. 5E is a schematic diagram illustrating a schematic top view of an imaging system arranged to image in the lateral direction; FIG. 5F is a schematic diagram illustrating a top view of an imaging system arranged to image in the transverse direction wherein an array of extraction reflectors 270 is provided, although the description is similarly applicable to other reflective extraction features. Features of FIGS. 5D-F not discussed in further detail may be assumed to correspond to the features with equivalent reference numerals as discussed above, including any potential variations in the features.

Considering FIG. 5D, light from spatial light modulator 40 illuminates transverse anamorphic component 60 and inputs light rays into input waveguide 1A in direction 191A. Light passes through the lateral anamorphic component 110 without modification and into extraction waveguide 1B in direction 191B. Ray bundles 420T, 420C, 420B are provided across the transverse direction for pixels 222T, 222C, 222B respectively on the spatial light modulator 48. The pupil 44 of the eye 45 only observes the full ray cone if located in the cone 422 which is close to the lens and thus not accessible to the eye 45. This is analogous to the illustrative embodiment of FIG. 4A.

Considering FIG. 5E, light from spatial light modulator 40 illuminates lateral anamorphic component 110 and inputs light rays into input waveguide 1A in direction 191A. The light cone in the lateral direction from the pixels 222L, 222M, 222R is collimated by the lateral anamorphic component 110 and passes into the extraction waveguide 1B in direction 191B. Ray bundles 420L, 420M, 420R are provided across the transverse direction. The pupil 44 of the eye 45 observes the full ray cone if located in the cone 424 which is accessible to the eye outside the extraction waveguide 1B because of the much larger width of the lateral anamorphic component 110 compared to the transverse anamorphic component 60. This is analogous to the illustrative embodiment of FIG. 5B.

The effect of the extraction reflectors 270 on pupil expansion in the transverse direction 197 will now be further illustrated.

In comparison to FIG. 5D, FIG. 5F illustrates the array of extraction reflectors 270 being distributed along the extraction waveguide 1B so as to provide exit pupil 40 expansion. Each of the extraction reflectors 170A-N effectively provides replicated images 48R, 60R of the spatial light modulator 48 and transverse anamorphic component 60 respectively. Such replicated images 48R, 60R further provide replicated light cones 420 of FIG. 5D, expanding the effective width of the final light cones 420TR, 420BR. Such replication provides replicated cone 426, from within which the pupil 44 receives light for the full field angles.

The cones 422, 424, 426 represent schematically the exit pupil 40 of the anamorphic near-eye display apparatus in the lateral direction 195 or transverse direction 197. Thus in comparison to the exit pupil 40 represented by cone 422 that by way of comparison would be provided for a conventional micro-projector without pupil expansion, exit pupil 40 expansion is achieved by the lateral anamorphic component 110 and by the array of extraction reflectors 170A-N that form reflective extraction features 169.

Alternative arrangements of anamorphic near-eye display apparatuses 100 will now be described.

FIG. 6A is a schematic diagram illustrating a schematic side perspective view of an alternative anamorphic near-eye display apparatus. Features of the embodiments of FIG. 6A not discussed in further detail may be assumed to correspond to the features with equivalent reference numerals as discussed above, including any potential variations in the features.

By way of comparison with FIG. 1A, in the alternative embodiment of FIG. 6A the air gap 3CB is omitted, and the partially reflective mirror 7 may be formed on or within the extraction waveguide 1B such that mirror waveguide 1D is not a separate element. Advantageously alignment cost and complexity may be reduced, and stray light reduced achieving improved image fidelity.

Alternative arrangements of reflective extraction features 169 will now be described.

FIG. 6B is a schematic diagram illustrating a exploded perspective view of an alternative near-eye anamorphic display apparatus wherein the partially reflective mirror is provided between the light guiding surfaces of the extraction waveguide and the extraction features are provided on a light guiding side of the extraction waveguide; FIG. 6C is a schematic diagram illustrating a schematic front perspective view of an alternative near-eye anamorphic display apparatus wherein the partially reflective mirror and extraction features are provided between the light guiding surfaces of the extraction waveguide; and FIG. 6D is a schematic diagram illustrating a schematic exploded front perspective view the embodiment of FIG. 6C. Features of the embodiment of FIGS. 6B-D not discussed in further detail may be assumed to correspond to the features with equivalent reference numerals as discussed above, including any potential variations in the features.

By way of comparison with FIG. 1A, in the alternative embodiments of FIGS. 6B-D the front and rear guide surfaces 8B, 6B of the extraction waveguide 1B are planar and parallel and the light extraction features 169 are disposed internally within the extraction waveguide 1B as will be described further hereinbelow. The extraction waveguide 1B comprises an array of extraction reflectors 170 disposed internally within the extraction waveguide 1B, the extraction reflectors 170 being arranged to extract light guided along the extraction waveguide 1B in the direction 191B towards an eye 45 of a viewer. The array of extraction reflectors 170 are distributed along the extraction waveguide 1B so as to provide exit pupil expansion. The extraction reflectors 170 are inclined with respect to the direction 191B along the optical axis 199 of the extraction waveguide 1B and extend partially across the extraction waveguide 1B between the opposing rear and front guide surfaces 6B, 8B.

Folded arrangements of near-eye anamorphic display apparatuses 100 will now be described.

FIG. 6E is a schematic diagram illustrating a top view of a folded near-eye anamorphic display apparatus 100 comprising a further turning prism wherein the extraction waveguide is arranged between the input waveguide and the eye; and FIG. 6F is a schematic diagram illustrating a top view of a folded near-eye anamorphic display apparatus comprising an input waveguide further comprising a light turning surface wherein the input waveguide is arranged between the extraction waveguide and the eye. Features of the embodiments of FIGS. 6E-F not discussed in further detail may be assumed to correspond to the features with equivalent reference numerals as discussed above, including any potential variations in the features.

By way of comparison with FIG. 6A, the alternative embodiment of FIG. 6E illustrates that a further turning prism 1E that may be a turning waveguide with edges 22E, 24E and separated by air gaps 3AE, 3EB may be provided. Partially reflective mirror 7 is provided within extraction waveguide 1B.

Light rays 32 from real-world object points 31 are transmitted by waveguides 1A, 1B respectively. Advantageously compactness may be improved and the rear surface 6B protected from damage.

By way of comparison with FIG. 6E, the alternative embodiment of FIG. 6F illustrates an embodiment wherein the input waveguide 1A is arranged next to the front surface 8B of the extraction waveguide 1B. Advantageously the planar guiding surfaces 8B, 6A may be protected. Further the end 4A of the input waveguide 1A is inclined to direct light from the input waveguide 1A towards the partially reflective mirror 7. Advantageously cost and complexity may be reduced.

FIG. 6F further illustrates that the illumination system 240 may be arranged in the brow position for the observer. Improved compactness may be achieved.

Alternative guided light cone redirecting arrangements will now be described.

FIG. 6G is a schematic diagram illustrating a top view of a turning prism arranged to redirect guided light cones through angles different to 90 degrees; FIG. 6H is a schematic diagram illustrating a top view of a turning prism with air gaps arranged to redirect guided light cones through 90 degrees;

FIG. 6I is a schematic diagram illustrating a top view of turning prisms with air gaps arranged to redirect guided light cones through 180 degrees; FIG. 6J is a schematic diagram illustrating a top view of a turning prism with no air gaps arranged to redirect guided light cones through 90 degrees; and FIG. 6K is a schematic diagram illustrating a top view of a turning prism with no air gaps arranged to redirect guided light cones through 180 degrees. Features of the embodiments of FIGS. 6G-K not discussed in further detail may be assumed to correspond to the features with equivalent reference numerals as discussed above, including any potential variations in the features.

FIG. 6G illustrates the folding of part of an optical system 250 comprising a first waveguide 1X and a second waveguide 1Y, with a turning component 1T arranged therebetween, separated by respective air gaps 3XT, 3TY. Input light rays 401 are guided along the waveguide 1X, redirected by a mirror face 17 of the turning component 1T (that may comprise a specular reflective coating such as a metallic coating) and output to waveguide 1Y. For turning angle θ different turning component 1T has internal angles θ, and 45°−θ/2 as illustrated.

FIG. 6H illustrates the effect of the air gaps 3XT, 3TY to provide transfer of guided ray 401 from the waveguide 1X to the waveguide 1Y. By comparison, FIG. 6J illustrates that the absence of air gaps 3XT, 3TY means that the guided ray in waveguide 1X can be undesirably lost from the system. Thus the highly selective air-gap boundaries 3XT, 3TY provide total internal reflection for light reflected from mirror face 17 within the turning component 1T to achieve efficient coupling to waveguide 1Y. Alternatively light rays from waveguide 1X may be directly output into the waveguide 1Y. Thus the air gaps 3XT, 3TY achieve high transmission efficiency and further preserves the angular distribution of light rays from waveguide 1X into waveguide 1Y. Advantageously image fidelity is increased, with reduced pixel blur and distortion.

Light ray 401 can pass through the air gaps 3XT, 3TY with small reflection losses, said losses can desirably be reduced by the addition of anti-reflection coatings on the faces facing across the air gap.

In the alternative embodiment of FIG. 6I, air gaps 3XT_{A}, 3T_{A}T_{B} and 3T_{B}Y are arranged between turning components 1T_{A}, 1T_{B} and waveguides 1X, 1Y. Light ray 401 is redirected into waveguide 1Y with small losses and preserving angular distribution of the input light and with low losses at the respective air gaps 3. By way of comparison FIG. 6K illustrates that the light ray 401 may not be coupled into the waveguide 1Y if the air gaps 3 are omitted.

Such air gaps 3 may advantageously be provided between the elongate waveguides 1 and turning components or waveguides 1 of the embodiments described elsewhere herein to achieve high efficiency, improved compactness and high image fidelity.

FIGS. 7A-B are schematic diagrams illustrating a top view of polarisation state propagation in alternative arrangements of anamorphic near-eye display apparatuses. Features of the embodiments of FIGS. 7A-B not discussed in further detail may be assumed to correspond to the features with equivalent reference numerals as discussed above, including any potential variations in the features.

By way of comparison with FIG. 1B, the alternative embodiment of FIG. 7A comprises extraction reflectors 170 disposed internally within the extraction waveguide 1B. However the polarisation of light suitable for efficient reflection at the partially reflective mirror 7 is the same in FIG. 1B and FIG. 7A.

The extraction reflectors 170 extend partially across the extraction waveguide 1B between opposing rear and front guide surfaces 6, 8 of the extraction waveguide 1B with successively shifted positions. The successively shifted positions are arranged along the waveguide in the direction 191B. In other words, in the transverse direction 197 the extraction reflectors 170 extend partially across the extraction waveguide 1B with successively shifted positions.

The input linear polariser 70 disposed between the spatial light modulator 48 and the partially reflective mirror 7 which in the embodiment of FIG. 1B is between the transverse anamorphic component 60 and the input waveguide 1A. The input linear polariser 70 is an absorbing polariser such as a dichroic iodine polariser arranged to transmit a linear polarisation state 904, 902 and absorb the orthogonal polarisation state 902, 904 respectively.

In the alternative embodiment of FIG. 7A, the polariser 70 may be arranged to transmit the s-polarised polarisation state 904 that may be preferentially reflected from the partially reflective mirror 7 and towards the intermediate waveguide 1C. A polarisation conversion retarder 72C is disposed between the partially reflective mirror 7 and the light reversing reflector 140, the polarisation conversion retarder 72C being arranged to convert a polarisation state of light passing therethrough between a linear polarisation state 904 and a circular polarisation state 924, wherein the polarisation conversion retarder 72C has a retardance of a quarter wavelength at a wavelength of visible light, for example 550 nm; that is the polarisation conversion retarder 72C may be a quarter wave retardation at a visible wavelength such as 550 nm and may comprise a stack of composite retarders arranged to achieve the operation of a quarter wave retarder over an increased spectral band, for example comprising a Pancharatnam stack. Improved chromaticity of output may be achieved.

After reflection at the light reversing reflector 140, orthogonal circular polarisation state 922 is provided and the polarisation conversion retarder 72C provides p-polarisation linear state 902 back towards the partially reflective mirror 7 that is preferentially transmitted towards the extraction waveguide 1B. Increased transmission of the partially reflective mirror 7 may be achieved for light rays propagating towards the extraction waveguide 1B.

The optical system 250 further comprises a further polarisation conversion retarder 72B disposed between the partially reflective mirror 7 and the extraction waveguide 1B, the polarisation conversion retarder 72B being arranged to convert a polarisation state of light passing therethrough between a linear polarisation state 902 and an orthogonal linear polarisation state 904, wherein the further polarisation conversion retarder 72B has a retardance of a half wavelength at a wavelength of visible light. As will be described hereinbelow, the further polarisation conversion retarder 72B provides polarisation state 904 incident onto the extraction reflectors 170. Advantageously improved efficiency may be achieved as will be described hereinbelow.

By way of comparison with FIG. 1E, the alternative embodiment of FIG. 7B comprises extraction reflectors 170 disposed internally within the extraction waveguide 1B. The input linear polariser 70 is disposed between the spatial light modulator 48 and the transverse anamorphic component 60.

In the alternative embodiment of FIG. 7B, the polariser 70 may be arranged to transmit the p-polarised polarisation state 902 that may be preferentially transmitted by the partially reflective mirror 7 and towards the intermediate waveguide 1C. The polarisation conversion retarder is arranged to convert a polarisation state of light passing therethrough between a linear polarisation state 902 and a circular polarisation state 922. After reflection at the light reversing reflector 140, orthogonal circular polarisation state 924 is provided and the polarisation conversion retarder 72C provides s-polarisation linear state 904 back towards the partially reflective mirror 7 that is preferentially reflected towards the extraction waveguide 1B. Increased reflectivity of the partially reflective mirror 7 may be achieved for light rays propagating towards the extraction waveguide 1B.

The further polarisation conversion retarder 72C of FIG. 7A is omitted so that the polarisation state 904 is preferentially reflected by the reflection extractors 170. Advantageously efficiency is increased.

The operation of the extraction reflectors 170 will now be further described.

FIGS. 7C-D are schematic diagrams illustrating top views of the extraction waveguide 1B and of propagation of polarised light in the extraction waveguide 1B around an extraction reflector 170 comprising a single dielectric partially reflective layer 184; and FIG. 7E is a schematic diagram illustrating a top view of propagation of polarised light in the extraction waveguide 1B around a light reflecting feature comprising a stack of dielectric layers. Features of the embodiment of FIGS. 7C-E not discussed in further detail may be assumed to correspond to the features with equivalent reference numerals as discussed above, including any potential variations in the features.

In the alternative embodiments of FIG. 7D and FIG. 7E, the extraction waveguide 1B comprises plural constituent parts 11A. 11B having facing stepped surfaces 7A, 7B attached together, the stepped surfaces of the constituent parts 11A. 11B being shaped with alternating extraction surfaces 170 extending in the transverse direction 197(60) and intermediate surfaces 172 extending along the extraction waveguide 1B, wherein the extraction reflectors 170 comprise the facing extraction surfaces 7A, 7B.

In an illustrative method of fabrication, the extraction waveguide 1B may comprise a first plural constituent part 11A comprising light guiding surface 8 and stepped surface 7A and has the dielectric coating 184A formed on the stepped surface 7A. A second plural constituent part 11B comprising light guiding surface 6 and stepped surface 7B is aligned to the first plural constituent part 11A and an adhesive layer 184B is provided to attach the two stepped waveguides such that the extraction reflectors 170 are disposed internally within the extraction waveguide 1B.

In the embodiment of FIGS. 7C-E the extraction reflectors 170 comprise extraction surfaces 167A, 167B spaced apart by a partially reflective coating 184. Further the intermediate reflectors 172 comprise intermediate surfaces 182A, 182B spaced apart by the partially reflective coating 184.

The partially reflective coating 184 comprises at least one dielectric layer 186 and in the embodiment of FIGS. 7C-D comprises a primary dielectric layer 186 and an adhesive layer 187. In the illustrative embodiment of FIGS. 7C-E the adhesive layer 187 is an index-matched layer matched to the refractive index of the stepped waveguides 1A, 1B and does not contribute to the reflectivity of the partially reflective coating 184.

In the present embodiments, the extraction reflectors 170 comprise a partially reflective coating 184 comprising a set of layers comprising items 11A, 186, 187, 11B.

In alternative embodiments, the adhesive layer 187 may comprise a dielectric material with a different refractive index to the plural constituent parts 11A. 11B to modify the reflectivity of the partially reflective coating 184. The set of layers may thus alternatively comprise adhesive layer 187 arranged between the constituent parts 11A, 11B wherein the refractive index of the adhesive layer 187 is different to the refractive index of the constituent parts 11A, 11B and further dielectric layers are omitted. In other words, the dielectric layer 186 may comprise an adhesive layer 187.

In FIG. 7C and as referring to FIG. 3A hereinabove, the light ray 460C propagating along the extraction waveguide 1B in the direction 191B has an angle of incidence δ at the opposed rear and front guide surfaces 6, 8. Ray 460C is then incident onto the extraction reflector 170 at an angle of incidence θ₁ that for the embodiment of TABLE 1 is 90 degrees. Some light is reflected along rays 35 back towards the input face 2B by Fresnel reflectivity at the extraction surfaces 167A, 167B. Light ray 460C is also transmitted to continue guiding along the extraction waveguide 1B.

For the case of θ₁ being normal to the surfaces 167A, 167B transmission of p-polarised state 902 is the same as the transmission of the s-polarised state. Light rays 461C illustrate reflection from the intermediate surfaces 172 that are inclined at angle δ and thus have lower reflectivity for p-polarised light state 192 compared to s-polarised light as will be described further hereinbelow. Light ray 460C with p-polarised state 192 is thus preferentially transmitted through the intermediate surfaces. Advantageously light is not trapped in the plural constituent part 11B or in the plural constituent part 11A and efficiency is increased.

In other words, the extraction waveguide 1B comprises at least two constituent parts 11A. 11B having corresponding stepped surfaces 7A, 7B shaped as alternating risers and treads, the stepped surfaces 7A. 7B being optically coupled together so that the risers are optically coupled and the treads are optically coupled, wherein the extraction reflectors 170 are formed between the optically coupled risers 167 of the stepped surfaces 7A, 7B of the constituent parts 11A, 11B.

In FIG. 7D, a proportion of the light ray 460C is extracted as light rays 37A-D. The light ray 37A propagating along the extraction waveguide 1B in the second direction 191B has an angle of incidence δ at the intermediate surface 172 and is reflected by the Fresnel reflectivity of the interface between the dielectric layer 186 and plural constituent part 11A material. The light then reflects from the extraction surface 167A of the extraction reflector 170 to be output through the second light guiding surface 8. In the embodiment of TABLE 2, the angle θ₂ is the same as the angle α and the ray 37A is output along the normal to the surface 8. The s-polarisation state 904 is preferentially reflected at the extraction reflector 170 in comparison to the p-polarisation state 902 of FIG. 7C, as will be illustrated hereinbelow with regards to FIG. 8A. Further reflected output light 37B-D is provided from respective reflections at the rear surfaces 167B.

The extraction waveguide 1B thus preferentially outputs light. Advantageously efficiency is increased and glare of light that is output from the waveguide away from the eye 45 is reduced.

The partially reflective extraction reflectors 170 achieve improved uniformity by reducing or eliminating dark bands across the transverse direction 197 as will now be described. By way of comparison with the present embodiments, if for example the extraction reflectors 170 were to be arranged to be entirely opaque for light from the input face 2B propagating in the direction 191B then they may block some angles of the input light cone measured by a detector placed at the lateral anamorphic component 110, and thus create ‘holes’ in the angular distribution of light across the transverse direction 197. The reflected light distribution in the extraction waveguide 1B also contains the holes and is directed towards the pupil 44 location within the exit pupil 40. If such holes were to be present then they would be visible as dark bands in the image across the transverse direction 197. Such partially reflective extraction reflectors 170 provide light onto the lateral anamorphic component 110 that provides some luminous intensity across the full cone of input angles that are directed from the transverse lens 61 through the input end. Thus a reduction of the visibility of holes in the output distribution of light to the pupil 44 and improved image uniformity for angles across the lateral direction 197 is achieved.

It may be desirable to further increase the efficiency of reflection from the extraction reflectors 170.

In an alternative embodiment, the partially reflective coating 184 may be metallic. The thickness of the metal layer may be adjusted during fabrication to optimize the reflectivity of the extraction reflector 170 and intermediate surface 172.

In the alternative embodiment of FIG. 7E, the partially reflective coating 184 comprises a stack 185 of dielectric layers 186A-E with alternating high and low refractive indices. An illustrative embodiment is provided in TABLE 2. The stack 185 of dielectric layers 186A-E may be formed on one or both of the plural constituent parts 11A, 11B by evaporation or sputtering for example and the extraction waveguide 1B assembled by alignment of the plural constituent parts 11A, 11B.

TABLE 2

| | Illustrative | Refractive | Thickness |
|---|---|---|---|
| Item | material | index | (nm) |
| Plural constituent part 11A | PMMA | 1.50 | — |
| Dielectric layer 186A | TiO₂ | 2.6 | 7 |
| Dielectric layer 186B | SiO₂ | 1.5 | 79 |
| Dielectric layer 186C | TiO₂ | 2.6 | 21 |
| Dielectric layer 186D | SiO₂ | 1.5 | 30 |
| Dielectric layer 186E | TiO₂ | 2.6 | 45 |
| Adhesive layer 187 | Acrylate | 1.56 | — |
| Plural constituent part 11B | PMMA | 1.49 | — |

Such a stack advantageously increases the reflectivity at each extraction surface 183 by increasing the number of Fresnel reflections and further the reflections may be arranged to interfere at desirable angles for extracted light rays 37.

Considering the material of the plural constituent parts 11A, 11B, a material with higher refractive index such as polycarbonate or high index glasses may be used. Advantageously increased field of view, ϕ_{T} may be provided in the transverse direction.

Polarisation selectivity of reflections at the extraction surfaces 180 will now be considered further.

FIG. 8A is a schematic graph illustrating the variation of reflectivity against wavelength for the illustrative embodiment of TABLE 2.

Profile 810 illustrates the total p-polarisation state 902 reflectivity for a single reflection from the dielectric stack 185 while profile 812 illustrates the total s-polarisation state 904 reflectivity for a single reflection from the dielectric stack 185 wherein the thicknesses of TABLE 2 are arranged to provide approximately 25% reflectivity for each reflection. Adjustment of the thicknesses and/or increased number of layers may be used to adjust the reflectivity to achieve desirable reflectivity of the s-polarisation state 904 light ray 37.

Referring to FIG. 3A, there may be some variation of reflectivity with transverse ray angle within the cone 491A_{T}. It would be desirable to provide a uniform luminance with viewing angle to the pupil 44.

FIG. 8B is a flowchart illustrating compensation of pixel data for pixel location in the transverse direction. For each transverse pixel angle (for example for each row 221T of FIG. 2A), the angle of incidence θ₂ onto the surfaces dielectric stack 185 varies and subsequently the reflectivity. The total output reflectivity for each row 221T may be adjusted to compensate for the variation in reflectivity.

Alternative arrangements of extraction waveguides 1 will now be further described.

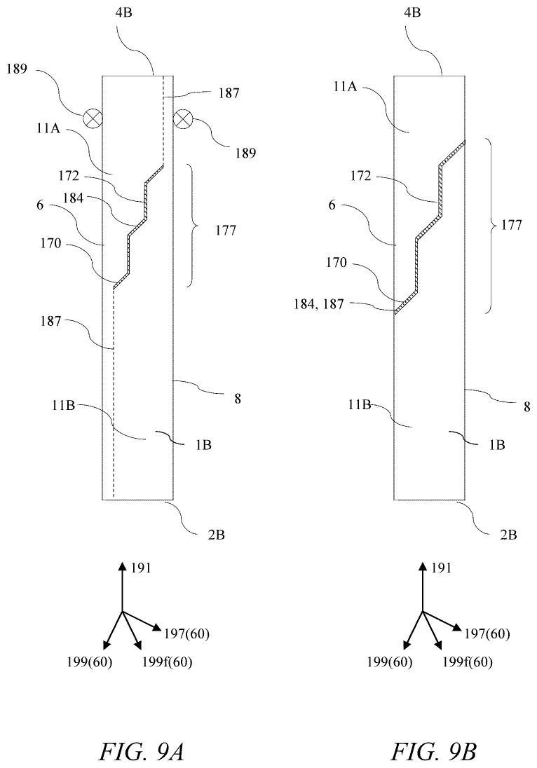

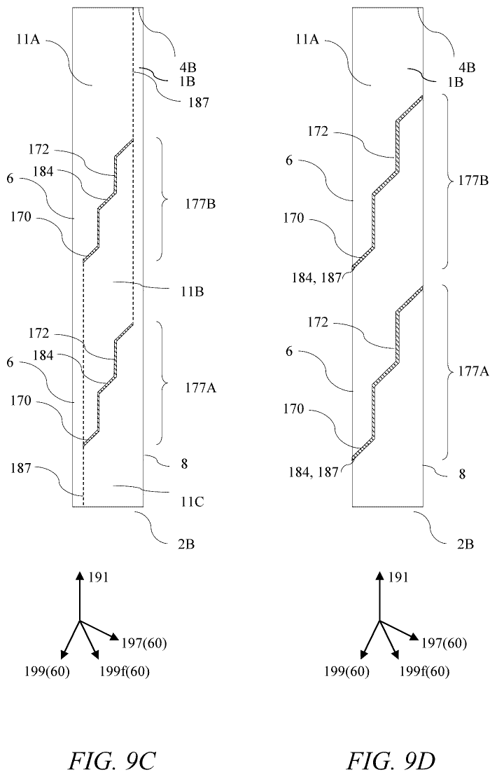

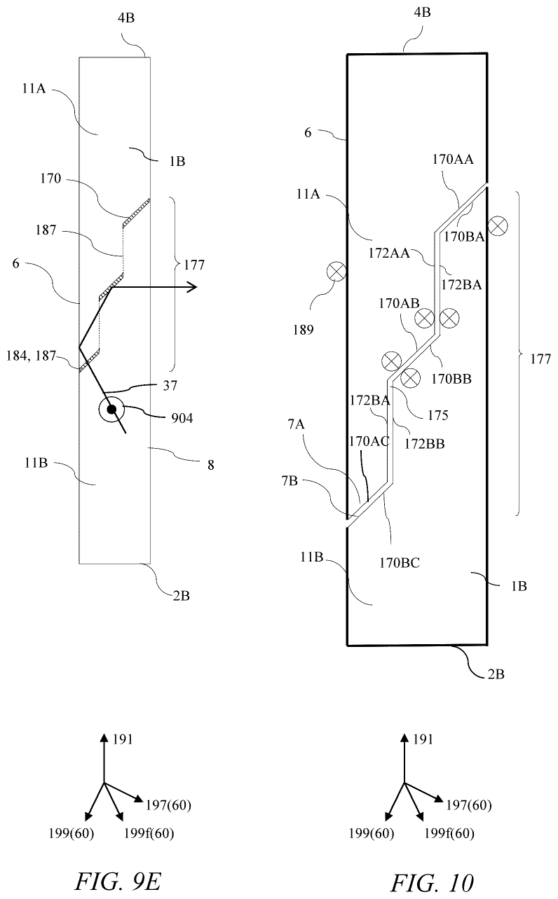

FIGS. 9A-E are schematic diagram illustrating top views of alternative arrangements of extraction waveguides 1. Features of the embodiments of FIGS. 9A-E not discussed in further detail may be assumed to correspond to the features with equivalent reference numerals as discussed above, including any potential variations in the features.

In the alternative embodiments of FIG. 6A and FIG. 9A, the extraction reflectors 170 do not extend to opposing rear and front guide surfaces 6, 8 of the extraction waveguide 1B.

In comparison to the embodiment of FIG. 6A, the extraction waveguide 1B of FIG. 9A has opposing rear and front guide surfaces 6, 8 having an anti-reflection coating 189. Such anti-reflection coatings 189 do not modify the total internal reflection of guided light rays within the waveguide. However, light rays 37 and other light rays that are extracted from the extraction waveguide 1B may provide double imaging from Fresnel reflections at the surfaces 6, 8. The anti-reflection coatings 189 advantageously achieve reduced double imaging and increased image contrast.

Further the embodiment of FIG. 9A illustrates adhesive layer 187 location. The plural constituent parts 11A. 11B may be fabricated separately by molding for example. Partially reflective coatings 184 may be provided over at least part 320 of at least one of the plural constituent parts 11A, 11B. After coating the stepped waveguides may be attached in alignment with adhesive layer 187. The rear and front guide surfaces 6, 8 may be formed during molding of plural constituent parts 11A, 11B, advantageously to achieve high optical quality for light guiding.

In comparison to the embodiment of FIG. 6A, in the alternative embodiment of FIG. 9B, the extraction reflectors 170 extend to opposing rear and front guide surfaces 6, 8 of the extraction waveguide 1B. During an assembly step, the coated plural constituent parts 11A, 11B may be aligned with adhesive layer. After bonding, the rear and front guide surfaces 6, 8 may further be polished to provide desirable optical quality for light guiding. Efficiency of light extraction may advantageously be increased and stray light directed back towards the input end advantageously reduced.

In alternative embodiments, not shown, one of the rear and front guide surfaces 6, 8 may be formed during moulding of one of the plural constituent parts 11A, 11B and the other of the rear and front guide surfaces 6, 8 may be formed by polishing the respective other light guiding surface 6, 8 after assembly.

It may be desirable to increase the size of the extraction reflectors 170 and the size of the exit pupil e_{T} in the transverse direction.

In comparison to the embodiment of FIG. 6A, in the alternative embodiment of FIG. 9C, the extraction reflectors 170 comprise plural sets 177A, 177B of extraction reflectors 170, wherein, within each set 177A, 177B of extraction reflectors 170, in the transverse direction 197(60) the extraction reflectors 170 extend partially across the extraction waveguide 1B with successively shifted positions, the extraction reflectors 170 of different sets 177A, 177B overlapping in extent in the transverse direction 197.

In comparison to the embodiment of FIG. 6A, in the alternative embodiment of FIG. 9D, the extraction reflectors 170 comprise plural sets 177A, 177B of extraction reflectors 170, wherein, within each set 177A, 177B of extraction reflectors 170, in the transverse direction 197(60) the extraction reflectors 170 extend to opposed rear and front guide surfaces across the extraction waveguide 1B with successively shifted positions, the extraction reflectors 170 of different sets 177A, 177B overlapping in extent in the transverse direction 197.

During fabrication, the arrangements of FIGS. 9C-D may be provided comprising plural constituent parts 11A, 11B, 11C in a similar manner to that described with respect to FIGS. 9A-B.

The embodiments of FIGS. 9C-D achieve increased region over which the light is extracted to the eye. The size of the exit pupil e_{R} in the transverse direction is advantageously increased. Further, the size resolved in the direction 191B of the extraction reflectors 170 is increased for a given pitch of extraction reflectors 170 and extraction waveguide 1B thickness t. Considering FIG. 1I, the height 454 of the pixel blur ellipse 452 due to diffraction of light reflected from the extraction reflectors 170 in the transverse direction is advantageously reduced.

In the alternative embodiment of FIG. 9E, the intermediate surfaces 172 are optically coupled together. Adhesive layer 187 may be arranged between the extraction reflectors 170 that may be a layer with a similar refractive index to the plural constituent parts 11A. 11B. During fabrication, intermediate regions between the extraction reflectors may be masked so that no partial reflector 184 is provided. During the alignment of the plural constituent parts 11A. 11B, intermediate regions are optically removed. Advantageously trapping of light may be reduced and extraction efficiency increased.

The arrangements of FIGS. 9A-E may be used in alternative combinations to those illustrated. For example, the optically coupled intermediate surfaces 172 of FIG. 9E may be used in the arrangements of FIGS. 9A-D.

It may be desirable to reduce the fabrication cost of the optical coatings of FIGS. 9A-E.

FIG. 10 is a schematic diagram illustrating a top view of an extraction waveguide 1B comprising a gap 175. Features of the embodiment of FIG. 10 not discussed in further detail may be assumed to correspond to the features with equivalent reference numerals as discussed above, including any potential variations in the features.

In the alternative embodiment of FIG. 10, the extraction waveguide 1B comprises plural constituent parts 11A, 11B having facing stepped surfaces 7A, 7B that are spaced apart by a gap 175, the stepped surfaces 11 being shaped with alternating extraction surfaces 170 extending in the transverse direction 197(60) and intermediate surfaces 172 extending along the extraction waveguide 1B, wherein the extraction reflectors 170 comprise the facing extraction surfaces 7A, 7B.

In other words, the extraction reflectors 170 thus comprise extraction surfaces 170AA and 170BA, 170AB and 170BB, and 170AC and 170BC spaced apart by a gap 175 and the intermediate reflectors 172 comprise intermediate surfaces 172AA and 172BA, 172AB and 172BB, and 172AC and 172BC spaced apart by a gap 181.

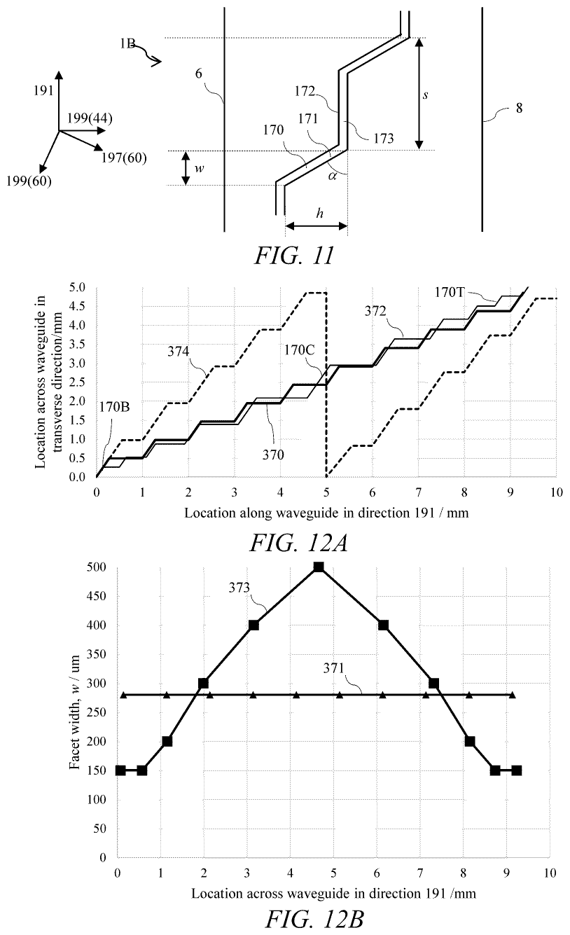

The gap may typically comprise air or may comprise another material such as an inert gas. The gap achieves total internal reflection for most, or all of the input rays from the input face 2A as will be described further with respect to FIGS. 11A-E hereinbelow.

In comparison to the embodiment of FIG. 9B, the embodiment of FIG. 10 has advantageously reduced complexity. Further the reflections from the extraction reflectors 170 and intermediate surfaces 172 are provided by total internal reflection rather than Fresnel reflections and so have reduced variation or reflectivity with wavelength and with field angle. Image uniformity to the eye 45 is improved.

The extraction surfaces 170, intermediate surfaces 172 and opposing rear and front guide surfaces 6, 8 further comprise an optional anti-reflection coating 189. Advantageously stray light and double images from light that is not guiding within the extraction waveguide 1B may be reduced.

Alternative arrangements materials for extraction reflector 170 and intermediate surface will now be described.

FIG. 11 is a schematic diagram illustrating a top view near an extraction reflector 170 comprising partially reflective material 171 and adjacent intermediate surfaces 172 comprising intermediate surface material 173. Features of the embodiment of FIG. 11 not discussed in further detail may be assumed to correspond to the features with equivalent reference numerals as discussed above, including any potential variations in the features.

As described hereinabove, the surface reflectivity from the extraction reflector 170 may be provided by (i) a single dielectric layer (ii) a dielectric stack (iii) a metal material (iv) a gap such as an air gap; and the surface reflectivity from the intermediate reflector 172 may be provided by (i) a single dielectric layer (ii) a dielectric stack (iii) a metal material (iv) a gap such as an air gap (v) optical coupling. The extraction reflectors 170 and intermediate surfaces 172 may be provided with various combinations of surface reflectivities to achieve different desirable properties optically and mechanically as discussed above and as illustrated in TABLE 3.

TABLE 3

| Material 171 at extraction | Material 173 at intermediate |
|---|---|
| reflector 170 | surface 172 |
| Dielectric layer | Dielectric layer |
| | Dielectric stack |
| | Metal |
| | Gap |
| | Optically coupled |
| Dielectric stack | Dielectric layer |
| | Dielectric stack |
| | Metal |
| | Gap |
| | Optically coupled |
| Metal | Dielectric layer |
| | Dielectric stack |
| | Metal |
| | Gap |
| | Optically coupled |
| Gap | Dielectric layer |
| | Dielectric stack |
| | Metal |
| | Gap |
| | Optically coupled |

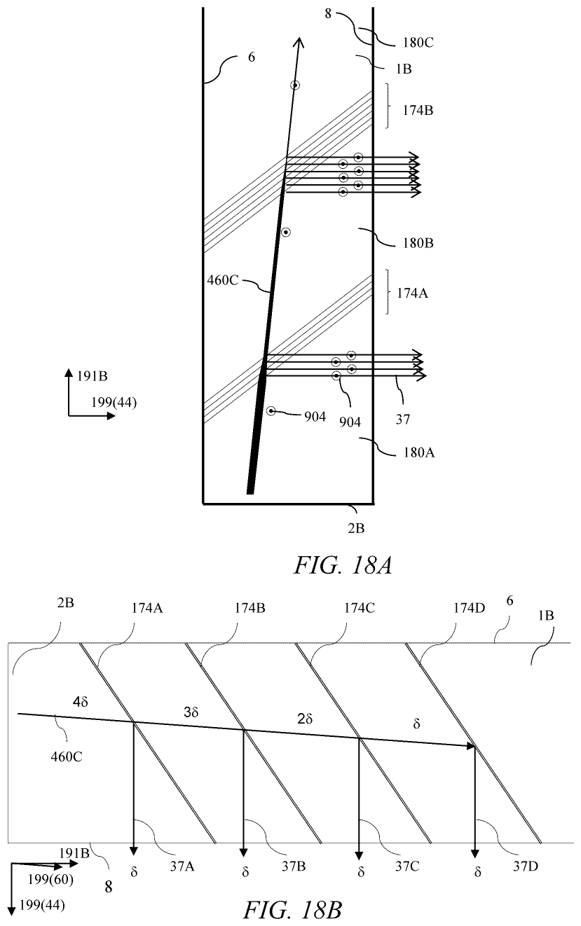

Further to TABLE 3, the material and composition of the material at each extraction reflector 170 and each intermediate surface 172 may vary along the direction 191B of the extraction waveguide 1B as will be described further hereinbelow with respect to FIG. 18B for example.

FIG. 11 further illustrates the extraction reflectors 170 with tilt angle α and with height h across the extraction waveguide 1B in the direction 199(44); extent w along the extraction waveguide 1B in the direction 191B; pitch s along the extraction waveguide 1B in the direction 191B.

Illustrative arrangements of the stepped surfaces 7 comprising extraction reflectors 170 and intermediate surfaces 172 will now be described.

Alternative arrangements of extraction waveguide 1B will now be described.

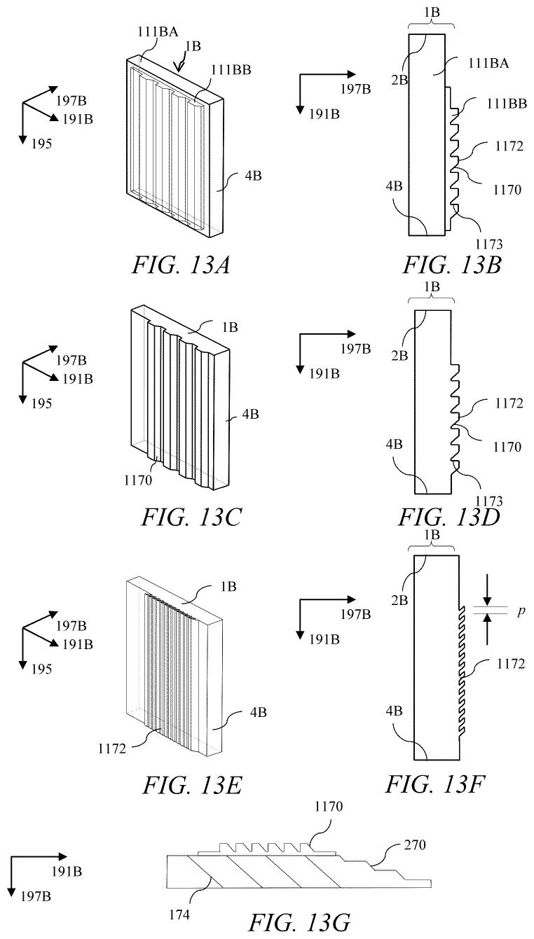

FIG. 13A is a schematic diagram illustrating a perspective front view of an extraction waveguide comprising an attached surface relief structure that is not stepped; FIG. 13B is a schematic diagram illustrating a top view of an extraction waveguide comprising an attached surface relief structure that is not stepped; FIG. 13C is a schematic diagram illustrating a perspective front view of an extraction waveguide comprising a surface relief structure that is not stepped; FIG. 13D is a schematic diagram illustrating a top view of an extraction waveguide comprising a surface relief structure that is not stepped; FIG. 13E is a schematic diagram illustrating a perspective front view of an extraction waveguide comprising a surface relief diffractive structure that is not stepped; and FIG. 13F is a schematic diagram illustrating a top view of an extraction waveguide comprising a surface relief diffractive structure that is not stepped. Features of the embodiments of FIGS. 13A-F not discussed in further detail may be assumed to correspond to the features with equivalent reference numerals as discussed above, including any potential variations in the features.

The alternative embodiment of FIGS. 13A-B illustrate that a film component 111BB may be provided on a planar substrate 111BA and comprises inclined extraction reflectors 1170 with intermediate regions 1172 and return facets 1173. Advantageously an extraction waveguide 1B may be conveniently manufactured with low cost. The reflectors 1170 may be provided to achieve desirable uniformity of output luminance with angle and location in the exit pupil 40.

By way of comparison with FIGS. 13A-B, the embodiment of FIGS. 13C-D are formed as an integrated body. Advantageously losses and stray light from the film component 111B may be reduced and image contrast improved.

By way of comparison with FIGS. 13C-D-B, the embodiment of FIGS. 13E-F are provided with a pitch p that is arranged to provide diffractive output of light from the waveguide 1B. Advantageously improved uniformity of output may be achieved.

FIG. 13G is a schematic diagram illustrating a top view of an extraction waveguide comprising a surface relief light extraction structure, a stepped surface relief extraction structure and partial reflectors arranged between the front and rear light guiding surfaces. Features of the embodiments of FIG. 13G not discussed in further detail may be assumed to correspond to the features with equivalent reference numerals as discussed above, including any potential variations in the features.

By way of comparison with the extraction waveguides 1B described hereinabove, the alternative embodiment of FIG. 13G comprises a combination of different extraction reflectors 270, 174, 1170. Such arrangements may advantageously achieve increased uniformity spatially and angularly.

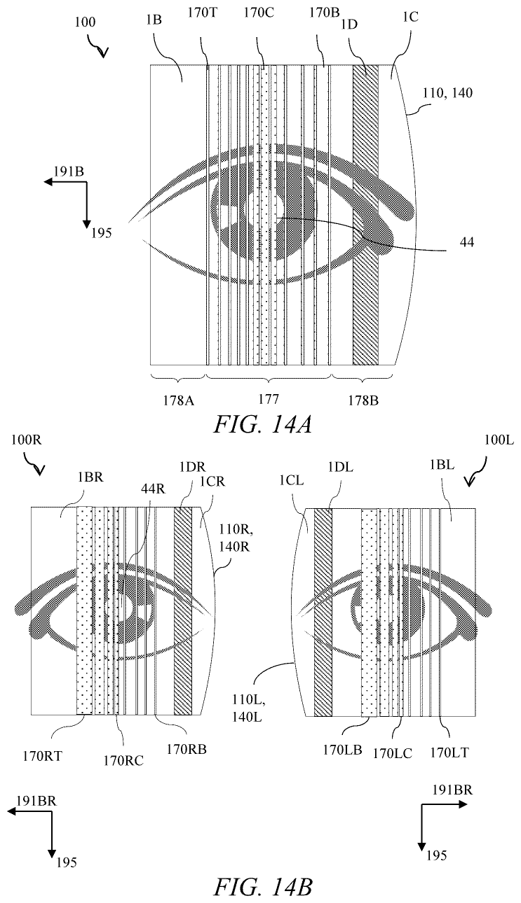

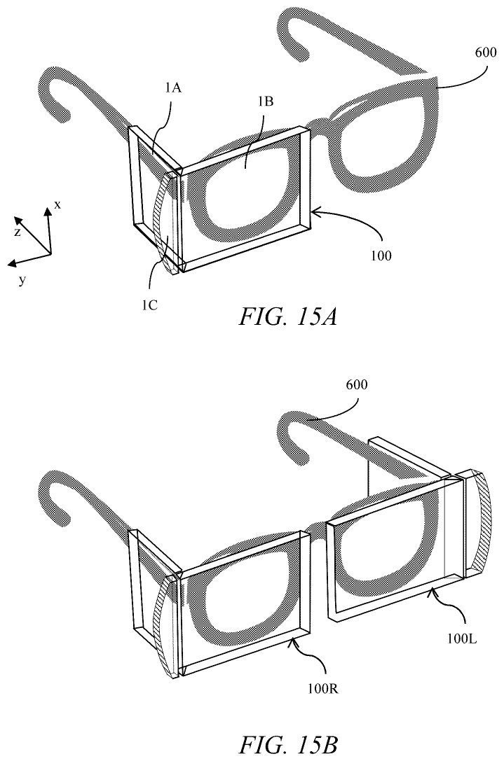

FIG. 12A is a schematic graph of the variation of stepped surface 7 profiles with position in the direction 191B along the extraction waveguide 1B for various illustrative arrangements of stepped extraction waveguide surfaces 7; FIG. 12B is a schematic graph of the variations 371, 373 of facet width w with position along an extraction waveguide 1A in the direction 191B; and FIG. 14A is a schematic diagram illustrating in front view an arrangement of chirped extraction reflectors for a monocular near-eye anamorphic display apparatus. Features of the embodiments of FIGS. 14A-C not discussed in further detail may be assumed to correspond to the features with equivalent reference numerals as discussed above, including any potential variations in the features.

Profile 370 of FIG. 12A illustrates a stepped surface 7 comprising 60 degrees tilt extraction reflectors 170 arranged on a uniform 1 mm pitch, with approximately 0.49 mm step height h, and uniform 0.28 mm step extent w, as illustrated by profile 371 in FIG. 12B. The step extent, w provides a diffracting aperture for the light rays 37 directed towards the pupil 44 of the eye and so a diffractive blur is added to the image data in the transverse direction 197. It would be desirable to increase the extent w and thus reduce diffractive blur in the transverse direction, to minimise the blur ellipse height 454 in the transverse direction 197 of FIG. 1I.

Profile 372 of FIG. 12A, profile 373 of FIG. 12B and FIG. 14A illustrate an alternative embodiment wherein the extraction reflectors 170 have a varying pitch, s along the extraction waveguide 1B in the direction 191B. Further, the extraction reflectors 170 have a varying extent w along the extraction waveguide 1B in the direction 191B. Thus considering the central extraction reflector 170C, the extent w is 0.5 mm whereas the top extraction reflector 170T as an extent of 0.15 mm. Diffractive blur is reduced for light from the centre of the extraction waveguide 1B which may be a preferred viewing location for the pupil 44. Thus high image quality may be achieved for the preferred viewing location, whereas off-axis imagery from the top and bottom extraction reflectors 170T, 170B is somewhat degraded. The best image quality is provided in the preferred viewing direction, advantageously achieving high image performance for the most commonly used image data.

Profile 374 of FIG. 12A illustrates an alternative embodiment wherein two sets of extraction reflectors 170 are provided, for example as further illustrated in the alternative embodiment of FIG. 9D. The extent w is increased for each step while maintaining a constant 1 mm pitch. Advantageously diffractive blur is reduced in comparison to the embodiment of the profile 370. Further, for a given extent w, the total thickness t of the extraction waveguide 1B may advantageously be reduced while achieving a desirable pitch p so that multiple extraction reflectors 170 overlap the pupil 44.

It would be desirable to further reduce the appearance of image blur due to diffraction in the lateral direction 197 from the extent w of the extraction reflectors 170.

FIG. 14B is a schematic diagram illustrating in front view an arrangement of chirped extraction reflectors 170 for a binocular near-eye anamorphic display apparatus 1. Features of the embodiment of FIG. 14B not discussed in further detail may be assumed to correspond to the features with equivalent reference numerals as discussed above, including any potential variations in the features.

In the alternative embodiment of FIG. 14B the extraction reflectors 170RA-RN for the pupil 44R of the right-eye 45R have a first profile of pitch s and extent w in the second direction 191B along the extraction waveguide 1B. Further the extraction reflectors 170LA-LN have a second profile of pitch s and extent w that is different to the first profile.

In the illustrative embodiment of FIG. 14B, the top extraction reflector 170RT for directing light towards the right pupil 44R has a large pitch and thus low diffraction blur while the bottom extraction reflector 170RB for directing light towards the right pupil 44R has a small pitch and thus increased diffraction blur. Further the top extraction reflector 170LT for directing light towards the left pupil 44L has a small pitch and thus higher diffraction blur while the bottom extraction reflector 170LB for directing light towards the left pupil 44L has a larger pitch and thus reduced diffraction blur. In operation, the human visual system may combine the two different blurs of the left-eye and right-eye images. Such combination may achieve perceived blur that is improved in comparison to arrangements in which the first and second profiles of pitch s and extent w are the same. Advantageously improved image quality may be perceived.

Head wear 600 comprising the anamorphic near-eye display apparatus 100 will now be described.

FIG. 15A is a schematic diagram illustrating in perspective front view augmented reality head-worn display apparatus 600 comprising a monocular anamorphic display apparatus arranged with spatial light modulator 48 and transverse anamorphic component 60 formed by the transverse lens 61 in brow position; and FIG. 15B is a schematic diagram illustrating in perspective front view augmented reality head-worn display apparatus 600 comprising binocular anamorphic display apparatuses 100L, 100R arranged with spatial light modulators 48R. 48L and transverse anamorphic components 60R. 60L in brow position. Features of the embodiments of FIGS. 15A-B not discussed in further detail may be assumed to correspond to the features with equivalent reference numerals as discussed above, including any potential variations in the features.

The head-worn display apparatus 600 may comprise a pair of spectacles 600 comprising the anamorphic near-eye display apparatus 100 described elsewhere herein that is arranged to extend across at least one eye 45 of a viewer 47 when the head-worn display apparatus 600 is worn. The head-worn display apparatus 600 may comprise a pair of spectacles comprising spectacle frames 602 with rims 603 and arms 604, which serve as a head-mounting arrangement arranged to mount the anamorphic near-eye display apparatus 100 on a head of a wearer with the anamorphic near-eye display apparatus 100 extending across at least one eye of the wearer. In general, any other head-mounting arrangement may alternatively be provided. The rims 603 and/or arms 604 may comprise electrical systems for at least power, sensing and control of the illumination system 240. The anamorphic near-eye display apparatus 100 of the present embodiments may be provided with low weight and may be transparent. The head-worn display apparatus 600 may be tethered by wires to remote control system or may be untethered for wireless control. Advantageously comfortable viewing of augmented reality content may be provided.

In alternative embodiments of a head-worn display apparatus, not shown, the input waveguide 1A may extend away from the eye 45 and the intermediate waveguide 1C may be arranged in the brow position rather than the temple position. In such cases, the top views of the present description may be side views.

It would be desirable to provide a virtual reality head-worn display apparatus 600 in which the head-worn display apparatus is not transparent to external images.

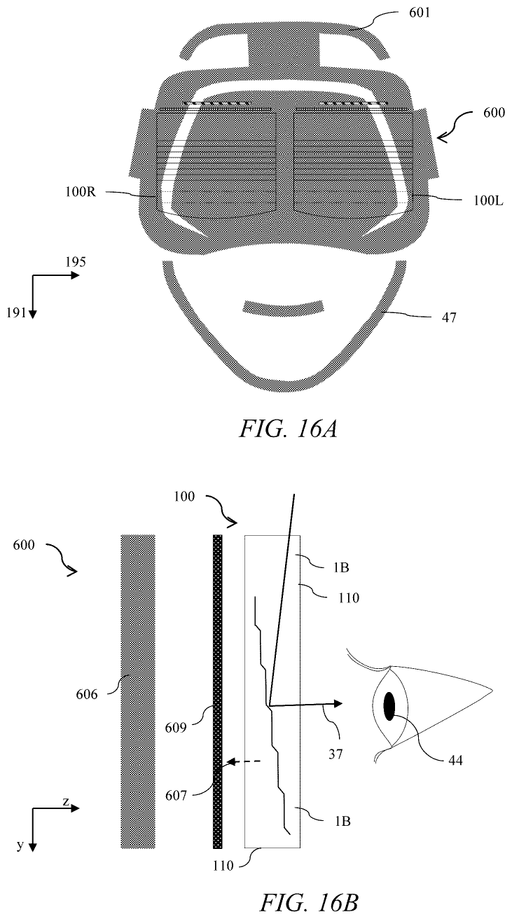

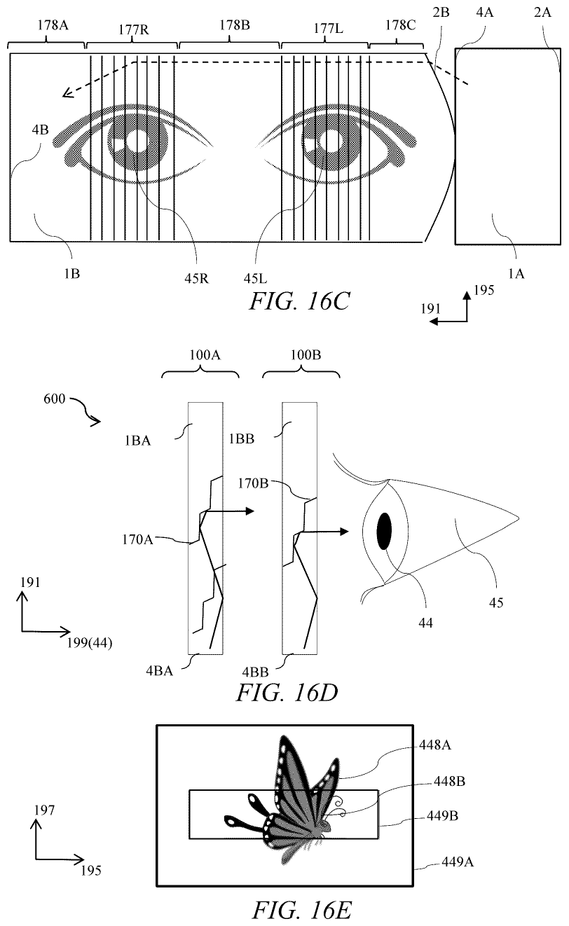

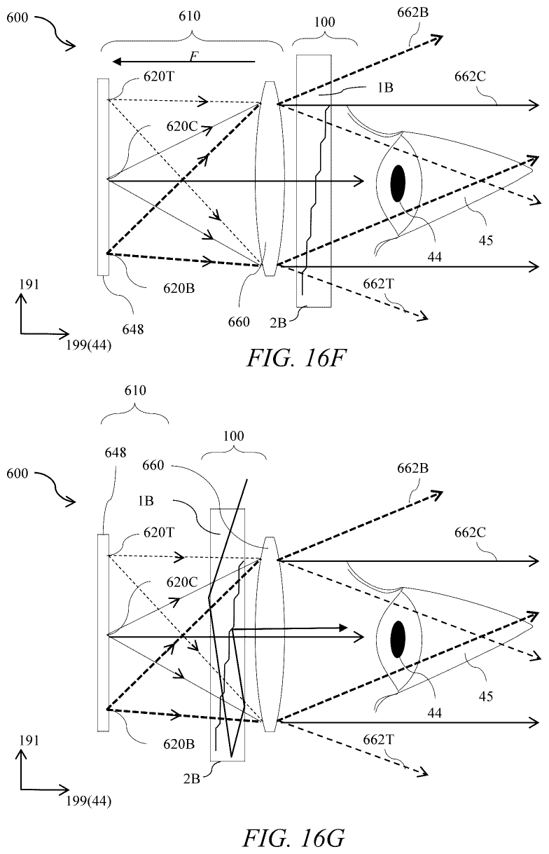

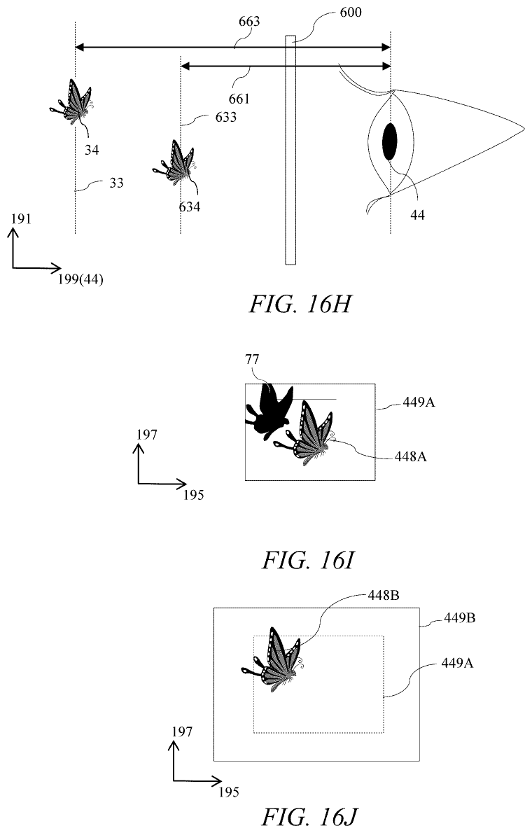

FIG. 16A is a schematic diagram illustrating in front view virtual reality head-worn display apparatus 600 comprising left-eye and right-eye anamorphic display apparatuses 100R. 100L; and FIG. 16B is a schematic diagram illustrating in top view a virtual reality head-worn display apparatus 600 comprising an anamorphic near-eye display apparatus 100. Features of the embodiment of FIGS. 16A-B not discussed in further detail may be assumed to correspond to the features with equivalent reference numerals as discussed above, including any potential variations in the features.

The alternative embodiment of head-worn display apparatus 600 of FIG. 16A may comprise display apparatuses 100R, 100L mounted in head gear 601 that have larger size than desirable for spectacle head-worn display apparatus 600 of FIG. 15B. Referring to FIG. 1I aberrations may be reduced for a given field angle, field of view increased for a given ellipse blur 452 limit. Further image brightness may be increased.

FIG. 16B illustrates an alternative arrangement wherein a light trap layer 609 is provided between the head-worn display apparatus 600 casing 606 and extraction waveguide 1B to receive stray light rays 607 output from the extraction waveguide 1B. Advantageously image contrast is improved.

It may be desirable to reduce the number of illumination systems in a binocular near-eye display.

FIG. 16C is a schematic diagram illustrating in front view an anamorphic near-eye display apparatus 100 comprising a single extraction waveguide 1B suitable for use by both eyes of a display user. Features of the embodiment of FIG. 16C not discussed in further detail may be assumed to correspond to the features with equivalent reference numerals as discussed above, including any potential variations in the features.

The array of extraction reflectors 170 comprises two separated regions 177L, 177R, each region 177L, 177R being arranged to extract light guided along the extraction waveguide 1B towards a respective eye 45L, 45R of the viewer 47. Non-extracting regions 178A-C are arranged in the extraction waveguide 1B outside of the separated regions 177L, 177R.

Thus a single illumination system 240 comprising spatial light modulator 48 may be arranged to provide illumination to both eyes 45R. 45L. Advantageously cost and complexity is reduced.

It may be desirable to increase the performance and functionality of the head-worn display apparatus 600.

FIG. 16D is a schematic diagram illustrating in top view an anamorphic near-eye display apparatus comprising an anamorphic two display apparatuses; and FIG. 16E is a schematic diagram illustrating a composite image provided by the head-worn display apparatus 600 of FIG. 16D to the eye 45. Features of the embodiments of FIGS. 16D-E not discussed in further detail may be assumed to correspond to the features with equivalent reference numerals as discussed above, including any potential variations in the features.

In the alternative embodiment of FIG. 16D, the anamorphic near-eye display apparatus 100A is a first near-eye display apparatus and the head-worn display apparatus 600 further comprises a second near-eye display apparatus 100B, wherein the second near-eye display apparatus 100B is arranged in series with and to receive light from the first near-eye display apparatus 100A.

Near-eye anamorphic display apparatus 100A comprises spatial light modulator 48A with a first size and pixel 222 density; transverse anamorphic component 60A with a first transverse optical power; and extraction waveguide 1BA comprising a lateral anamorphic component 110A with a first lateral optical power. Near-eye anamorphic display apparatus 100B comprises spatial light modulator 48B that may have size and pixel 222 density that is the same or different to the spatial light modulator 48A; transverse anamorphic component 60B with a second transverse optical power that may be the same or different to the first transverse optical power; and extraction waveguide 1BA comprising a lateral anamorphic component 110A with a second lateral optical power that may be the same or different to the first lateral optical power.

The spatial light modulators 48A, 48B, transverse anamorphic components 60A, 60B; lateral anamorphic components 110A. 110B and the extraction reflectors 170 may be arranged to provide desirably increased optical performance including at least one of (i) increased image resolution; (ii) increased brightness; (iii) increased exit pupil 40 size; (iv) reduced image diffraction; (v) increased field of view; and (vi) multiple focal planes.

In the illustrative embodiment of FIG. 16D, the spatial light modulators 48A, 48B are the same but the transverse anamorphic components 60A, 60B and lateral anamorphic components 110A, 110B are different so that the magnification provided by the respective anamorphic display apparatuses 100A, 100B are different. FIG. 16E illustrates that an outer image region 448A with border 449A is provided by the anamorphic near-eye display apparatus 100A and the central image region 448B with border 449B is provided by the anamorphic near-eye display apparatus 100B. Advantageously a high resolution image may be provided in the central region 448A, overlaid on a lower resolution image in the outer region 448B. Such an arrangement may advantageously achieve increased image fidelity for the most common viewing directions while providing large field of view.

FIG. 16D also illustrates that the extraction reflectors 170 may be provided with different alignments to achieve increased exit pupil 40 size and to reduce diffraction blur.

It may be desirable to increase the performance of virtual reality display systems.

FIG. 16F is a schematic diagram illustrating in top view a virtual reality head-worn display apparatus 600 comprising an anamorphic near-eye display apparatus 100 arranged to receive light from a magnifying lens 610; and FIG. 16G is a schematic diagram illustrating in top view a virtual reality head-worn display apparatus comprising an anamorphic near-eye display apparatus arranged between the anamorphic spatial light modulator and magnifying lens of a non-anamorphic display apparatus. Features of the embodiments of FIGS. 16F-G not discussed in further detail may be assumed to correspond to the features with equivalent reference numerals as discussed above, including any potential variations in the features.

In the alternative embodiment of FIG. 16D, the anamorphic near-eye display apparatus 100 is a first near-eye display apparatus and head-worn display apparatus 600 further comprises a non-anamorphic near-eye display apparatus 610, wherein the non-anamorphic near-eye display apparatus 610 comprises a non-anamorphic spatial light modulator 648 and a non-anamorphic magnifying optical system 660; and wherein the at least one near-eye display apparatus 100 is arranged in series with and to receive light from the non-anamorphic near-eye display apparatus 610.

In the alternative embodiment of FIG. 16G, the anamorphic near-eye display apparatus 100 may be arranged in series with the non-anamorphic spatial light modulator 648, being arranged between the non-anamorphic spatial light modulator 648 and the non-anamorphic near-eye display apparatus 610. The anamorphic near-eye display apparatus may be arranged substantially at the pupil of the magnifying optical system 660 to provide no optical power to light from the non-anamorphic near-eye display apparatus 100. Alternatively some small optical power for light from the anamorphic near-eye display apparatus 100, may be provided modifying the virtual image distance. The total thickness of the optical system may be reduced, advantageously achieving reduced bulk.

In the embodiments of FIGS. 16F-G, the non-anamorphic magnifying optical system 660 may comprise a lens such as a Fresnel lens, a pancake lens or other known non-anamorphic magnifying lenses and is arranged to provide the eye 45 with a virtual image of the spatial light modulator 648. In comparison to the anamorphic near-eye display apparatus 100, the non-anamorphic near-eye display apparatus 610 provides magnification of pixels 622 on the non-anamorphic spatial light modulator 648 that is equal in the lateral and transverse directions 195, 197. The non-anamorphic magnifying optical system 660 is typically circularly symmetric.

In operation, top pixel 620T of the non-anamorphic spatial light modulator 648 provides light rays 662T, central pixel 620C provides light rays 662C and bottom pixel 620B provides light rays 662B. The eye of the observer 45 collects the light rays 460T, 460C, 460B and produces an image on the retina of the eye such that an image is perceived with angular size that is magnified in comparison to the angular size of the spatial light modulator 48.

The spatial light modulators 48, 648, non-anamorphic magnifying optical system 660, transverse anamorphic component 60; lateral anamorphic component 110 and the extraction reflectors 170 may be arranged to provide desirably increased optical performance including at least one of (i) increased image resolution; (ii) increased brightness; (iii) increased exit pupil 40 size; (iv) reduced image diffraction; (v) increased field of view; and (vi) multiple focal planes.

FIG. 16H is a schematic diagram illustrating in top view an arrangement of virtual image distances for a virtual reality display apparatus. Features of the embodiment of FIG. 16H not discussed in further detail may be assumed to correspond to the features with equivalent reference numerals as discussed above, including any potential variations in the features.

Considering the embodiment of FIG. 16F, the virtual image distance 61 from the eye 44 to the virtual image 34 provided by the anamorphic near-eye display apparatus 100 may be at an infinite conjugate plane 33 distance 663, whereas by control of the back working distance. F of the spatial light modulator 648 to the non-anamorphic magnifying system 660 the virtual image 634 provided by the non-anamorphic near-eye display apparatus 610 may be at a finite conjugate plane 633 distance 661.

More generally a virtual image distance for light from the first near-eye display apparatus 100A, 100 may be different from a virtual image distance for light from the second near-eye display apparatus 100B or non-anamorphic near-eye display apparatus 610 respectively.

Advantageously comfort of display use may be increased.

FIGS. 16I-J are schematic diagrams illustrating displayed virtual images for the arrangement of FIG. 16H. Features of the embodiments of FIGS. 16I-J not discussed in further detail may be assumed to correspond to the features with equivalent reference numerals as discussed above, including any potential variations in the features.

FIG. 16I illustrates the image 448A with border 449A provided by the anamorphic near-eye display apparatus 100 whereas FIG. 16J illustrates the image 448B with border 449B provided by the non-anamorphic near-eye display apparatus 610.

The background image 448A and foreground images 448B are provided so that the image 448A may further comprise an occlusion image 77 that is aligned in operation to the foreground images 448B that overlay the background image. Opaque foreground images may advantageously be achieved.

Embodiments including alternative forms of reflective extraction features 169 will now be described.

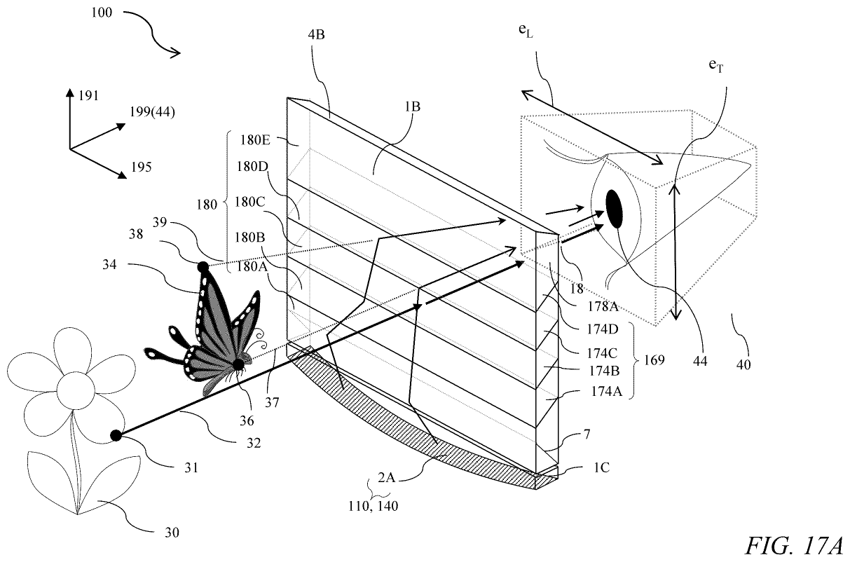

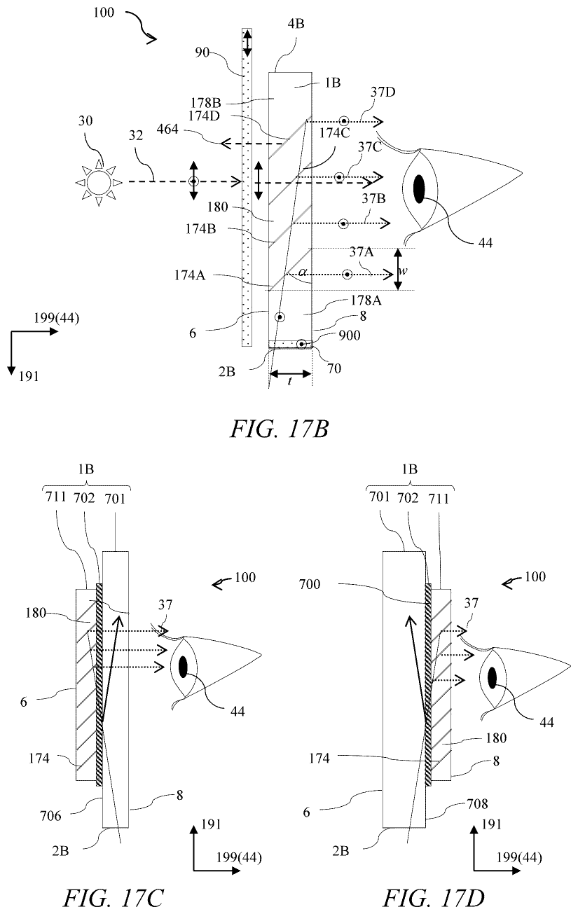

FIG. 17A is a schematic diagram illustrating in perspective front view an alternative arrangement of the anamorphic near-eye display apparatus 100 wherein the reflective extraction features comprise extraction reflectors 174A-D comprises plural constituent plates 180A-E. Features of the embodiment of FIG. 17A not discussed in further detail may be assumed to correspond to the features with equivalent reference numerals as discussed above, including any potential variations in the features.

In comparison to FIG. 1A, in the alternative embodiment of FIG. 17A, the extraction waveguide 1B comprises plural constituent plates 180A-E optically coupled together, wherein the extraction reflectors 174A-D are formed between the constituent plates 180A-E. The extraction reflectors 174A-D extend between the opposing rear and front guide surfaces 6, 8 of the extraction waveguide 1B. In other words, the extraction reflectors 174A-E extend across the entirety of the extraction waveguide 1B between the opposing rear and front guide surfaces 6, 8, however typically some regions 178A, 178B along the extraction waveguide 1B may be provided without extraction reflectors 174 as discussed hereinabove.

In the alternative embodiment of FIG. 17A, the extraction reflectors 174 have the same reflective area. Advantageously luminance variations with viewing angle may be reduced.

FIG. 17B is a schematic diagram illustrating a top view of light input into the anamorphic near-eye display apparatus of FIG. 17A. Features of the embodiment of FIG. 17B not discussed in further detail may be assumed to correspond to the features with equivalent reference numerals as discussed above, including any potential variations in the features.

In manufacture, plural constituent plates 180 are coated and bonded as a stack of plates 180A-N. The stack of plates 180A-N may then be diced and polished at angle α to provide the inclined plates 180A-N.

The outer interfaces shown in FIG. 17B as extraction reflectors 174A, 174D may alternatively be provided by bonding to non-extracting waveguide regions 178A. 178B so that no extraction is provided. Advantageously the complexity of the non-extracting waveguide constituent parts 178A, 178B is reduced and cost reduced.

In comparison to FIG. 6A, the plural constituent plates 180 of FIGS. 17B-C provide extraction reflectors 174A-D that each extend between the opposing rear and front guide surfaces 6, 8. The extraction reflectors 174A-D may be arranged at tilt angle α and have width w that is determined by the waveguide thickness, t and the angle α. The extent w in the direction 191B along the extraction waveguide 1B is increased and advantageously diffractive blur in the transverse direction is reduced.

In operation, light rays 37 that are extracted are incident onto light guiding surface 6 before incidence at the partially extraction reflectors 174A-D to provide corresponding output rays 37A-D. Advantageously the size of the headbox is increased.

FIG. 17C is a schematic diagram illustrating in perspective front view an alternative arrangement of anamorphic near-eye display apparatus 100 comprising an extraction waveguide 1B comprising an extraction member 711 and a partially reflective layer 702 arranged on the rear surface 706 of a waveguide member 701. Features of the embodiment of FIG. 17C not discussed in further detail may be assumed to correspond to the features with equivalent reference numerals as discussed above, including any potential variations in the features.

By way of comparison with FIG. 17B, in the alternative embodiment of FIG. 17C, the extraction reflectors 174 are arranged outside the waveguide member 701.

The partially reflective layer 702 may be at least one of a reflective polariser, a dielectric stack, a thin metal layer or a combination thereof. Further retarders may be provided at the partially reflective layer to achieve appropriate manipulation of polarisation state at the partially reflective layer 702 to provide desirable reflectivity characteristics to achieve improved uniformity.

In operation, light rays 37 are guided along the waveguide member 701. At the partially reflective layer 702 some light may be reflected and some light may be transmitted through the partially reflective layer 702. Reflected light is propagated along the waveguide member 701 to be extracted by different extraction reflectors 174 to those for transmitted light. Advantageously uniformity of extraction of light rays 37 in the direction 191 along the waveguide 1B may be improved.

FIG. 17D is a schematic diagram illustrating in perspective front view an alternative arrangement of anamorphic near-eye display apparatus 100 comprising an extraction waveguide 1B comprising an extraction member 711 and a partially reflective layer 702 arranged on the front surface 708 of a waveguide member 701. Features of the embodiment of FIG. 17D not discussed in further detail may be assumed to correspond to the features with equivalent reference numerals as discussed above, including any potential variations in the features.

By way of comparison with FIG. 17C, in the alternative embodiment of FIG. 17D, the extraction reflectors 174 are arranged on the front side 708 of the waveguide member 701. Advantageously visibility of stray light from the extraction reflectors 714 may be reduced.

The propagation of polarised light is similar to that of FIGS. 7C-E, although no intermediate surfaces 172 are provided and will now be further described.

FIG. 18A is a schematic diagram illustrating a top view of polarised light propagation in the anamorphic near-eye display apparatus 100 of FIG. 17A. Features of the embodiment of FIGS. 18A-B not discussed in further detail may be assumed to correspond to the features with equivalent reference numerals as discussed above, including any potential variations in the features.

Extraction reflector 174A comprises dielectric stack comprising dielectric layers 186AA-186AC and extraction reflector 174B comprises dielectric stack comprising dielectric layers 186BA-186AE, that may for example comprise different dielectric stack than extraction reflector 174A and may provide different reflectivity.

The dielectric stacks 186A-N may be formed on one or both surfaces of the adjacent plates 180. In other embodiments, the dielectric stacks may be replaced by single dielectric layers, metal, or a gap.

In operation, some p-polarised light 464 is reflected for light rays 460C propagating in the second direction 191B along the extraction waveguide 1B; however as illustrated in FIG. 8A, said p-polarised reflectivity may be minimised by appropriate design of the respective dielectric stack 186A-N.

In the extraction waveguide 1B, the polarisation conversion retarder 72 provides s-polarised state 908 that is reflected by the dielectric stacks 186AA-AC and 186BA-186BE towards the pupil 44.

FIG. 18B is a schematic diagram illustrating the variation of reflectivity of extraction reflectors 174 in the direction 191B along the extraction waveguide 1B of FIG. 17A and with illustrative embodiment of TABLE 4 in the case the extraction waveguide comprises four extraction reflectors 174A-D. Features of the embodiment of FIG. 18B not discussed in further detail may be assumed to correspond to the features with equivalent reference numerals as discussed above, including any potential variations in the features.

TABLE 4

| | Stack | Input power | Output power |
|---|---|---|---|
| Reflector | reflectivity | to reflector | to ray 37 |
| 174A | 25% | 4δ | δ |
| 174B | 33% | 3δ | δ |
| 174C | 50% | 3δ | δ |
| 174D | 100% | δ | δ |

In the alternative embodiment of FIG. 18B, the extraction reflectors 174 extend across the extraction waveguide 1B and the extraction reflectors have the same reflective areas. The reflectivities of the extraction reflectors 174 are defined across their overall area and increase with increasing distance along the optical axis 199(60) for light that is in the extraction waveguide 1B. In other words, the reflectivities of the extraction reflectors 174 are defined across their overall area and increase with increasing distance in the direction 191B along the extraction waveguide 1B.

The stack reflectivity profile of TABLE 4 achieves uniform power δ of output to rays 37A-D, so that advantageously a uniform image luminance is seen for different pupil 44 positions across the exit pupil 40. Such reflectivity profile may be achieved by adjusting the dielectric stack 186A-N to be different at each extraction reflector 174A-N. Such differences may be achieved by adjustment of number, thickness and material of dielectric layers 186.

The illustrative embodiment of TABLE 4 provides desirable output properties for polarised illumination of FIGS. 18A-B, because the extraction reflectors 174 are substantially transparent to light rays 460C with the p-polarised state 902. Thus the reflectors 174D are substantially blocking to transmitted s-polarisation state 904 but are transmitting to p-polarisation state 902 and are thus partially transmitting in a general sense.

Alternative arrangements of extraction reflectors 174 will now be described.

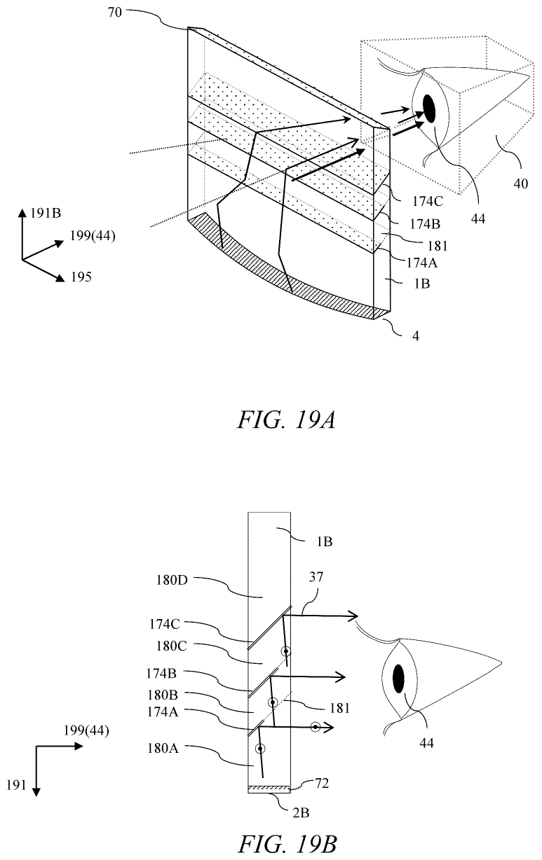

FIG. 19A is a schematic diagram illustrating in perspective front view an alternative arrangement of the anamorphic near-eye display apparatus 100 of FIG. 17A wherein some of the polarising beam splitters 200 do not extend the entirety of the thickness of the extraction waveguide 1B; and FIG. 19B is a schematic diagram illustrating in top view the operation of the anamorphic near-eye display apparatus 100 of FIG. 19A. Features of the embodiment of FIGS. 19A-B not discussed in further detail may be assumed to correspond to the features with equivalent reference numerals as discussed above, including any potential variations in the features.

In the alternative embodiment of FIGS. 19A-B, the extraction reflectors 174 extend across part of the extraction waveguide 1B, the array of extraction reflectors 174 having reflectivities defined across their overall area that increase with increasing distance along the optical axis 199 along the waveguide in the direction 191B. In other words, the extraction reflectors 174 are patterned to have different reflective areas providing reflectivities defined across their overall area that increase with increasing distance along the optical axis 199(60).

Such extraction reflectors 174 may be manufactured by masking of the plates 180 during the formation of the dielectric layers 186A-N, for example by deposition. Some regions 181 of the surfaces of the plates may thus have no dielectric stack. As illustrated in TABLE 4, the total power δ extracted at each facet may be constant across the array of extraction reflectors 174A-D. In comparison to FIG. 18A, the dielectric stack composition may be the same for each of the extraction reflectors 174A-D. Advantageously cost and complexity of deposition onto the plates 180 may be reduced.

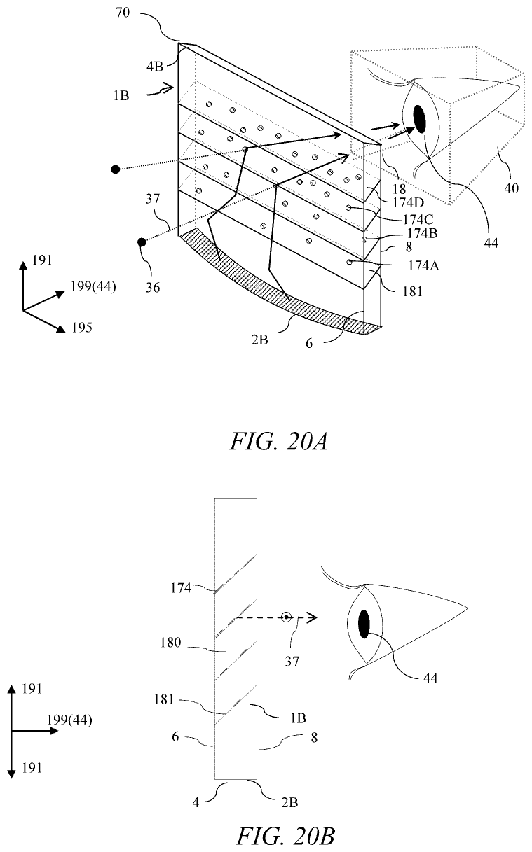

FIG. 20A is a schematic diagram illustrating in perspective front view an alternative arrangement of the anamorphic near-eye display apparatus 100 of FIG. 17A, wherein the polarising beam splitters 200 comprise patterned reflectors; and FIG. 20B is a schematic diagram illustrating in top view the operation of the anamorphic near-eye display apparatus 100 of FIG. 20A. Features of the embodiment of FIGS. 20A-B not discussed in further detail may be assumed to correspond to the features with equivalent reference numerals as discussed above, including any potential variations in the features.

In the alternative embodiment of FIGS. 20A-B, the extraction reflectors 174 have a density by area of patterning that increases with distance along the extraction waveguide 1B in the direction 191B in the extraction waveguide 1B to achieve the desirable reflectivity profile, for example as illustrated in TABLE 4.

The patterning of the extraction reflectors 174 may achieve reduced complexity of fabrication of the plates 180.

Further, the extraction reflectors 174 may comprise high reflectivity metal compared to the dielectric stacks discussed elsewhere herein. In such a case, the input linear polariser 70 and polarisation conversion retarder 72 may be omitted. Advantageously cost may be reduced.

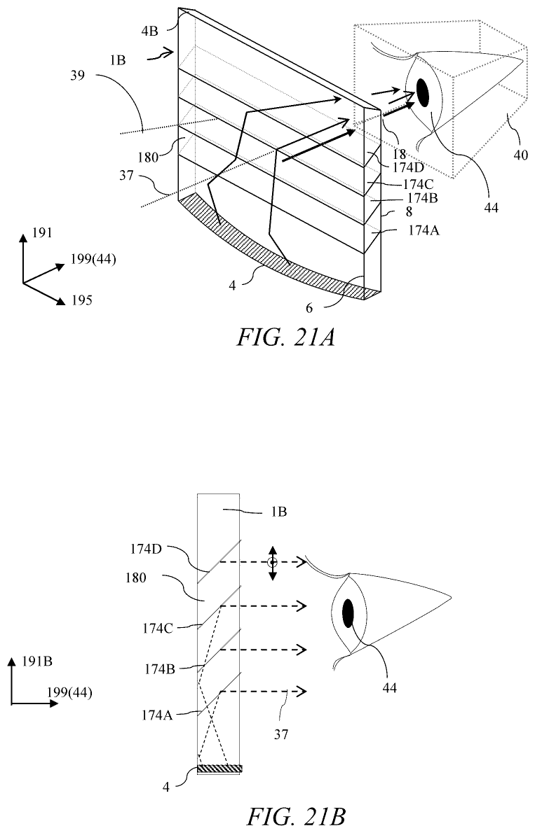

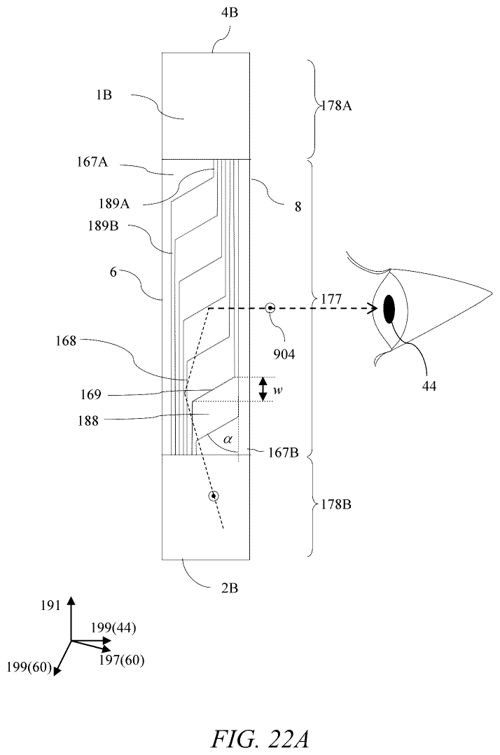

FIG. 21A is a schematic diagram illustrating in perspective front view an alternative arrangement of the anamorphic near-eye display apparatus of FIG. 17A comprising a plurality of partially reflective metal extraction reflectors 174; and FIG. 21B is a schematic diagram illustrating in top view the operation of the anamorphic near-eye display apparatus 100 of FIG. 21A. Features of the embodiment of FIGS. 21A-B not discussed in further detail may be assumed to correspond to the features with equivalent reference numerals as discussed above, including any potential variations in the features.

In the alternative embodiment of FIGS. 21A-B, the extraction reflectors 174A-D are partially reflecting mirrors that may comprise a metallic coating arranged on the plates 180. The metal coatings are adjusted with different reflectivities during manufacture to achieve desirable reflectivity. In comparison to TABLE 4, the maximum reflectivity for the extraction reflector 174D may be 50% or less so that input light 460C is transmitted in the input waveguide 1A.

The input linear polariser 70 and polarisation conversion retarder 72 is omitted and advantageously cost and complexity is reduced.

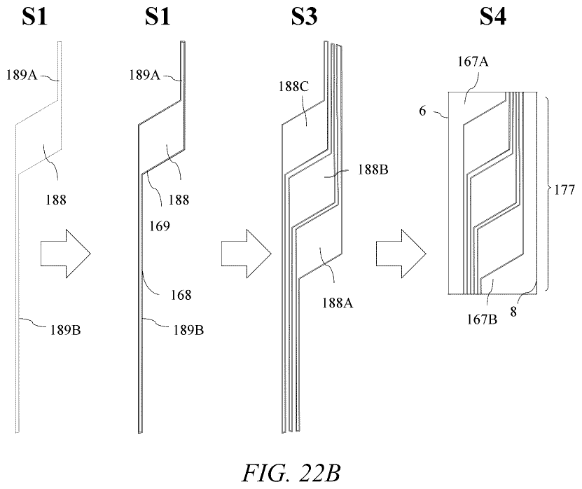

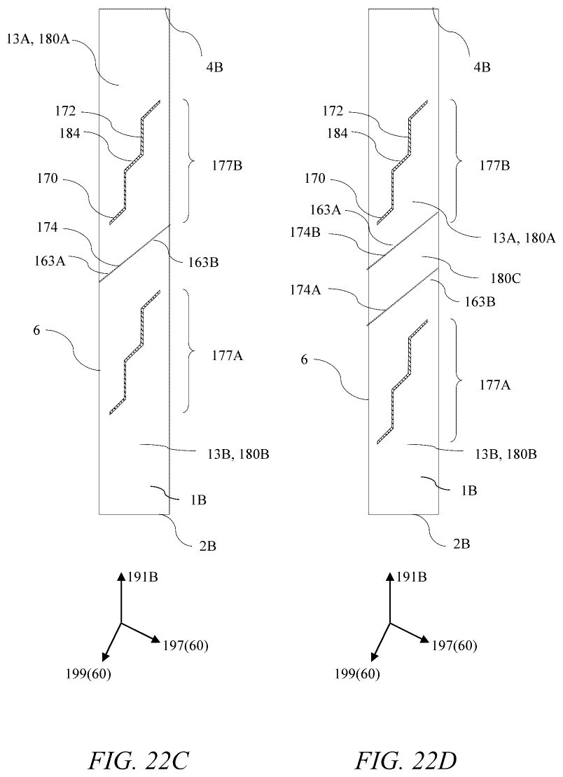

FIG. 22A is a schematic diagram illustrating a top view of an anamorphic near-eye display apparatus 100 comprising a plurality of stepped constituent plates 188. Features of the embodiment of FIG. 22A not discussed in further detail may be assumed to correspond to the features with equivalent reference numerals as discussed above, including any potential variations in the features.

In the alternative embodiment of FIG. 22A, the extraction region 177 comprises plural constituent plates 188, wherein the wherein extraction reflectors 169 are formed between the constituent plates 188. The stepped constituent plates 188 further comprise support members 189A, 189B that extend in the second direction 191B along the extraction waveguide 1B. Outer support members 167A, 167B are provided to form rear and front guide surfaces 6, 8.

In comparison to the embodiment of FIG. 17B, the extraction reflectors extend partly between the rear and front guide surfaces 6, 8, and the steps overlap in the direction 199(44) and in the transverse direction 197(60). The extent w of the extraction reflector 169 is larger than for the stepped surfaces 7A. 7B of FIG. 12A for example. Advantageously blur in the transverse direction 197 is reduced.

FIG. 22B is a schematic diagram illustrating a method to manufacture the extraction region 177 of the extraction waveguide of FIG. 22A. Features of the embodiment of FIG. 22B not discussed in further detail may be assumed to correspond to the features with equivalent reference numerals as discussed above, including any potential variations in the features.

In a first step S1, stepped constituent plate 188 comprising support members 189A, 189B is fabricated by injection moulding for example.

In step S2, the surfaces of the stepped constituent plate 188 are coated with coating 168 such as dielectric layers as described elsewhere herein.

In step S3, a stack of stepped constituent plates 188A-C is attached in alignment, such that the extraction reflectors formed therebetween have a common tilt, a with respect to the direction 191B along the extraction waveguide 1B.

In step S4 outer support members 167A. 167B are added to provide extraction waveguide 1B extraction region 177 part. In a final step (not shown) the non-extracting waveguide parts 178 are added. The outer surfaces 6, 8 may be polished to achieve desirable flatness and parallelism.

The method of FIG. 22B does not use the expensive plate construction method as may be used for the arrangements of FIG. 17A for example. Advantageously cost may be reduced.

It may be desirable to provide further expansion of exit pupil 40 while reducing diffraction blur and manufacturing cost.

FIGS. 22C-D are schematic diagrams illustrating top views of alternative arrangements of extraction waveguides 1 comprising two types of partially reflecting extraction reflectors 170, 174. Features of the embodiments of FIGS. 22C-D not discussed in further detail may be assumed to correspond to the features with equivalent reference numerals as discussed above, including any potential variations in the features.

The extraction waveguides 1 of FIGS. 22C-D comprise first and second extraction parts 13A. 13B. The extraction parts 13A, 13B comprise extraction reflectors 170 and intermediate surfaces 172 of the same type as FIG. 9C. The extraction reflectors 170 and intermediate surfaces 172 may alternatively be of the types illustrated in TABLE 3 or in at least FIGS. 9A-11E disclosed hereinabove.

In the alternative embodiment of FIG. 22C, a further extraction reflector 174 is arranged between the extraction part 13A comprising constituent plate 180A and extraction part comprising constituent plate 180B. The extraction reflector 174 may be at least of the type illustrated in any of the embodiments of FIG. 17A to FIG. 22A disclosed hereinabove.

In operation, the extraction reflectors 170 with stepped shape provide extraction for the region towards the edge of the exit pupil 40, whereas the extraction reflector 174 provides extraction for the central region of the exit pupil 40. Advantageously diffraction blur in the central region is reduced, with improved image quality for the most common viewing direction. Further, the cost of manufacture of the plural constituent plates 180A, 180B is reduced.

In the alternative embodiment of FIG. 22D, further extraction reflectors 174A, 174B and further constituent plate 180C are arranged between the extraction part 13A comprising constituent plate 180A and extraction part comprising constituent plate 180B. In comparison to FIG. 22D, the region of the exit pupil 40 over which the diffraction blur is reduced is advantageously increased.

In an exemplary manufacturing method, the embodiments of FIGS. 22C-D may be formed by fabrication of the extraction parts 13A, 13B as described elsewhere herein, coating of the ends 163A, 163B of the extraction parts 13A, 13B and attaching the ends 163A. 163B, for example by means of an adhesive. Optionally, the surfaces 6, 8 may be subsequently polished to provide desirable light guiding properties.

It may be desirable to reduce the cost and complexity of the extraction waveguide 1B.

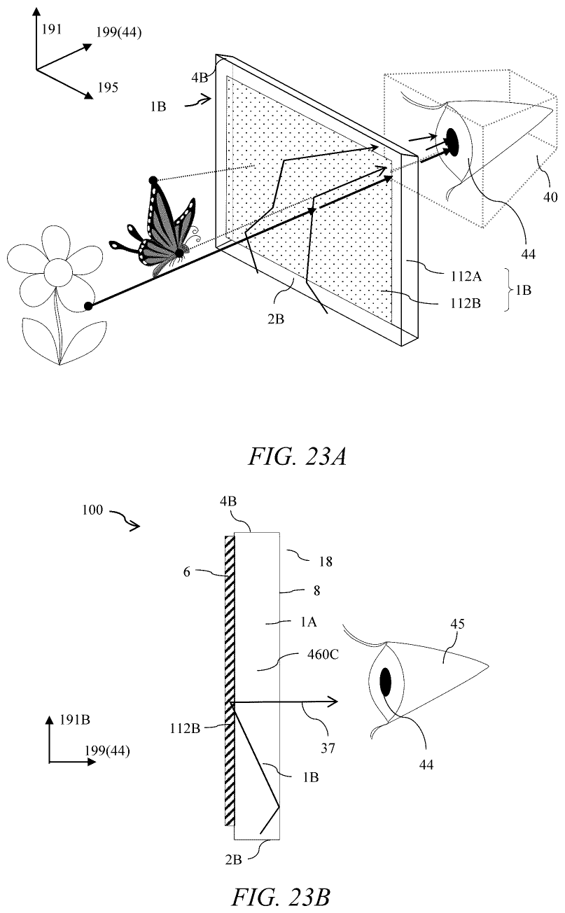

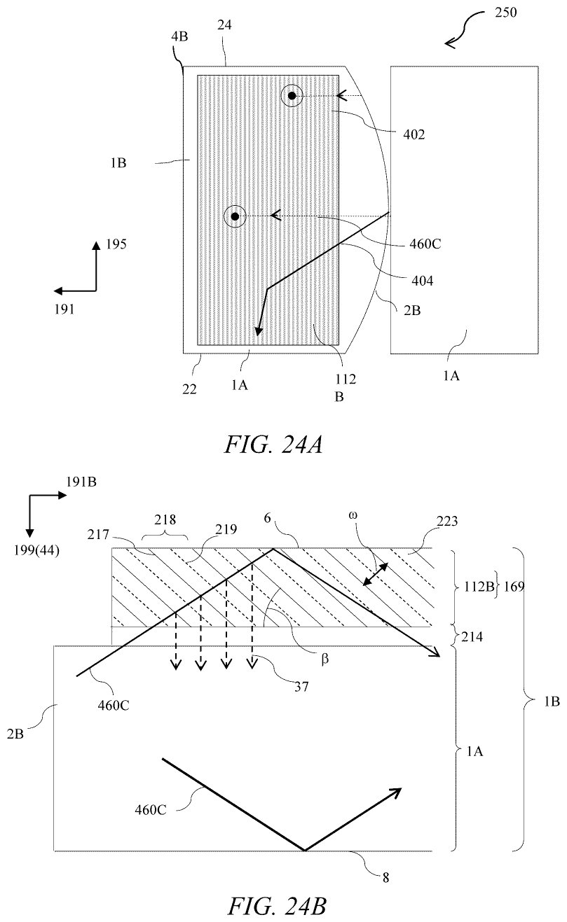

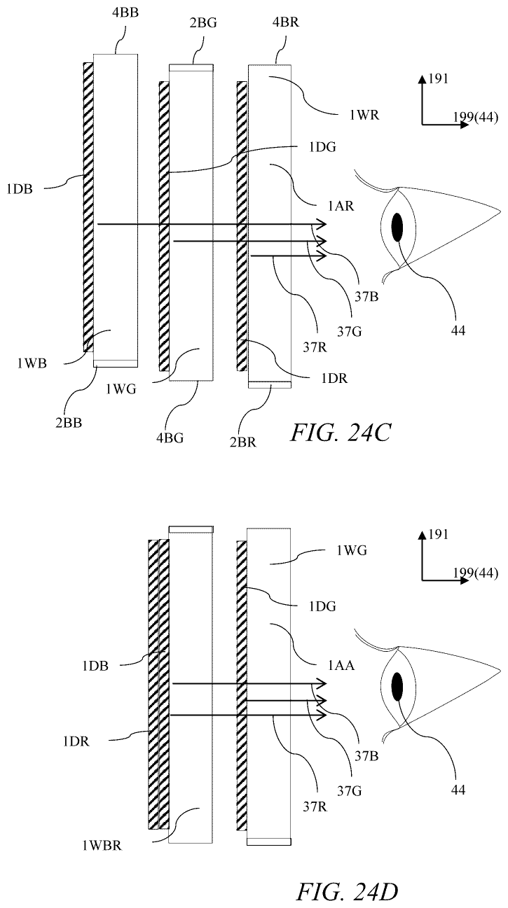

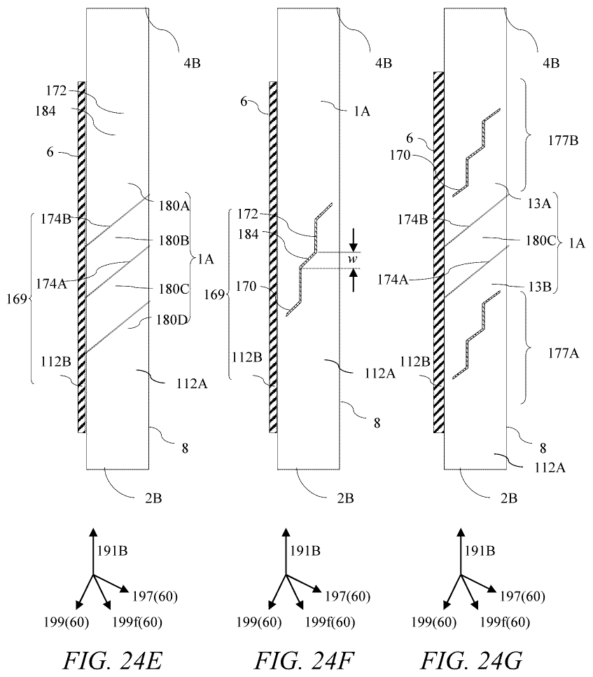

FIG. 23A is a schematic diagram illustrating in perspective front view an alternative arrangement of the anamorphic near-eye display apparatus 100 wherein the extraction waveguide 1B comprises a diffractive optical element 112B will now be described; FIG. 23B is a schematic diagram illustrating in top view the operation of the anamorphic near-eye display apparatus 100 of FIG. 23A; and FIG. 24A is a schematic diagram illustrating in front view the operation of the anamorphic near-eye display apparatus 100 of FIG. 23A. Features of the embodiment of FIGS. 23A-C not discussed in further detail may be assumed to correspond to the features with equivalent reference numerals as discussed above, including any potential variations in the features.

Considering the alternative embodiment of FIG. 23A, the extraction waveguide 1B comprises a transmissive element 1A and a diffractive optical element 112B optically coupled to the transmissive element 1A. The operation of the transverse anamorphic component 60 and lateral anamorphic component 110 are as described elsewhere herein.

Considering FIGS. 23B-C, the diffractive optical element 112B is arranged to provide extraction of some of the light guided in the extraction waveguide 1B between the opposing rear and front guide surfaces 6, 8, wherein the diffractive optical element 112B is arranged between the opposing rear and front guide surfaces 6, 8. Central ray 460C on the optical axis 199(60) along the second direction 191B of the extraction waveguide 1B is partially reflected by the diffractive optical element 112B to output light 464 away from the eye 45.

FIG. 24B is a schematic diagram illustrating in top view operation of a waveguide comprising a diffractive output beam deflector element 216. Features of the embodiment of FIG. 24B not discussed in further detail may be assumed to correspond to the features with equivalent reference numerals as discussed above, including any potential variations in the features.

The extraction waveguide 1B comprises a transmissive element 1A and a diffractive optical element 112B optically coupled together, wherein the reflective extraction features 169 comprise portions 218 of the diffractive optical element 112B. The diffractive optical element 112B is an example of an extraction reflection feature and comprises a combination of iso-index layers 217, 219 provided in a continuum of material 223 with which are the features that extract light.

In other words, the extraction waveguide 1B comprises an array of portions 218 disposed internally within the extraction waveguide 1B, the portions 218 being arranged to transmit light guided 400 along the extraction waveguide 1B in the second direction 191B and to extract light guided along the extraction waveguide 1B in the second direction 191B towards an eye 45 of a viewer. The array of portions 218 are distributed along the extraction waveguide 1B so as to provide exit pupil expansion.

FIG. 24B illustrates that the extraction waveguide 1B comprises the transmissive element 1A and a diffractive optical element 112B optically coupled to the transmissive element 1A by means of adhesive layer 214, wherein the diffractive optical element 112B comprises an array of portions 218. Light rays 460C are guided in the extraction waveguide 1B by means of total internal reflection at opposing rear and front guide surfaces 6, 8 of the extraction waveguide 1B. Thus at least some light rays 460C are transmitted through the portions 218 of the diffractive optical element 112B. The proportion of light that is reflected by the portions 218 may be controlled by means of control of the modulation depth of the portion 218 along the extraction waveguide 1B in the direction 191B.

The diffractive optical element 216 is a volume hologram wherein the portions 218 comprise iso-index planes 217 with increased refractive index and iso-index planes 217 with reduced refractive index. The index modulation between the iso-index plane 217, 219, the inclination β and pitch ω of the iso-index planes 217, 219 provide the portions 218 with desirable extraction of light rays 37 from the diffractive optical element 112B.

FIG. 24B is a schematic diagram illustrating in perspective front view an alternative arrangement of the anamorphic near-eye display apparatus 100 further comprising a diffractive deflector element 217 wherein the diffractive deflector element has optical power in the transverse direction 197. Features of the embodiment of FIG. 24B not discussed in further detail may be assumed to correspond to the features with equivalent reference numerals as discussed above, including any potential variations in the features.

FIG. 24B illustrates that the transverse lens 61 is omitted, and the optical function of the transverse anamorphic component 60 is provided in the iso-index profile of the diffractive deflector element 215 together with the optical function of the deflector 215. Advantageously the size of the input optics may be reduced.

The diffractive optical elements 1B, 215, 217 described hereinabove exhibit limited bandwidth and efficiency and so are well suited to monochrome display.

It may further be desirable to provide a full colour display apparatus comprising diffractive optical elements.

FIG. 24C is a schematic diagram illustrating in top view a full colour anamorphic display apparatus 100 comprising three waveguides 1R. 1G, 1B comprising respective diffractive optical elements; and FIG. 24D is a schematic diagram illustrating in top view a full colour anamorphic display apparatus 100 comprising two waveguides 1RB, 1G comprising respective diffractive optical elements. Features of the embodiment of FIG. 24C not discussed in further detail may be assumed to correspond to the features with equivalent reference numerals as discussed above, including any potential variations in the features.

The anamorphic near-eye display apparatus 100 comprises separate red display apparatus 100R, green display apparatus 100G and blue display apparatus 100B, each respectively comprising red, green and blue illumination systems 240R, 240G, 240B, transverse anamorphic components 60R, 60B, 60G and diffractive optical elements 1BR, 1BG, 1BR arranged on transmissive elements 1AR, 1AG, 1AB. Output light rays 37B, 37G, are transmitted through the extraction waveguide 1BR. Colour images may be advantageously provided.

In the alternative embodiment of FIG. 24D, a first extraction waveguide may be provided with a green diffractive optical element 1AG and transmissive element 1AA and a second extraction waveguide may be provided with red and blue diffractive optical elements 1BR, 1BB and transmissive element 1BA. The second waveguide is illuminated with red and blue light from illumination system 240RB while the illumination system 240G provides green illumination to the first extraction waveguide. Thickness may be reduced in comparison to a stack (not shown) comprising red, green and blue diffractive optical elements, cross-talk between the red and blue diffractive optical elements may be reduced. Colour reproduction may be improved.

It may be desirable to provide further expansion of exit pupil 40 while reducing diffraction blur and manufacturing cost.

FIGS. 24E-G are schematic diagrams illustrating top views of alternative arrangements of extraction waveguides comprising combinations of reflective extraction features 169 of different forms. Features of the embodiments of FIGS. 24E-G not discussed in further detail may be assumed to correspond to the features with equivalent reference numerals as discussed above, including any potential variations in the features.

The extraction waveguides 1 of FIGS. 24E-G comprise transmissive elements 1A that comprise reflective extraction features that are extraction reflectors are reflective extraction features 169 that are a diffractive optical element 112B.

FIG. 24E illustrates an alternative embodiment wherein the extraction reflectors comprise plural constituent plates 180A-D and extraction reflectors 174 as described hereinabove. The central region of the exit pupil 40 in the transverse direction 197 may be provided by the extraction reflectors 174 with advantageously low diffraction blur. The number of constituent plates 180 may be reduced for a desirable exit pupil size e_{T} in the transverse direction 197 and cost advantageously reduced.

The outer regions of the exit pupil 40 in the transverse direction 197 may be provided by the diffractive optical element 112B. The exit pupil 40 may advantageously have an increased size.

In the alternative embodiment of FIG. 24F, extraction reflectors 170 with stepped shape provide extraction for the region towards the centre of the exit pupil 40, whereas the diffraction optical element 1B provides extraction for the outer region of the exit pupil 40. Advantageously high efficiency is provided in the central region. The size w of the extraction reflectors 170 may be increased and diffractive blur advantageously reduced. Further, the cost of manufacture may be reduced.

In the alternative embodiment of FIG. 24G, in comparison to the arrangement of FIG. 22D further reflective extraction features 169 comprising portions of a diffractive optical element 112B are provided. The size of the exit pupil 40 is advantageously increased and manufacturing cost reduced.

The alternative embodiments of FIGS. 24E-G illustrate non-limiting arrangements comprising different types of reflective extraction features 169. The various embodiments described elsewhere herein for reflective extraction features 169 may be arranged together in further arrangements to achieve optimisation of manufacturing cost, exit pupil 40 size, image blur, stray light and other desirable display characteristics of the near-eye anamorphic display 100 of the present disclosure.

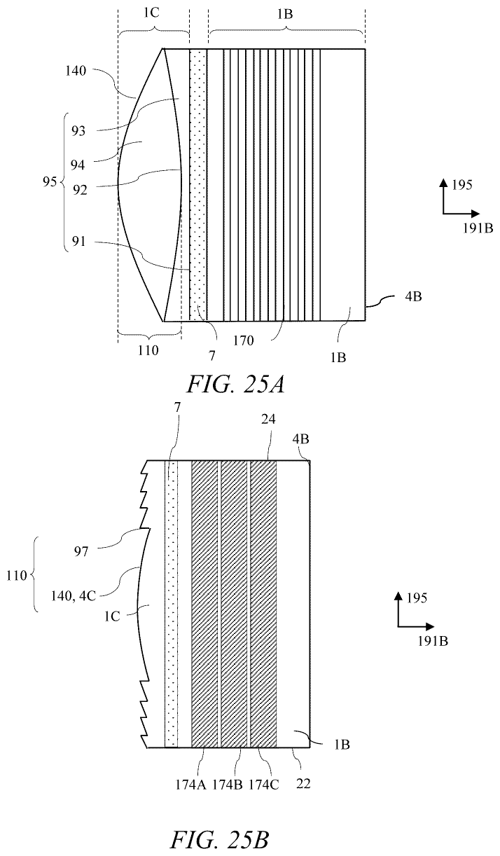

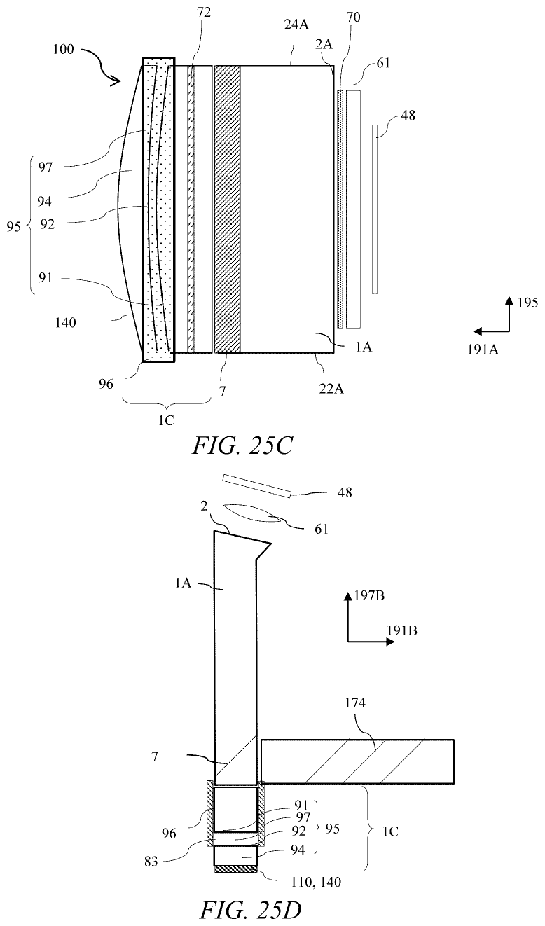

It may be desirable to provide reduced aberrations from the lateral anamorphic component 110. Some approaches for reducing aberrations are implemented in the following examples. In the following examples, specific examples of the refractive extraction features 169 are shown (for example being extraction reflectors 170 in FIG. 25A and extraction reflectors 174 in FIGS. 25B-D and so on), but this is not limitative and in general any of the refractive extraction features 169 disclosed herein may alternatively be applied in the following examples. Similarly, the various features of the following examples may be combined together in any combination.

FIG. 25A is a schematic diagram illustrating in front view an anamorphic near-eye display apparatus 100 wherein the lateral anamorphic component 110 comprises the curved light reversing reflector 140 at the end 4C of the intermediate waveguide 1C and further comprises refractive components, in particular surfaces 91, 92 and intermediate materials 93, 94, that form part of the intermediate waveguide 1C. Features of the embodiment of FIG. 25A not discussed in further detail may be assumed to correspond to the features with equivalent reference numerals as discussed above, including any potential variations in the features.

In the alternative embodiments of FIGS. 25A-B, the side view illustrates the partially reflective mirror 7, intermediate waveguide 1C and extraction waveguide 1B, wherein the input waveguide 1A is not illustrated.

FIG. 25A illustrates that the lateral anamorphic component 110 may further comprises a lens 95 comprising in this example surfaces 91, 92 and intermediate materials 93, 94. The lens 95 may be arranged with rear and front guide surfaces that are co-planar with the opposing light guide surfaces 6C. 8C of the intermediate waveguide 1C. Advantageously high efficiency and high image fidelity may be achieved.

In operation, the lens 95 may be arranged to provide improved aberrations in the lateral direction 195 over a wider exit aperture e_{L}. Thus the image blur 455 as illustrated in FIG. 1I may advantageously be reduced.

In the alternative embodiment of FIGS. 25A, the extraction waveguide 1B is illustrated with stepped extraction reflectors 170, although the embodiments of FIGS. 25A-B are not limited to the stepped extraction reflectors 170 and any other reflective extraction features 169 described hereinbefore may be provided as alternatives.

It may be desirable to reduce the size of the reflective end 4 of the intermediate waveguide 1C.

FIG. 25B is a schematic diagram illustrating in front view an anamorphic near-eye display apparatus 100 wherein the lateral anamorphic component 110 comprises the end 4C of the intermediate waveguide 1C, which is arranged in this example as a Fresnel surface 97. Features of the embodiment of FIG. 25B not discussed in further detail may be assumed to correspond to the features with equivalent reference numerals as discussed above, including any potential variations in the features.

In the alternative embodiment of FIGS. 25B, Fresnel surface 97 is arranged to advantageously remove the sag of a domed input face 2B of FIG. 25A. The extraction waveguide 1B is illustrated with extraction reflectors 174 arranged between plural plates 180 although the other extraction reflectors described hereinbefore may be provided as alternatives.

FIG. 25C is a schematic diagram illustrating in front view an anamorphic near-eye display apparatus 100 wherein the lateral anamorphic component 110 comprises a refractive component 95 comprising an air gap and air gap mirrors 96; and FIG. 25D is a schematic diagram illustrating in top view the anamorphic near-eye display apparatus 100 of FIG. 25C. Features of the embodiments of FIGS. 25C-D not discussed in further detail may be assumed to correspond to the features with equivalent reference numerals as discussed above, including any potential variations in the features.

By comparison with FIG. 25A, in the alternative embodiment of FIG. 25C, the intermediate material 93 is replaced by an air gap 97 with surfaces 91, 92 facing the air gap 97. The refractive power of the surfaces 91, 92 may be modified, advantageously providing increased control of aberrations in the lateral direction 195. The surfaces 91, 92 may have circular, elliptical or other aspheric top view profiles to advantageously maximise image performance directed to the eye 45.

The air gap 97 has edges 83, and the anamorphic near-eye display apparatus 100 further comprises reflectors that are air gap mirrors 96 extending across the edges 83 of the air gap 97. The air gap mirrors 96 provide trapping of guiding light in the region of the air gap 97. Advantageously efficiency is increased and spatial uniformity improved.

It may be desirable to reduce image blur at higher lateral field angles.

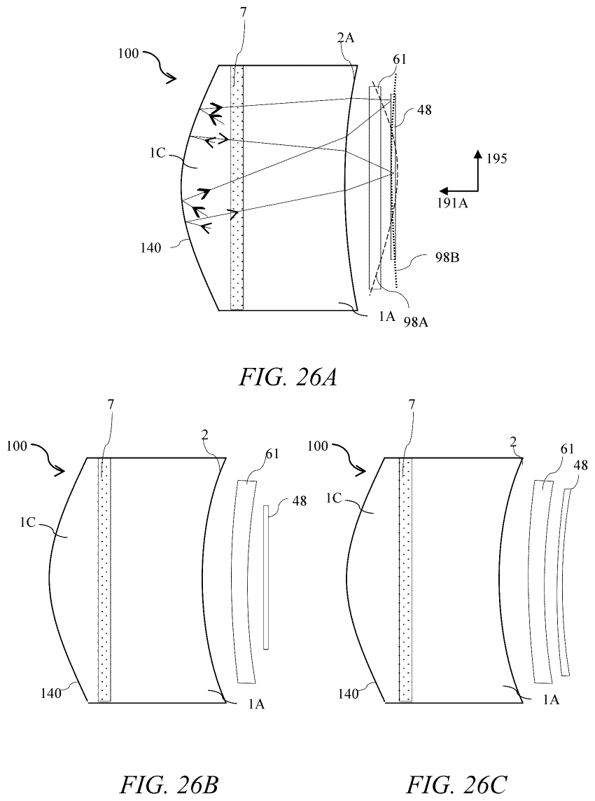

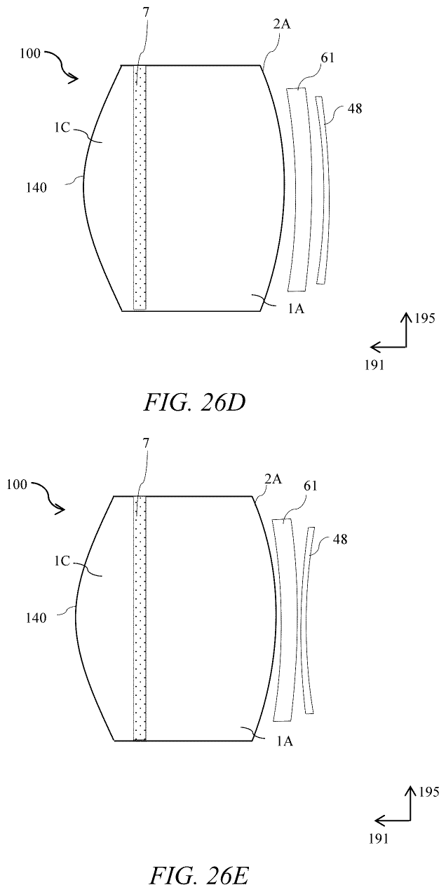

FIG. 26A is a schematic diagram illustrating in front view an anamorphic near-eye display apparatus 100 wherein the input face 2A of the input waveguide 1A has a curvature in the lateral direction 195 (which may be planar for one of the surfaces 4A, 2B). Features of the embodiment of FIG. 26A not discussed in further detail may be assumed to correspond to the features with equivalent reference numerals as discussed above, including any potential variations in the features.

In the alternative embodiments of FIGS. 26A-E, the side view illustrates the partially reflective mirror 7, intermediate waveguide 1C and extraction waveguide 1B, wherein the extraction waveguide 1B is not illustrated.

In the illustrative embodiment of FIG. 1A hereinabove, the input face 2A of the input waveguide 1A has no curvature in the lateral direction 195. In practice, aberrations including those of the lateral anamorphic component 110 may provide Petzval field curvature provides an illustrative curved field surface 98A as marked in FIG. 26A. Image pixels on the field surface 98A provide the largest modulation transfer function (MTF) when seen by the eye 45. Image pixels that are separated in the direction 191A from the field surface 98A have reduced MTF, appearing more blurry. It would be desirable to provide pixels 222 of the spatial light modulator 48 that are on the field surface 98 of the optical system.

In the alternative embodiment of FIG. 26A, the input end 2A of the input waveguide 1A has a curvature in the lateral direction 195 that compensates for Petzval field curvature of the lateral anamorphic component 110. Thus the desirable field surface 98B provided by FIG. 26B is more closely aligned to the plane of the spatial light modulator 48. MTF for off-axis field points is increased and advantageously image blur is reduced.

Alternative embodiments to reduce field curvature will now be described.

FIG. 26B is a schematic diagram illustrating in front view an anamorphic near-eye display apparatus 100 wherein the input face 2A of the input waveguide 1A has curvature in the lateral direction 195 and the transverse anamorphic component 60 has curvature in the lateral direction 195; FIG. 26C is a schematic diagram illustrating in front view an anamorphic near-eye display apparatus 100 the input face 2A of the input waveguide 1A and the transverse anamorphic component 60 has curvature in the lateral direction 195, and the spatial light modulator 48 has curvature in the lateral direction 195; FIG. 26D is a schematic diagram illustrating in front view an anamorphic near-eye display apparatus 100 wherein the input face 2A of the input waveguide 1A has curvature in the lateral direction 195 195, the transverse anamorphic component 60 has curvature in the lateral direction 195 and the spatial light modulator 48 has curvature in the lateral direction 195, where the direction of curvature of each of the input face 2A of the input waveguide 1A, the transverse anamorphic component 60 and the spatial light modulator 48 is opposite to that of FIG. 26C; and FIG. 26E is a schematic diagram illustrating in front view an anamorphic near-eye display apparatus 100 wherein the input face 2A of the input waveguide 1A has curvature in the lateral direction 195, the transverse anamorphic component 60 has curvature in the lateral direction 195, and the spatial light modulator 48 has curvature in the lateral direction 195, where the direction of curvature of each of the input face 2A and the transverse anamorphic component 60 is the opposite to that of FIG. 26C, and the direction of curvature of the spatial light modulator 48 is the same as that of FIG. 26C. Features of the embodiments of FIGS. 26B-E not discussed in further detail may be assumed to correspond to the features with equivalent reference numerals as discussed above, including any potential variations in the features.

The alternative embodiments of FIGS. 26B-E are examples illustrating the case that at least one of the input face 2A of the input waveguide 1A, the transverse anamorphic component 60 and the spatial light modulator 48 has a curvature in the lateral direction 195 in a manner that compensates for Petzval field curvature of the lateral anamorphic component 110. The directions of curvature of respective elements 2, 60, 48 may be modified to achieve optimised image performance so that the MTF for off-axis field points is further increased and advantageously image blur is reduced.

In comparison to non-anamorphic components, the curvature may be arranged about only one axis. In particular, the spatial light modulator 48 may comprise a silicon or glass backplane. Such backplanes are not typically suitable for curvature about two axes. However in the present embodiments, single axis curvature may achieve desirable correction for field curvature. Advantageously the cost of achieving a suitably curved spatial light modulator 48 may be reduced.

It would be desirable to provide further improvement of aberrations from the lateral anamorphic component 110.

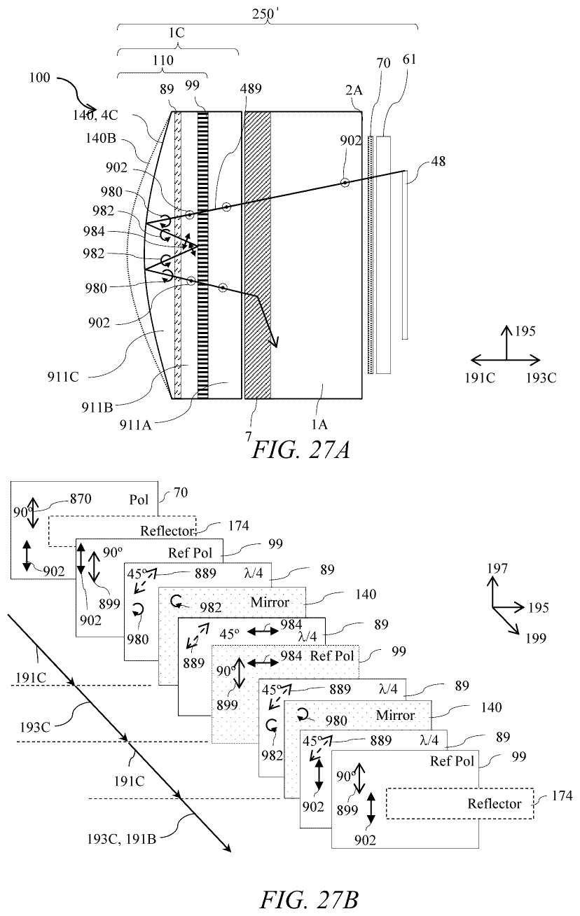

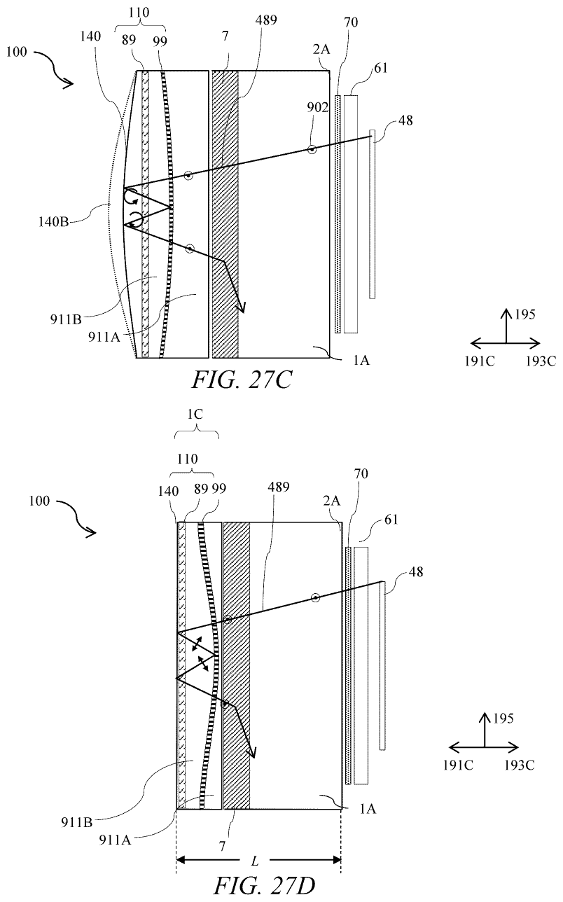

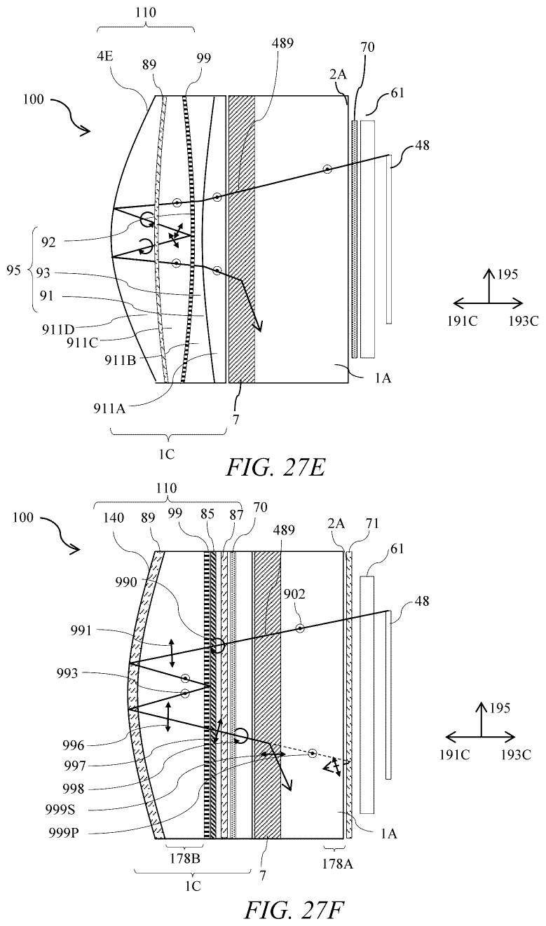

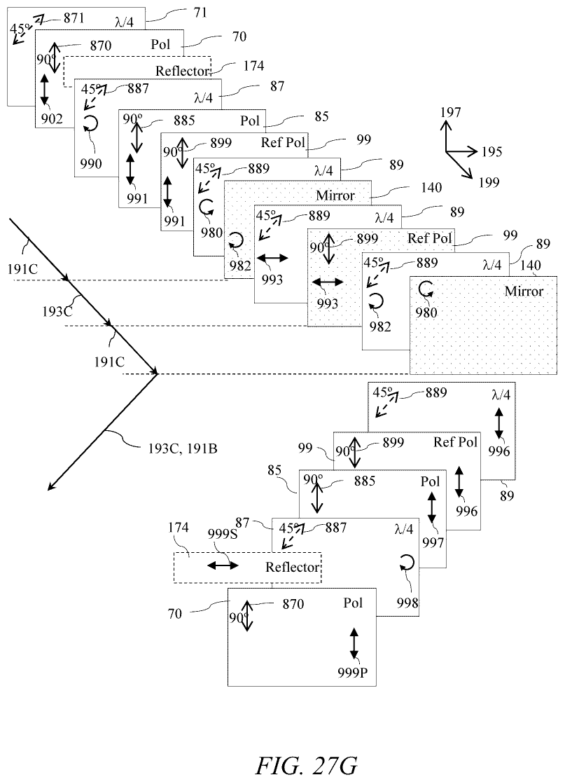

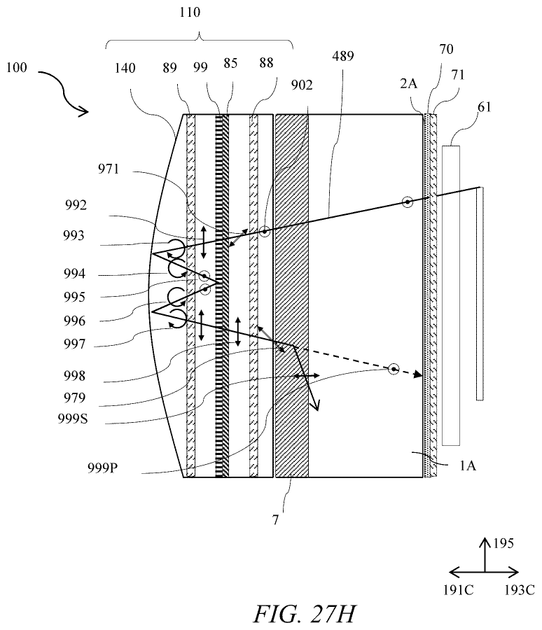

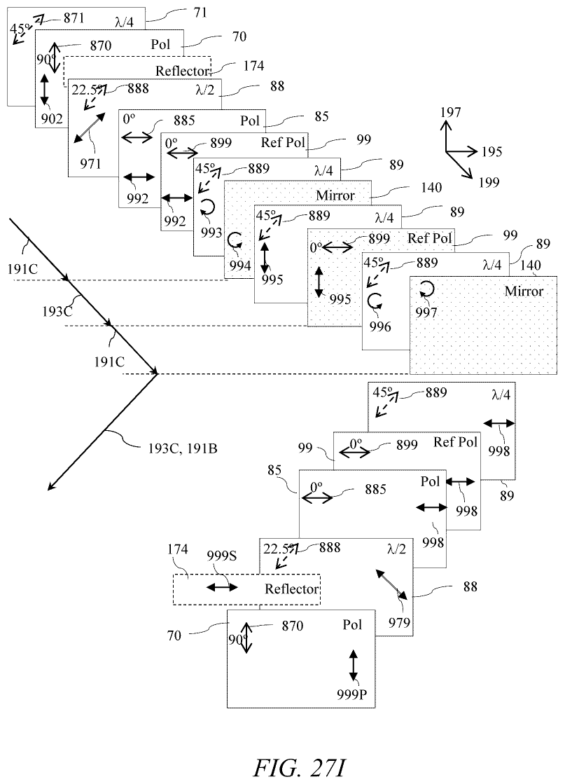

FIG. 27A is a schematic diagram illustrating in front view an anamorphic near-eye display apparatus 100 wherein the lateral anamorphic component 110 further comprises a planar reflective linear polariser 99 and a polarisation conversion retarder 89 arranged between the light reversing reflector 140 that is the reflective end 4C, and the reflective linear polariser 99; and FIG. 27B is a schematic diagram illustrating optical axis alignment directions through the polarisation control components of FIG. 27A. Features of the embodiment of FIGS. 27A-B not discussed in further detail may be assumed to correspond to the features with equivalent reference numerals as discussed above, including any potential variations in the features.

In the alternative embodiment of FIG. 27A, the lateral anamorphic component 110 comprises: a reflective linear polariser 99 disposed between the light reversing reflector 140 wherein the light reversing reflector 140 is curved in the lateral direction 195 and the array of extraction reflectors 174A-C; and a polarisation conversion retarder 89 disposed between the reflective linear polariser 99 and the light reversing reflector 140, the polarisation conversion retarder 89 being arranged to convert a polarisation state of light passing therethrough between a linear polarisation state and a circular polarisation state.

The reflective linear polariser 99 is arranged between intermediate waveguide 1C parts 911A, 911B and the polarisation conversion retarder 89 is arranged between intermediate waveguide 1C parts 911B, 911C. In alternative embodiments such as illustrated in FIG. 27F hereinbelow, the polarisation conversion retarder 89 may be arranged on the reflective linear polariser 99 or on the light reversing reflector 140 such that the intermediate waveguide 1C part 911C is omitted.

In FIG. 27B, illustrative arrangements of optical axis direction 889 of polarisation conversion retarder 89 respectively is illustrated; and the linear polarisation state transmission axes 870, 899 of polarisers 70, 99 respectively. For illustrative purposes, the geometry is unfolded after reflection at the light reversing reflector 140.

Considering light ray 489, input linear polariser 70 provides p-polarisation state 902 in the intermediate waveguide 1C 1. Light ray 489 is transmitted by reflective linear polariser 99. The polarisation conversion retarder 89 has a retardance of a quarter wavelength at a wavelength of visible light; that is the polarisation conversion retarder 89 may be a quarter wave retardation at a visible wavelength such as 550 nm and may comprise a stack of composite retarders arranged to achieve the operation of a quarter wave retarder over an increased spectral band, for example comprising a Pancharatnam stack. The retardance of the polarisation conversion retarder 89 may be different to a quarter wavelength, but selected to provide the same effect. For example, the polarisation conversion retarder 89 may have a retardance of three quarter wavelengths or five quarter wavelengths, for example.

The optical system 250 further comprises an input linear polariser 70 disposed between the spatial light modulator 48 and the array of extraction reflectors 174A-C, wherein the input linear polariser 70 and the reflective linear polariser 99 of the lateral anamorphic component 110 are arranged to pass a common polarisation state.

Reflective linear polariser 99 may be a wire grid polariser or a multilayer polariser film such as 3M APF reflective polariser and may be bonded between parts 911A. 911B of the intermediate waveguide 1C.

The polarisation conversion retarder 89 of FIG. 27A outputs a circular polarisation state 980. After reflection at the light reversing reflector 140, the circular polarisation state 982 is provided due to the phase shift at reflection and is converted to s-polarisation state 984 that is reflected by reflective linear polariser 99. Light ray 489 is then reflected a second time by the light reversing reflector 140 to provide polarisation state 902 that is transmitted through the reflective linear polariser 99 and reflected by the extraction reflectors 174A-C. Thus the polarisation conversion retarder 89 has a different function to the polarisation conversion retarder 72 of FIG. 6A for example.

The light ray 489 is thus incident twice onto the light reversing reflector 140. Such an arrangement may reduce the sag of the light reversing reflector 140 in comparison to the light reversing reflector 140B that would be used if the reflective linear polariser 99 and polarisation conversion retarder 89 were omitted. Aberrations of the optical system may be reduced and MTF increased. Further the optical power is achromatic, minimising colour blur. Advantageously the eye 45 may see reduced image blur for off-axis viewing directions. Field of view may be increased for high image quality.

In alternative embodiments to those described elsewhere herein, the polarisation state 902 may be provided by another polarisation state such as a linearly polarised s-polarisation state or a circular polarisation state for example. Corresponding polarisation states that propagate through the system may be provided, to achieve a similar operation. The polarisation state 902 may be provided to achieve desirably low glare for light exiting from the extraction waveguide 1B away from the eye 45 of the viewer 47 and efficient reflection from reflective extraction features 169 after reflection from the light reversing reflector 140. Further improvement of aberrations as described hereinbelow may be achieved.

FIG. 27C is a schematic diagram illustrating in front view an anamorphic near-eye display apparatus 100 wherein the lateral anamorphic component 110 further comprises a curved reflective linear polariser 99 and a polarisation conversion retarder 89 arranged between the light reversing reflector 140 that is the reflective end 4, and the reflective linear polariser 99. Features of the embodiment of FIG. 27C not discussed in further detail may be assumed to correspond to the features with equivalent reference numerals as discussed above, including any potential variations in the features.

In comparison to the embodiment of FIG. 27A, in the alternative embodiment of FIG. 27C, the reflective polarizer 99 is curved in the lateral direction 195. Reflections take place in series from surface 140, then surface 99 and then surface 140 again. Optical power is provided at each reflection so that the curvature of each surface can be reduced to achieve the desired optical power of the lateral anamorphic component 110. Aberrations of the optical system may be further reduced and MTF increased. Further the optical power is achromatic, minimising colour blur. Advantageously the eye 45 may see reduced image blur for off-axis viewing directions. The light reversing reflectors 140 of the present embodiments may be aspheric. Field of view may be further increased for high image quality.

Further, the reflective linear polariser 99 may be provided in manufacture by means of curving the surface of the reflective linear polariser 99 about a single axis. Distortions of the reflective linear polariser 99 may be advantageously reduced.

FIG. 27D is a schematic diagram illustrating in front view an anamorphic near-eye display apparatus 100 wherein the lateral anamorphic component 110 further comprises a planar light reversing reflector 140 that is the reflective end 4, a curved reflective linear polariser 99 and a polarisation conversion retarder 89 arranged between the planar light reversing reflector 140 that is the reflective end 4, and the reflective linear polariser 99; and FIG. 27E is a schematic diagram illustrating in front view an anamorphic near-eye display apparatus 100 wherein the lateral anamorphic component 110 comprises a curved light reversing reflector 140 that is the reflective end 4, a curved reflective linear polariser 99; a polarisation conversion retarder 89 arranged between the planar light reversing reflector 140 that is the reflective end 4, and the reflective linear polariser 99 and a refractive lens arranged between the input end 2 and the reflective linear polariser 99. Features of the embodiments of FIGS. 27D-E not discussed in further detail may be assumed to correspond to the features with equivalent reference numerals as discussed above, including any potential variations in the features.

In the alternative embodiment of FIG. 27D, the light reversing reflector 140 is not curved in the lateral direction 195 and is planar; and the reflective linear polariser 99 is arranged to provide the optical power of the lateral anamorphic component 110. Advantageously the length L of the input waveguide 1A may be reduced for a desirable focal length of the light reversing reflector. Aberrations may advantageously be improved in a smaller package.

Further the reflective linear polariser 99 may have a profile that has an aspheric shape to advantageously achieve improved aberrations.

In the alternative embodiment of FIG. 27E, the polarisation conversion retarder 89 is curved in the lateral direction and is arranged between intermediate waveguide 1C parts 911C, 911D that have different refractive indices and/or different dispersions of refractive index with wavelength. Advantageously further correction of aberrations may be achieved.

The alternative embodiment of FIG. 27E further shows refractive lens 95 comprising surface 91 between intermediate waveguide 1C parts 911A, 911B, surface 92 of the reflective linear polariser 99 and material 93 that has a different refractive index to the material of the intermediate waveguide 1C part 911A. Such an arrangement may further provide increased control of aberrations. Off-axis field of view for desirable image blur may be further increased.

The embodiments of FIGS. 27A-G show that the same polarisation state 902 propagates in the first and second directions 191, 193 in the intermediate waveguide 1C. It may be desirable to reduce stray light.

FIG. 27F is a schematic diagram illustrating in front view an anamorphic near-eye display apparatus 100 wherein the lateral anamorphic component 110 further comprises an absorbing polariser 85; a reflective linear polariser 99; a polarisation conversion retarder 89 arranged between the light reversing reflector 140 that is the reflective end 4, and the reflective linear polariser 99; a polarisation control retarder 87 arranged between the input end 2 and the reflective linear polariser 99; and FIG. 27G is a schematic diagram illustrating propagation of illustrative polarisation states through the polarisation control components of FIG. 27F. Features of the embodiments of FIGS. 27F-G not discussed in further detail may be assumed to correspond to the features with equivalent reference numerals as discussed above, including any potential variations in the features.

In the alternative embodiment of FIG. 27F, the optical system 250 comprises an input linear polariser 70 disposed between the spatial light modulator 48 and the array of extraction reflectors 170 and the lateral anamorphic component 110 further comprises: a polarisation control retarder 87 disposed between the reflective linear polariser 99 and the array of extraction reflectors 170, the polarisation control retarder 87 being arranged to change a polarisation state of light passing therethrough; and an absorbing linear polariser 85 disposed between the polarisation control retarder 87 and the reflective linear polariser 99, wherein the absorbing linear polariser 85 and the reflective linear polariser 99 are arranged to pass a common linear polarisation state that is a component of the polarisation state output from the polarisation control retarder 87 in the direction 191C along the intermediate waveguide 1C.

In FIG. 27F the polarisation control retarder 87 has a retardance of a quarter wavelength at a wavelength of visible light such as 550 nm and may be a Pancharatnam retarder. Polarisation control retarder 87 is arranged to convert a polarisation state of light passing therethrough between a linear polarisation state 902, 997 and a circular polarisation state 990, 998. Polarisation control retarder 87 has a retardance and optical axis direction 887 arranged to provide said conversion.

The optical system 250 comprises an input linear polariser 70 disposed between the spatial light modulator 48 and the array of extraction reflectors 170 and polarisation conversion retarder 89 is curved in the lateral direction 195.

In FIG. 27G, illustrative arrangements of optical axis directions 871, 887, 889 of quarter wave retarders 71, 87, 89 respectively are illustrated; and the linear polarisation state transmission axes 870, 885, 899 of polarisers 70, 85, 99 respectively. For illustrative purposes, the geometry is unfolded after reflection at the light reversing reflector 140. At least some of the quarter wave retarders 71, 87, 89 may have a quarter wave retardation at a visible wavelength such as 550 nm and may comprise a stack of composite retarders arranged to achieve the operation of a quarter wave retarder over an increased spectral band, for example comprising a Pancharatnam stack.

Considering the propagation of polarisation states along the ray 489 in FIG. 27F then the linear polarisation state is converted to circular polarisation state 990 before the absorbing polariser 85 that has an electric vector transmission direction parallel to the electric vector transmission direction of the reflective linear polariser 99.

Half of the light is transmitted through the reflective linear polariser 99 and polarisation states 991, 992, 993, 994, 995, 996, 997 are provided by the various reflections and passes through polarisation conversion retarder 89 as described for FIG. 27A hereinabove. The polarisation control retarder 87 provides circular polarisation state 998, with some light with polarisation state 999S reflected by polarisation-selective extraction reflectors 174A-C, while the light with polarisation state 999P is transmitted to the input end 2.

As described elsewhere herein, the polarisation conversion retarder 71 may be arranged to reflect the residual transmitted light to be absorbed at input linear polariser 70. Advantageously visibility of the unextracted light is reduced.

FIG. 27F further illustrates alternative arrangements of polariser and retarder locations. Such alternative illustrative arrangements of polariser and retarder locations may be provided together or individually in other embodiments as described elsewhere herein.

In the alternative embodiment of FIG. 27F, the input linear polariser 70 is not arranged at the input end 2, and a region 178 of extraction waveguide 1 is provided between the input end 2 and the input linear polariser 70. In operation, the linear polariser 70 is arranged near to the extraction reflector 174C and provides improved polarisation state uniformity for input light ray 489 before incidence onto the extraction reflectors 174C. Further polariser 85 is arranged close to the extraction reflector 174A.

In the regions 178A, 178B, there may for example be some residual birefringence in the bulk material of the extraction waveguide 1 that may cause some polarisation state modification to an input linear polarisation state. The arrangement of FIG. 27F achieves a more uniform polarisation state 902 for light ray 489 incident onto the extraction reflectors 174A-C. Advantageously uniformity may be increased and light lost as glare to the external environment reduced.

Further the polarisation conversion retarder 89 is curved and arranged on the light reversing reflector 140. Advantageously complexity of fabrication is reduced.

FIG. 27H is a schematic diagram illustrating in front view an anamorphic near-eye display apparatus 100 wherein the lateral anamorphic component 110 further comprises an absorbing polariser 85; a planar reflective linear polariser 99; a polarisation conversion retarder 89 arranged between the light reversing reflector 140 that is the reflective end 4, and the reflective linear polariser 99; and a further half wave retarder 88 arranged between the input end 2 and the reflective linear polariser 99; and FIG. 27I is a schematic diagram illustrating propagation of illustrative polarisation states through the polarisation control components of FIG. 27H. Features of the embodiments of FIGS. 27H-I not discussed in further detail may be assumed to correspond to the features with equivalent reference numerals as discussed above, including any potential variations in the features.

By way of comparison with FIGS. 27F-G, in the alternative embodiments of FIGS. 27H-I, the polarisation control retarder 87 has a retardance of a half wavelength at a wavelength of visible light and is arranged to rotate the linear polarisation state, for example between linear polarisation state 902 and linear polarisation state 971 and between linear polarisation state 998 and linear polarisation state 979.

Polarisation control retarder 87 has a retardance and optical axis direction 887 arranged to provide a linear polarisation state 971 inclined at 45 degrees to the electric vector transmission direction of the reflective linear polariser 99 and absorbing polariser 85. Half of the light is transmitted as polarisation state 992 which as described in FIG. 27F provides a linear polarisation state 998 that is transmitted through the reflective linear polariser 99 and absorbing polariser 85. Polarisation control retarder 87 converts this to 45 degrees linear state 979. Some light with polarisation state 999S is reflected by polarisation-selective extraction reflectors 174A-C, while the light with polarisation state 999P is transmitted to the input end 2.

The polarisation control retarder 87 may have a half wave retardance at a visible wavelength such as 550 nm and may comprise a stack of composite retarders arranged to achieve the operation of a half wave retarder over an increased spectral band, for example comprising a Pancharatnam stack.

The embodiments of FIG. 27A-F achieve reduced loss of light propagating along the direction 191 through the intermediate waveguide 1C. Advantageously glow is reduced.

Lenses for use with the anamorphic near-eye display apparatus 100 will now be described.

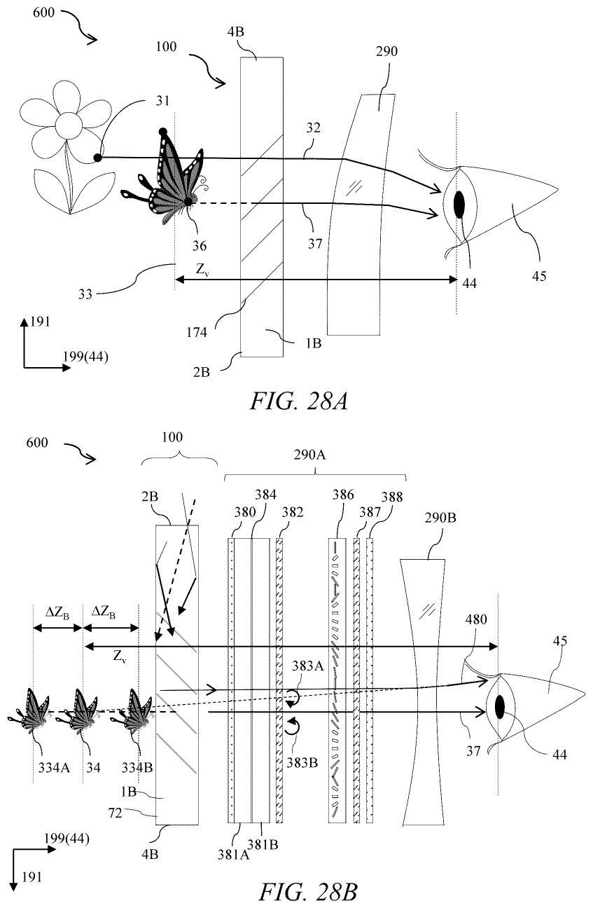

FIG. 28A is a schematic diagram illustrating in side view the operation of an anamorphic near-eye display apparatus 100 of FIG. 1 further comprising a lens 290. Features of the embodiment of FIG. 28A not discussed in further detail may be assumed to correspond to the features with equivalent reference numerals as discussed above, including any potential variations in the features.

The anamorphic near-eye display apparatus 100 described hereinabove provides virtual images 36 that are located in the far field, so that the nominal viewing distance Z, is infinite. It may be desirable to provide modification of the distance Zᵥ to the virtual image plane 33 of the virtual image 36 provided by the anamorphic near-eye display apparatus 100.

The head-worn display apparatus 600 further comprises at least one lens 290 that may be a corrective lens having optical power for correcting eyesight. The correction of eyesight may be for example to correct for the eyesight, for example to correct for presbyopia, astigmatism, myopia or hyperopia of the display user 45.

The lens 290 may further or alternatively be a focal plane modifying lens for providing the virtual image 33 such that the distance Zᵥ is a finite distance. Such an arrangement may provide suitable accommodation cues for the display user 47 such that virtual images that are desirably close to the user 47 are provided at desirable accommodation distances. In stereoscopic display applications, the accommodation correction of the lens 290 may be arranged to approximate the convergence distance of the imagery. Accommodation-convergence mismatch may be reduced and advantageously visual stress reduced, increasing comfort of use.

Such lenses 290 may be used for example in the spectacles head-worn display apparatus 600 of FIGS. 14A-B or the virtual reality head-worn display apparatus 600 of FIG. 16A.

It may be desirable to adjust the accommodation distance Zᵥ of the virtual image.

FIG. 28B is a schematic diagram illustrating in side view the operation of an anamorphic near-eye display apparatus 100 of FIG. 1 further comprising a Pancharatnam-Berry lens 386. Features of the embodiment of FIG. 28B not discussed in further detail may be assumed to correspond to the features with equivalent reference numerals as discussed above, including any potential variations in the features.

In the alternative embodiment of FIG. 28B, the anamorphic near-eye display apparatus 100 is arranged to direct output light rays 37 into lens 290 that comprises a switchable optical stack.

Switchable optical stack comprises input polariser 380, transparent substrates 381A, 381B with an electrically switchable liquid crystal layer 384 provided therebetween and a quarter wave retarder 382. In a first state, the liquid crystal layer 384 is arranged to provide no polarisation rotation of the polarised light from the polariser 380 and the switchable optical stack provides a first circularly polarised output polarisation state 383A. In a second state, the liquid crystal layer 384 is arranged to provide a polarisation rotation of the polarised light from the polariser 380 and the switchable optical stack provides a second circularly polarised output polarisation state 383B, orthogonal to the polarisation state 383A.

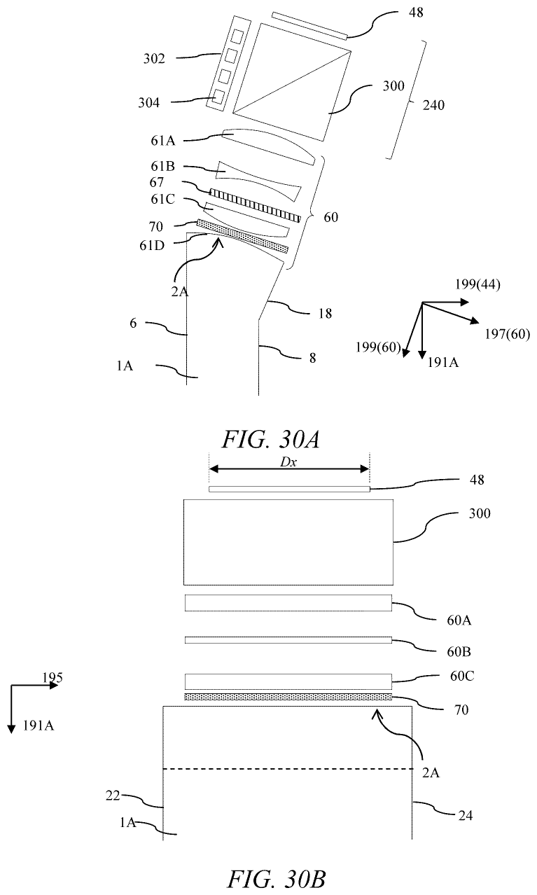

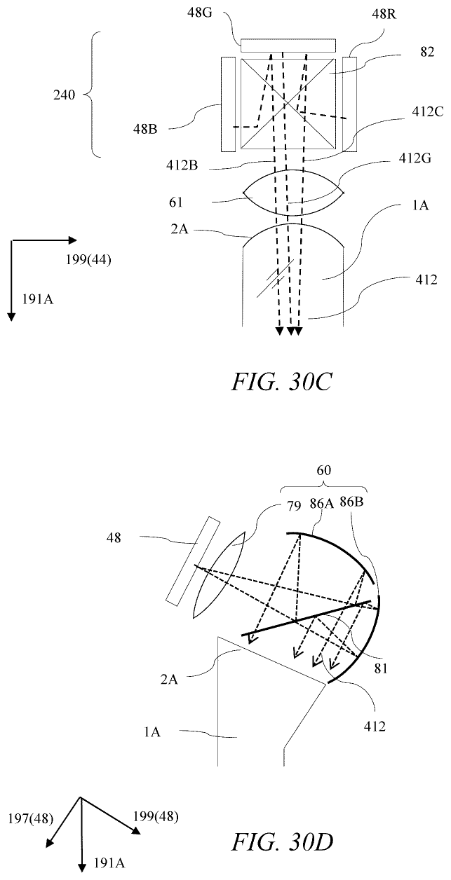

The Pancharatnam-Berry lens 386 comprises a circularly symmetric alignment of liquid crystal molecules with similar but different alignment across each radius of the circularly symmetric alignment to that illustrated across the lateral direction 195 in FIG. 30A hereinabove. The Pancharatnam-Berry lens 386 thus provides a circularly symmetric first phase radial profile similar to profile 358A of FIG. 30B for the light with polarisation state 383A and a circularly symmetric second phase radial profile similar to profile 358B of FIG. 30B for the light with polarisation state 383B. The output polarisation state from the Pancharatnam-Berry lens 386 is analysed by quarter wave retarder 387 and linear polariser 388.

Output light from the lens 290A with positive or negative power modification of the wavefront from the anamorphic near-eye display apparatus 100 is then incident onto the fixed lens 290B so that the eye 45 observes one of the two power corrections.

Considering the virtual image 34, in the absence of the lens 290A would provide a virtual image at distance Zᵥ. In the first state of the liquid crystal layer 384, the virtual image 334A is provided with a separation ΔZ_{A} from the distance Zᵥ; and in the second state of the liquid crystal layer 384, the virtual image 334B is provided with a separation ΔZ_{B} from the distance Zᵥ.

In alternative embodiments, the lens 290B may be provided by a Pancharatnam-Berry lens. Advantageously thickness may be reduced.

The lenses 290A, 290B thus achieve adjustable accommodation distances for virtual images 334A, 334B. Stacks of lenses 290A with for example a geometric sequence of optical power adjustments may be provided to achieve increased fidelity in location of the virtual image 334. Accommodation conflicts with the provided imagery may advantageously be reduced and image comfort increased. Comfortable usage time for the head-worn display apparatus 600 may be extended.

It may be desirable to provide a virtual image 34 that does not have an infinite conjugate while not modifying the real image 30 magnification or distance Z_{R}.

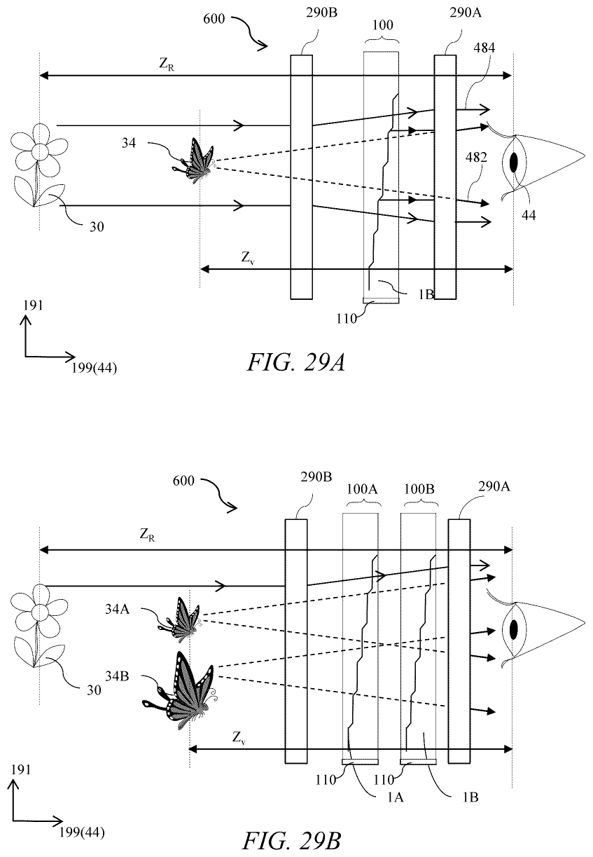

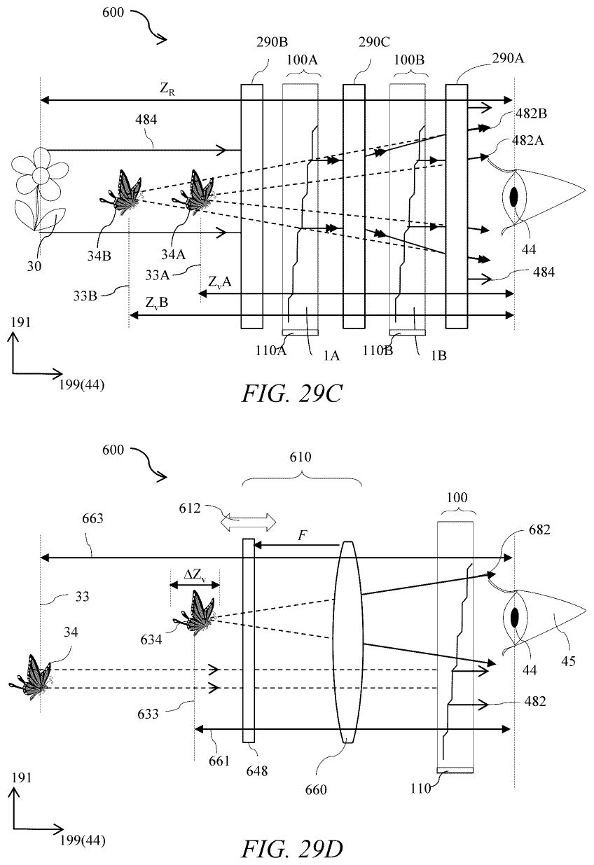

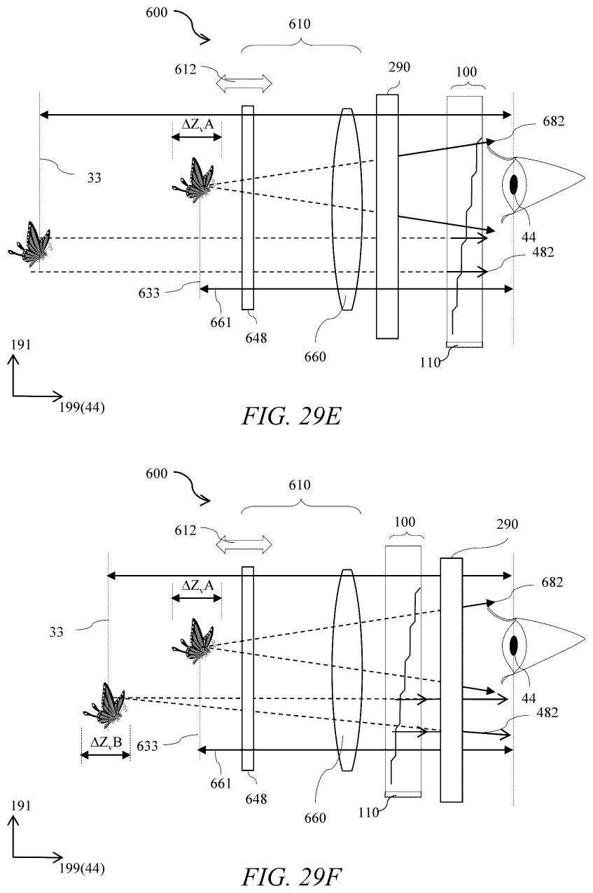

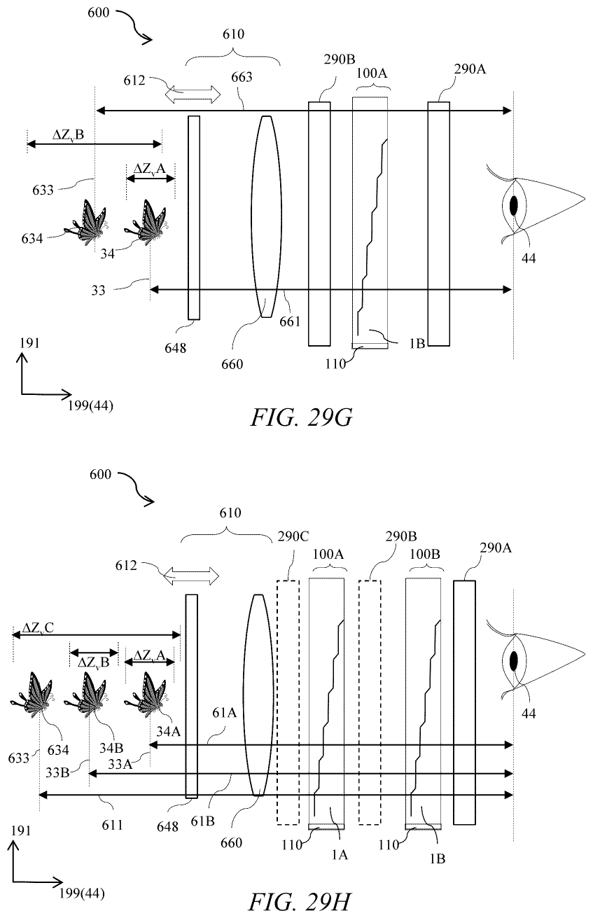

FIG. 29A is a schematic diagram illustrating in side view a head-worn display apparatus 600 comprising first and second focal plane modifying lenses 290A, 290B. Features of the embodiment of FIG. 29A not discussed in further detail may be assumed to correspond to the features with equivalent reference numerals as discussed above, including any potential variations in the features.

In the alternative embodiment of FIG. 29A, anamorphic near-eye display apparatus 100 is arranged between the focal plane modifying lenses 290A, 290B. The lens 290A is a focal plane modifying lens that is arranged to modify the distance Z, to the virtual image 34 by deflection of light rays 482 from the anamorphic near-eye display apparatus 100.

The lens 290B is a correction lens arranged to correct for the optical power of the lens 290A, so that light rays 484 from real images 30 are undeflected by the head-worn display apparatus 600. Advantageously virtual images 34 may be provided near to the eye, for example to provide a user interface and overlayed with real-world images, advantageously reducing the degradation of the real-world images 30.

The lenses 290A, 290B may be Pancharatnam-Berry lenses as described hereinabove, so that the distance Zv may be modified in correspondence to desired image data. The lenses 290A, 290B may have the same optical design and the lens 290B may be driven in the opposite output to the lens 290A to achieve resultant zero power of lenses 290A. 290B. Advantageously cost and complexity may be reduced.

FIG. 29B is a schematic diagram illustrating in side view a head-worn display apparatus 600 comprising plural extraction waveguides and further comprising first and second focal plane modifying lenses. Features of the embodiment of FIG. 29B not discussed in further detail may be assumed to correspond to the features with equivalent reference numerals as discussed above, including any potential variations in the features.

In the alternative embodiment of FIG. 29B, two anamorphic near-eye display apparatuses 100A, 100B are provided to achieve multiple virtual images 34A. 34B. The performance of the head-worn display apparatus may be increased, for example as described with respect to FIG. 16D hereinabove. Further, focal plane modifying lenses 290A. 290B are provided with operation as described in FIG. 29A. Advantageously real-world images 30 may be provided with reduced degradation.

It may be desirable to provide virtual images 34A. 34B with different focal distances ZᵥA, ZᵥB.

FIG. 29C is a schematic diagram illustrating in side view a head-worn display apparatus 600 comprising plural extraction waveguides and three focal plane modifying lenses 290A, 290B, 290C. Features of the embodiment of FIG. 29C not discussed in further detail may be assumed to correspond to the features with equivalent reference numerals as discussed above, including any potential variations in the features.

In comparison to the embodiment of FIG. 29B, in the alternative embodiment of FIG. 29C a further focal plane modifying lens 290C is provided to receive light from the anamorphic near-eye display apparatus 100A and to pass light to the further anamorphic near-eye display apparatus 100B. The virtual image distance ZᵥA for light from one of the anamorphic near-eye display apparatuses 100A is different to the virtual image distance ZᵥB for light from at least one other near-eye display apparatus 100B. The multiple focal planes 33A, 33B may advantageously achieve increased image comfort.

The lens 290C cooperates with the lens 290A to provide the second virtual image 34B, and the lens 290B cooperates with the lenses 290A, 290C to provide zero total optical power. In an alternative embodiment (not shown) the lens 290B may be omitted, for example for virtual reality applications. Advantageously cost and complexity may be reduced.

It may be desirable to increase the performance of a virtual reality head-worn display apparatus by providing increased control of focal planes 33, 633.

FIG. 29D is a schematic diagram illustrating in side view a head-worn display apparatus 600 comprising a non-anamorphic near-eye display apparatus 610 and an anamorphic near-eye display apparatus 100. Features of the embodiment of FIG. 29D not discussed in further detail may be assumed to correspond to the features with equivalent reference numerals as discussed above, including any potential variations in the features.

In comparison to the embodiment of FIG. 16F, in the alternative embodiment of FIG. 29D, the non-anamorphic near-eye display apparatus 610 comprises an actuator 612 arranged to move the further spatial light modulator 648 in relation to the non-anamorphic magnifying optical system 660, adjusting the magnification of the non-anamorphic near-eye display apparatus 100. The virtual image distance 663 for light from the anamorphic near-eye display apparatus 100 provided by rays 482 is different to the virtual image distance 661 for light from the non-anamorphic near-eye display apparatus 610 provided by rays 482. The distance F may be adjusted in correspondence to desired image data that may be in response to measured viewing direction of the eye 45.

Advantageously user comfort may be increased.

FIG. 29E is a schematic diagram illustrating in side view a head-worn display apparatus 600 comprising a non-anamorphic near-eye display apparatus 610; an anamorphic near-eye display apparatus 100; and a focal plane modifying lens 290. Features of the embodiment of FIG. 29E not discussed in further detail may be assumed to correspond to the features with equivalent reference numerals as discussed above, including any potential variations in the features.

In the alternative embodiment of FIG. 29D, an additional focal plane modifying lens 290 is provided between the non-anamorphic near-eye display apparatus 610 and the anamorphic near-eye display apparatus 100. The lens 290 may comprise a controllable Pancharatnam-Berry lens. The actuator 612 may optionally be omitted. The range of focal distances ΔZᵥA may be increased and the speed of control may be increased. User comfort may advantageously be increased.

FIG. 29F is a schematic diagram illustrating in side view a head-worn display apparatus comprising a non-anamorphic near-eye display apparatus 610; an anamorphic near-eye display apparatus 100; and a focal plane modifying lens 290 arranged to receive light from the non-anamorphic near-eye display apparatus and the anamorphic near-eye display apparatus. Features of the embodiment of FIG. 29F not discussed in further detail may be assumed to correspond to the features with equivalent reference numerals as discussed above, including any potential variations in the features.

In the alternative embodiment of FIG. 29F, the focal plane modifying lens 290 is arranged to provide finite virtual image distances 33, 633. Further, the focal plane modifying lens 290 may be controllable to achieve variable focal plane distances ΔZᵥA, ΔZᵥB from the displays 610, 100 respectively. User comfort may advantageously be increased.

FIG. 29G is a schematic diagram illustrating in side view a head-worn display apparatus 600 comprising a non-anamorphic near-eye display apparatus 610; an anamorphic near-eye display apparatus 100; and two focal plane modifying lenses 290A, 290B. Features of the embodiment of FIG. 29F not discussed in further detail may be assumed to correspond to the features with equivalent reference numerals as discussed above, including any potential variations in the features.

In comparison to the embodiments of FIGS. 29E-32F, in the alternative embodiment of FIG. 29G, focal plane modifying lenses 290A, 290B are arranged with the anamorphic near-eye display apparatus 100 provided therebetween. Focal plane control of both virtual images 33, 633 may be provided. Advantageously user comfort may be further increased.

FIG. 29H is a schematic diagram illustrating in top view a head-worn display apparatus 600 comprising a non-anamorphic near-eye display apparatus 610; two anamorphic extraction waveguides 1100A, 100B; and focal plane modifying lenses 290A, 290B, 290C. Features of the embodiment of FIG. 29G not discussed in further detail may be assumed to correspond to the features with equivalent reference numerals as discussed above, including any potential variations in the features.

In the alternative embodiment of FIG. 29H, multiple images 33A, 33B, 634 may be provided with multiple focal ranges ΔZᵥA, ΔZᵥB, ΔZᵥC that may overlap. Focal plane control of virtual images 33A, 33B, 633 may be provided. Advantageously user comfort may be further increased.

Alternative arrangements of illumination systems and transverse anamorphic components 60 will now be described.

FIG. 30A is a schematic diagram illustrating in top view a detail of an arrangement of a transverse lens 61 that forms a transverse anamorphic component 60; and FIG. 30B is a schematic diagram illustrating in side view a detail of the arrangement of the transverse lens 61 of FIG. 30A. Features of the embodiment of FIGS. 30A-B not discussed in further detail may be assumed to correspond to the features with equivalent reference numerals as discussed above, including any potential variations in the features.

In the alternative embodiment of FIG. 30A, the transverse lens 61 forming the transverse anamorphic component 60 comprises a compound lens 61A-C. Further the compound lens may comprise a lens 61D comprising the curved input face 2A of the input waveguide 1A. FIG. 30B illustrates that the illumination system 240 and transverse anamorphic component 60 do not provide optical power in the lateral direction 195, that is the compound lenses 61A-D are cylindrical or elongate with a non-spherical surface profile, for example aspheric such as illustrated by the shapes of lenses 61A-B to achieve improved field aberrations and advantageously increased MTF at higher field angles.

Advantageously aberrations in the transverse direction 197(60) may be improved.

Further, the illumination system may comprise a reflective spatial light modulator 48, an illumination array 302 comprising light sources 304 and a beam combiner cube arranged to illuminate the spatial light modulator 48. The illumination array 302 may comprise different coloured light sources so that the spatial light modulator 48 may provide time sequential colour illumination.

FIG. 30A further illustrates that the transverse anamorphic component 60 may comprise a transverse diffractive component 67 that is provided with optical power in the transverse direction 197. The component 67 may have chromatic aberrations that are angularly varying so as to correct for chromatic aberrations from the refractive components 60A-D in the transverse direction 197. Colour blurring in the transverse direction 197 may advantageously be reduced.

FIG. 30C is a schematic diagram illustrating in top view a spatial light modulator arrangement 50 for use in the anamorphic near-eye display apparatus 100 of FIG. 1 comprising separate red, green and blue spatial light modulators 48R, 48G, 48B and a beam combining element 82. Features of the embodiment of FIG. 30C not discussed in further detail may be assumed to correspond to the features with equivalent reference numerals as discussed above, including any potential variations in the features.

The alternative embodiment of FIG. 30C illustrates that the illumination system 240 may comprise red, green and blue spatial light modulators 48R, 48G, 48B and a colour combining prism arrange to direct light rays 412R, 412G, 412B towards the transverse anamorphic component 60. Such an arrangement may be used to provide high resolution colour imagery from emissive spatial light modulators 48 for example. Emissive displays may be OLED on silicon or microLED on silicon spatial light modulators 48 for example. Advantageously high resolution colour virtual images may be provided.

FIG. 30D is a schematic diagram illustrating in top view an illumination system 240 and transverse anamorphic component 60 for use in the anamorphic near-eye display apparatus 100 of FIG. 1A comprising a birdbath folded arrangement. Features of the embodiment of FIG. 15B not discussed in further detail may be assumed to correspond to the features with equivalent reference numerals as discussed above, including any potential variations in the features.

In the alternative embodiment of FIG. 30D, the spatial light modulator 48 illuminates a catadioptric illumination system 240 comprising input lens 79, curved mirror 86A and partially reflective mirror 81 such that rays 412 are directed into the input face 2A of the input waveguide 1A. Advantageously chromatic aberrations in the transverse direction 197 may be reduced. The partially reflective mirror 81 may be a polarising beam splitter or may be a thin metallised layer for example.

Additionally or alternatively curved mirror 86B may be provided to increase efficiency of operation.

Alternative arrangements of transverse anamorphic component 60 comprising input reflectors 62 will now be described.

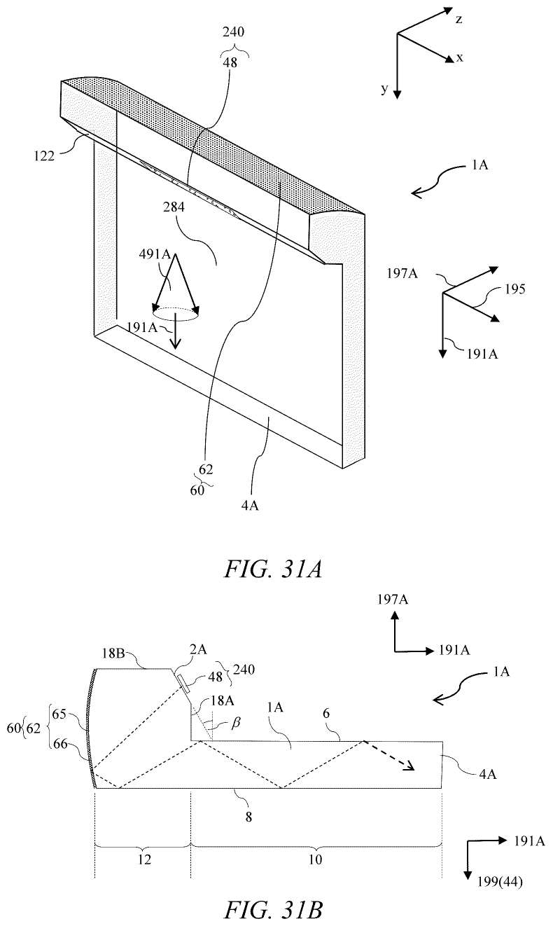

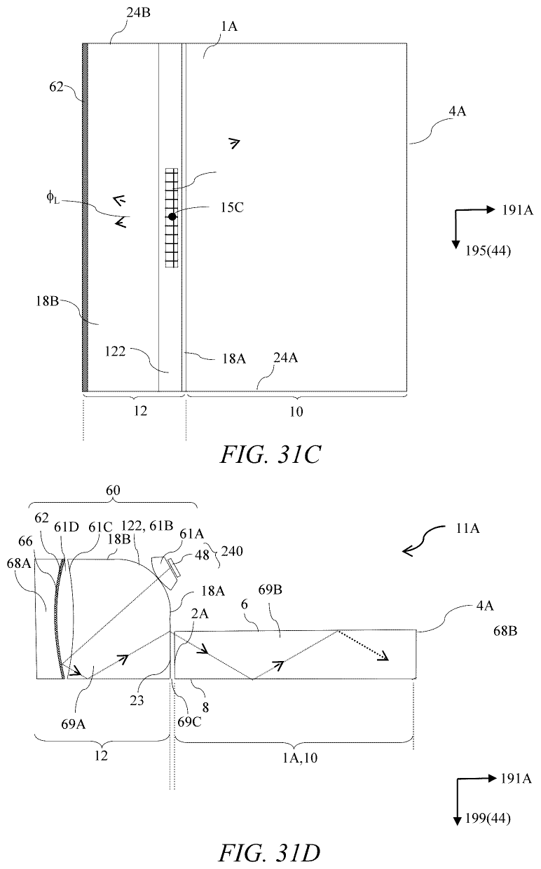

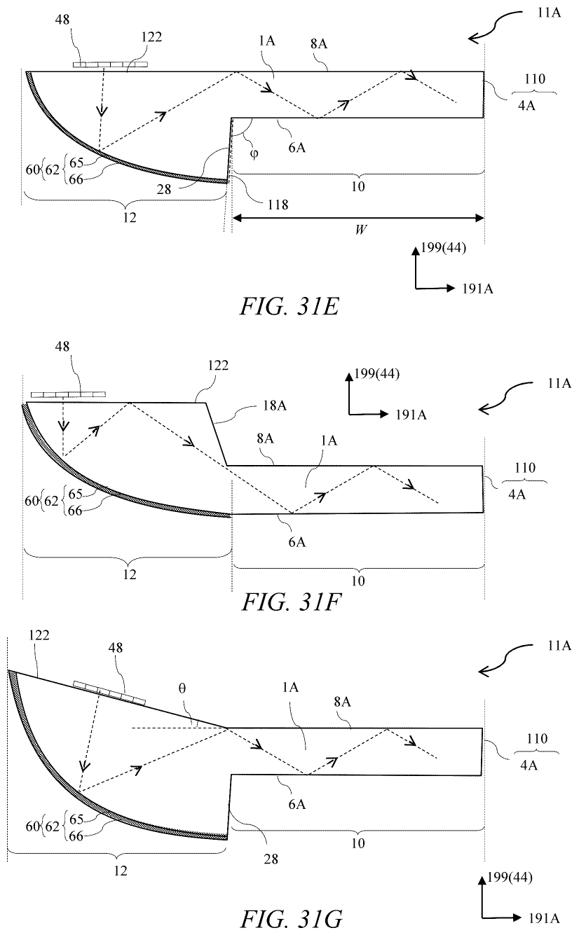

FIG. 31A is a schematic diagram illustrating a front perspective view of an input waveguide 1A comprising an input reflector 62; FIG. 31B is a schematic diagram illustrating a top view of the input waveguide 1A of FIG. 31A; and FIG. 31C is a schematic diagram illustrating a front view of the input waveguide 1A of FIG. 31A. Features of the embodiment of FIGS. 31A-C not discussed in further detail may be assumed to correspond to the features with equivalent reference numerals as discussed above, including any potential variations in the features.

In comparison to FIG. 1, in the alternative embodiment of FIGS. 31A-C, the optical system 250 comprises an input section 12 comprising an input reflector 62 that is the transverse anamorphic component 60 and is arranged to reflect the light from the illumination system 240 and direct it along the input waveguide 1A. The input section 12 further comprises an input face 122 disposed on a front or rear side 8, 6 of the input waveguide 1A and facing the input reflector 62, and the input section 12 is arranged to receive the light from the illumination system 240 through the input face 122 wherein the input face 122 is disposed outwardly of one of the front or rear guide surfaces 8, 6 and the input section 12 is integral with the input waveguide 1A. The input section 12 further comprises a separation face 28 extending outwardly from the one of the front or rear guide surface 8, 6 to the input face 122. Extraction features in extraction region 284 may be of the types as illustrated elsewhere herein.

The embodiment of FIGS. 31A-G may be fabricated using a moulding process and reflective material 66 formed on curved surface 65 to provide the input reflector, for example by sputtering, evaporation or other known coating methods. Alternatively the reflective material 66 may comprise a reflective film such as ESR™ from 3M Corporation. Advantageously the cost and complexity of fabrication may be reduced.

It may be desirable to provide further control of optical aberrations in the transverse direction 197.

FIG. 31D is a schematic diagram illustrating a top view of an alternative an input waveguide assembly 11A comprising alternative input reflector 62 and lens 61. Features of the embodiment of FIG. 31D not discussed in further detail may be assumed to correspond to the features with equivalent reference numerals as discussed above, including any potential variations in the features.

In the alternative embodiment of FIG. 31D, the input waveguide 1A has an input face 2A that is an input face through which the input waveguide 1A is arranged to receive light from the illumination system 240, and the input section 12 is a separate element from the input waveguide 1A that further comprises an output face 23 and is arranged to direct light reflected by the input reflector 62 through the output face 23 and thereafter into the mirror waveguide 1D of FIG. 1A for example.

The transverse anamorphic component 60 further comprises a lens 61 wherein the lens 61 of the transverse anamorphic component 60 is a compound lens 61. Lens 61 may comprise a refractive element 61A. Further lens 61 may comprise a lens 61B comprising the curved input face 2A of the input waveguide 1A. Further lens 61 may comprise a curved surface 61C and a material 61D that may be air or a material with a different refractive index to the refractive index of the extraction waveguide 1B material. The lenses 61A-D may be arranged to reduce the aberrations of the input reflector 62 of FIGS. 1A-D. The transverse anamorphic component 60 is thus a catadioptric optical element comprising refractive and reflective optical functions. Advantageously the fidelity of the image may be improved in the transverse direction.

FIG. 31D further illustrates an alternative embodiment wherein the input reflector 62 is arranged on the surface of a member 68A. The surface of the input reflector 62 may advantageously be further protected. FIG. 31D further illustrates an alternative embodiment wherein the lateral anamorphic component 110 is a reflector arranged on the surface of a member 68B. The coatings 66, 67 may be formed on the members 68A, 68B respectively. Higher temperature processing conditions may be achieved than for coating of polymer waveguides 1. Advantageously cost may be reduced and efficiency of operation increased.

In the alternative embodiment of FIG. 31D, the input section 12 is not integral with the input waveguide 1A. The input waveguide 1A has an end that is an input face 2A through which the input waveguide 1A is arranged to receive light from the illumination system 240, and the input section 12 is a separate element from the input waveguide 1A that further comprises an output face 23 and is arranged to direct light reflected by the input reflector 62 through the output face 23 and into the input waveguide 1A through the input face 2A of the input waveguide 1A. Further, the transverse anamorphic component 60 is disposed outside the input waveguide 1A, and the input waveguide 1A is arranged to receive light 400 from the transverse anamorphic component 60 through the input face 2. In other words, FIG. 31D further illustrates an alternative embodiment wherein the input section 12 and the guide section 10 of the input waveguide 1A are formed by separate members 69A, 69B respectively and aligned across gap 69C which may comprise air or a bonding material such as an adhesive. The members 69A, 69B may be formed separately during manufacture, reducing complexity of processing of the input waveguide 1A surfaces and advantageously increasing yield.

It may be desirable to increased size of spatial light modulator 48 in the transverse direction.

FIGS. 31E-G are schematic diagrams illustrating in top views alternative embodiments of anamorphic near-eye display apparatus 100 comprising an input reflector 62. Features of the embodiments of FIGS. 31E-G not discussed in further detail may be assumed to correspond to the features with equivalent reference numerals as discussed above, including any potential variations in the features.

In the alternative embodiment of FIGS. 31E-F input face 122 extends parallel to the front guide surface 8A in the case that the input face 122 is on the front side of the input waveguide 1A or to the rear guide surface 6A in the case that the input face 122 is on the rear side of the input waveguide 1A. FIG. 31E comprises input face 122 that is coplanar with the front guide surface 8 in the case that the input face 122 is on the front side of the input waveguide 1A or with the rear guide surface 6 in the case that the input face 122 is on the rear side of the input waveguide 1A. Advantageously the spatial light modulator 48 may be provided on a drive board of a larger size.

In the alternative embodiment of FIG. 31F input face 122 is offset and parallel with the front guide surface 8 in the case that the input face 122 is on the front side of the input waveguide 1A or with the rear guide surface 6 in the case that the input face 122 is on the rear side of the input waveguide 1A. Advantageously the spatial light modulator 48 may be provided within or near to the arms 604 of the head-wear 600.

In the alternative embodiment of FIG. 31G, the input face 122 extends at an acute angle θ to the front guide surface 8 in the case that the input face 122 is on the front side of the input waveguide 1A or to the rear guide surface 6 in the case that the input face 122 is on the rear side of the input waveguide 1A. Advantageously a more convenient mechanical arrangement may be provided.

FIG. 32A is a schematic diagram illustrating in perspective front view an alternative arrangement of an input focusing lens 61. Features of the embodiment of FIG. 32A not discussed in further detail may be assumed to correspond to the features with equivalent reference numerals as discussed above, including any potential variations in the features.

Spatial light modulator 48 comprises active area 49A and border 49B and is aligned to the lens of the transverse anamorphic component 60 that is a compound lens comprising lenses 60A-F. Some of the lenses 60A-F may comprise surfaces that have a constant radius and some may comprise variable radius surfaces such that in combination aberration correction is advantageously improved.

Alternative arrangements of spatial light modulator 48, illumination system 240 and optical system 250 will now be described.

FIG. 32B is a schematic diagram illustrating in top view a spatial light modulator arrangement for use in the anamorphic near-eye display apparatus of FIG. 1 comprising a spatial light modulator 48 comprising a laser 50, a scanning arrangement 51 and a light diffusing screen 52. Features of the embodiment of FIG. 32B not discussed in further detail may be assumed to correspond to the features with equivalent reference numerals as discussed above, including any potential variations in the features.

In the alternative embodiment of FIG. 32B, the spatial light modulator 48 comprises the laser 50 arranged to direct a beam 490 towards scanning arrangement 51 that may be a rotating mirror for example, with oscillation 53 that is synchronised to the image data.

The beam 490 is arranged to illuminate a screen 52 to provide a diffuse light source 55 at the screen. The screen 52 may comprise a diffusing arrangement so that the transmitted light is diffused into light cone 491A arranged to provide input light rays 492 into the transverse anamorphic component 60 and input waveguide 1A.

The screen 52 may alternatively comprise a photoemission layer such as a phosphor laser at which the laser beam 490 is arranged to produce emission from the photoemission layer. The output colour can advantageously be independent of the laser 50 emission wavelength. Further laser speckle may be reduced.

The laser 50 may comprise a one dimensional array of laser emitting pixels 222 across a row 221T and the scanning arrangement 51 may provide one dimensional array of light sources 55 at the screen 52 for each addressable row of the spatial light modulator 48. The scanning speed of the scanning arrangement 51 is reduced, advantageously achieving reduced cost and complexity.

Alternatively the laser 50 may comprise a single laser emitter and the scanning arrangement 51 may provide two dimensional scanning of the beam 490 to achieve a two dimensional pixel array of emitters 55 at the screen 52. Advantageously laser 50 cost may be reduced.

Further arrangements comprising laser sources will now be described.

FIG. 33A is a schematic diagram illustrating in top view input to the input waveguide 1A comprising a spatial light modulator 48 comprising laser sources and a scanning arrangement 51; FIG. 33B is a schematic diagram illustrating in front view a spatial light modulator 48 comprising a row of laser light sources 172 for use in the arrangement of FIG. 33A; and FIG. 33C is a schematic diagram illustrating an alternative illumination arrangement. Features of the embodiment of FIGS. 33A-C not discussed in further detail may be assumed to correspond to the features with equivalent reference numerals as discussed above, including any potential variations in the features.

The alternative embodiment of FIG. 33A comprises a transverse anamorphic component 60 that is formed by a deflector element 50 that comprises scanning mirror 51.

FIG. 33B illustrates a spatial light modulator 48 suitable for use in the arrangement of FIG. 33A comprising a one dimensional array of pixels 222A-N wherein the pixels 222A-N each comprise a laser source. Control system 500 is arranged to supply line-at-a-time image data to spatial light modulator 48 controller 505 that outputs pixels data to laser pixels 222A-N by means of driver 509; and location data to scanning arrangement 51 by means of scanner driver 511. The laser pixels 222A-N are arranged in a single row with pitch P_{L} in the lateral direction 195 that is the same as illustrated in FIG. 2D for example.

Returning to the description of FIG. 33A, in operation, image data for a first addressed row of image data are applied to the laser pixels 222A-N and the scanning arrangement 51 adjusted so that the laser light from the spatial light modulator 48 is directed as ray 490A in a first direction across the transverse direction 197. At a different time, image data for a different addressed row of image data are applied to the laser pixels 222A-N and the scanning arrangement 51 adjusted so that the laser light from the spatial light modulator 48 is directed as ray 490B in a different direction across the transverse direction 197. The transverse anamorphic component 60 is thus arranged to receive light from the spatial light modulator 48 and the illumination system 240 is arranged so that light output from the transverse anamorphic component 60 is directed in directions illustrated by rays 490A, 490B that are distributed in the transverse direction with cone 491A.

In other words, the scanning arrangement 51 scans about the lateral direction 197(60) and serves to provide illustrative light rays 490A, 490B sequentially. By means of sequential scanning, the scanning arrangement 51 effectively has positive optical power in the transverse direction 197(60) for light from the spatial light modulator 48, achieving output cone 491A in a sequential manner. In this manner, the scanning arrangement 51 directs light in directions that are distributed in the transverse direction, allowing it to serve as a transverse anamorphic component 60. The scanning of the scanning arrangement 51 may be arranged not to direct light near to parallel to the direction 191A along the input waveguide 1A. Advantageously double imaging is reduced.

Advantageously the cost and complexity of the illumination system 240 and transverse anamorphic component 60 may be reduced.

The alternative embodiment of FIG. 33C provides beam expander 61A, 61B that increases the width 63 of the output beam from the illumination system 240. In FIG. 33C, the illumination system 240 further comprises a deflector element 50 arranged to deflect light output from the transverse anamorphic component 60 by a selectable amount, the deflector element 50 being selectively operable to direct the light output from the transverse anamorphic component 60 in the directions that are distributed in the transverse direction 197. Advantageously uniformity of the output image from across the exit pupil 40 is provided.

The illumination system 240 and optical system 250 of the embodiments hereinabove may be provided for directional illumination devices for illumination of external scenes.

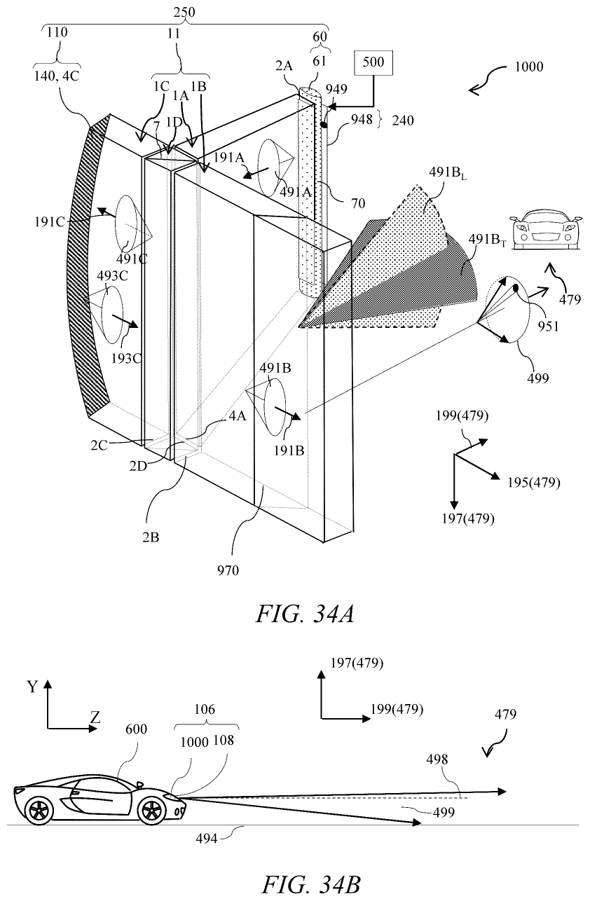

FIG. 34A is a schematic diagram illustrating a front perspective view an anamorphic directional illumination device 1000 arranged to illuminate an external scene 479. Features of the embodiment of FIG. 34A not discussed in further detail may be assumed to correspond to the features with equivalent reference numerals as discussed above, including any potential variations in the features.

The alternative embodiment of FIG. 34A illustrates an anamorphic directional illumination device 1000 that comprises an illumination system 240 comprising a light source array 948, the illumination system being arranged to output light. Light source array 948 may for example comprise an array of light emitting diodes, or may be provided by a spatial light modulator 48 as described elsewhere herein.

Optical system 250 is arranged to direct light from the illumination system 240. The light in light cone 499 may be directed towards an externally illuminated scene 479. Illuminated scenes 479 may include but are not limited to roads, rooms, external spaces, processing equipment, metrology environments, theatrical stages, human bodies such as for face illumination for face detection and measurement purposes.

The optical system 250 has an optical axis 199 and has anamorphic properties in a lateral direction 195 and a transverse direction 197 that are perpendicular to each other and perpendicular to the optical axis 199, wherein the light source array 948 comprises light sources 949a-n distributed in the lateral direction 195, and which may further be distributed in the transverse direction 197 as described elsewhere herein.

The optical system 250 further comprises a transverse anamorphic component 60 having positive optical power in the transverse direction 197, wherein the transverse anamorphic component 60 is arranged to receive light from the light source array 948 and the illumination system 250 is arranged so that light output from the transverse anamorphic component 60 is directed in directions that are distributed in the transverse direction 197.

The optical system 250 further comprises an input waveguide 1A arranged to receive light cone 491A from the transverse anamorphic component 60; and a partially reflective mirror 7. The input waveguide 1A is arranged to guide light cone 491A from the transverse anamorphic component 60 to the partially reflective mirror 7 along the input waveguide 1A, and the partially reflective mirror 7 is arranged to reflect at least some of that light to light cone 491C.

Intermediate waveguide 1C is arranged to receive at least some of the light cone 491C reflected by the partially reflective mirror 7. Lateral anamorphic component 110 has positive optical power in the lateral direction 195 and the intermediate waveguide is arranged to guide the light cone 491C received from the partially reflective mirror 7 to the lateral anamorphic component 110 along the intermediate waveguide 1C in a first direction 191C.

Light reversing reflector 140 that is arranged to reflect light cone 491C that has been guided along the intermediate waveguide 1C in the first direction 191C so that the reflected light cone 493C is guided along the intermediate waveguide 1C in a second direction 193 opposite to the first direction 191 to the partially reflective mirror 7, the partially reflective mirror being arranged to transmit at least some of that light into the extraction waveguide 1B that is arranged to receive at least some of the light as light cone 491B transmitted by the partially reflective mirror 7 that has been guided in the second direction 193C along the intermediate waveguide 1C.

The extraction waveguide 1 comprises at least one reflective extraction feature 970, the at least one reflective extraction feature 970 being arranged to transmit light guided cone 491B along the extraction waveguide 1B in the first direction 191B and to extract light cone 491B guided along the extraction waveguide 1B to provide output light cone 499 directed towards the illuminated scene 479.

The anamorphic directional illumination device 1000 of FIG. 29A may comprise various embodiments arranged to improve efficiency, aberrations and image quality as described elsewhere herein.

By way of comparison with the anamorphic near-eye display apparatuses 100 described hereinabove, the output light from the directional illumination device 1000 is provided as illumination cones 951a-n for illumination of a scene 479 compared to the angular pixel information for illumination of pupil 44 and retina 46. High resolution imaging of illuminated scenes 479 may be achieved with high efficiency and low cost in a compact package.

The light sources 949 may output light that is visible light or infra-red light. Advantageously directional illumination of scenes 479 may be provided for visible illumination or illumination of scenes for other detectors such as LIDAR detectors. The light sources 949 may have different spectral outputs. The different spectral outputs include: a white light spectrum, plural different white light spectra, red light, orange light, and/or infra-red light. A visible illumination may be provided and a further illumination for detection purposes may also be provided, which may have different illumination structures to achieve improved signal to noise of detection.

In an alternative embodiment, the scene 479 may comprise a projection screen and the anamorphic directional illumination device 1000 may provide projection of images onto the projection screen. Advantageously a lightweight and portable image projector with high efficiency may be provided in a thin package.

The reflective extraction feature 970 of FIG. 29A may alternatively be provided by an array of light extraction features 970a-n. Advantageously the aesthetic appearance of the directional illumination appearance may be modified. Alternatively the reflective extraction feature 970 may be provided by at least one of reflective extraction feature 169 as described elsewhere hereinabove and may comprise at least one feature such as, but not limited to, extraction reflectors 170, 172, 174 and diffractive extraction features 112B. Alternative embodiments of light source array 948 may be provided by embodiments of spatial light modulator 48 as described hereinabove, for example in FIGS. 2A-D. FIG. 32B and FIGS. 33A-C. The transverse anamorphic component 60 may alternatively be as illustrated with reference to FIG. 3A, FIGS. 30A-D and FIGS. 31A-G for example. The lateral anamorphic component 110 may alternatively comprise the arrangements illustrated with reference to FIGS. 25A-D and FIGS. 27A-I for example. Field curvature may be improved by the arrangements such as FIGS. 26A-E for example. The features mentioned above may be provided in isolation or in combination.

Alternative embodiments of waveguide 1 arrangements, transverse anamorphic component 60 arrangements, lateral anamorphic component 110 arrangements and extraction feature 970 arrangements may be provided as described elsewhere hereinabove.

FIG. 34B is a schematic diagram illustrating a side view of a road scene 479 comprising a vehicle 600 comprising a vehicle external light apparatus 106 comprising the anamorphic directional illumination device 1000 of FIG. 34B not discussed in further detail may be assumed to correspond to the features with equivalent reference numerals as discussed above, including any potential variations in the features.

The alternative embodiment of FIG. 34B illustrates a vehicle external light apparatus 106 comprising an anamorphic directional illumination device 1000 such as illustrated in FIG. 34A that is a vehicle external light device mounted on a housing 108 for fitting to a vehicle 600. The vehicle external light apparatus 106 is arranged to illuminate an external scene 479 such as a road environment. The vehicle external light apparatus 106 provides output light cone 499 so that the horizon 499 and road surface 494 may be illuminated. In the example of FIG. 34B the cross section of light cone 499 is distributed across the transverse direction 197. In alternative embodiments the cross section of light cone 499 may be distributed across the lateral direction 195.

The light source array 948 may be controlled by controller 500 in response to the location of objects such as other drivers or road hazards in the illuminated scene 479. The light cone 499 may be arranged to illuminate a two dimensional array of light cones 951 corresponding to respective light sources 949. The light sources 949a-n may be individually or collectively controllable so that some parts of the scene 479 are illuminated and other parts are not illuminated or illuminated with different illuminance. Advantageously glare to other drivers may be reduced while providing increased levels of illuminance of the road scene 479.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

1. An anamorphic near-eye display apparatus comprising:
an illumination system comprising a spatial light modulator, the illumination system being arranged to output light; and
an optical system arranged to direct light from the illumination system to a viewer's eye, wherein the optical system has an optical axis and has anamorphic properties in a lateral direction and a transverse direction that are perpendicular to each other and perpendicular to the optical axis, wherein the spatial light modulator comprises pixels distributed in the lateral direction, and the optical system comprises:
a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction;
an input waveguide arranged to receive light from the transverse anamorphic component;
a partially reflective mirror, the input waveguide being arranged to guide light from the transverse anamorphic component to the partially reflective mirror along the input waveguide, and the partially reflective mirror being arranged to reflect at least some of that light;
an intermediate waveguide arranged to receive at least some of the light reflected by the partially reflective mirror,
a lateral anamorphic component having positive optical power in the lateral direction, the intermediate waveguide being arranged to guide the light received from the partially reflective mirror to the lateral anamorphic component along the intermediate waveguide in a first direction;
a light reversing reflector that is arranged to reflect light that has been guided along the intermediate waveguide in the first direction so that the reflected light is guided along the intermediate waveguide in a second direction opposite to the first direction to the partially reflective mirror, the partially reflective mirror being arranged to transmit at least some of that light; and
an extraction waveguide arranged to receive at least some of the light transmitted by the partially reflective mirror that has been guided in the second direction along the intermediate waveguide,
wherein the extraction waveguide comprises an array of reflective extraction features, the reflective extraction features being arranged to extract light guided along the extraction waveguide towards an eye of a viewer, the array of reflective extraction features being distributed along the extraction waveguide so as to provide exit pupil expansion.

2. An anamorphic near-eye display apparatus according to claim 1, wherein the reflective extraction features are disposed internally within the extraction waveguide.

3. An anamorphic near-eye display apparatus according to claim 1, wherein the reflective extraction features comprise extraction reflectors that extend across at least part of the extraction waveguide between front and rear guide surfaces of the extraction waveguide.

4. An anamorphic near-eye display apparatus according to claim 3, wherein the array of reflective extraction reflectors have reflectivities defined across their overall area that increase with increasing distance along the second direction.

5. An anamorphic near-eye display apparatus according to claim 3, wherein the extraction reflectors comprise extraction surfaces spaced apart by a partially reflective coating.

6. An anamorphic near-eye display apparatus according to claim 5, wherein the partially reflective coating comprises at least one dielectric layer.

7. An anamorphic near-eye display apparatus according to claim 6, wherein the at least one dielectric layer comprises a stack of dielectric layers.

8. An anamorphic near-eye display apparatus according to claim 5, wherein the partially reflective coating is metallic.

9. An anamorphic near-eye display apparatus according to claim 3, wherein the extraction reflectors comprise extraction surfaces spaced apart by a gap.

10. An anamorphic near-eye display apparatus according to claim 9, wherein the extraction surfaces have an anti-reflection coating.

11. An anamorphic near-eye display apparatus according to claim 3, wherein the extraction reflectors extend partially across the extraction waveguide between the front and rear guide surfaces of the extraction waveguide with successively shifted positions.

12. An anamorphic near-eye display apparatus according to claim 11, wherein the extraction reflectors extend to the front and rear guide surfaces of the extraction waveguide.

13. An anamorphic near-eye display apparatus according to claim 12, wherein the extraction reflectors do not extend to the front and rear guide surfaces of the extraction waveguide.

14. An anamorphic near-eye display apparatus according to claim 11, further comprising intermediate reflectors extending along the extraction waveguide between adjacent pairs of extraction reflectors.

15. An anamorphic near-eye display apparatus according to claim 14, wherein the intermediate reflectors comprise intermediate surfaces spaced apart by a partially reflective coating.

16. An anamorphic near-eye display apparatus according to claim 15, wherein the partially reflective coating comprises at least one dielectric layer.

17. An anamorphic near-eye display apparatus according to claim 16, wherein the at least one dielectric layer comprises a stack of dielectric layers.

18. An anamorphic near-eye display apparatus according to claim 15, wherein the partially reflective coating is metallic.

19. An anamorphic near-eye display apparatus according to claim 14, wherein the intermediate reflectors comprise intermediate surfaces spaced apart by a gap.

20. An anamorphic near-eye display apparatus according to claim 19, wherein the intermediate surfaces have an anti-reflection coating.

21. An anamorphic near-eye display apparatus according to claim 11, wherein the extraction waveguide comprises plural constituent parts having facing stepped surfaces attached together, the stepped surfaces being shaped with alternating extraction surfaces extending in the transverse direction and intermediate surfaces extending along the extraction waveguide, wherein the extraction reflectors comprise the facing extraction surfaces.

22. An anamorphic near-eye display apparatus according to claim 21, wherein the intermediate surfaces are optically coupled together.

23. An anamorphic near-eye display apparatus according to claim 11, wherein the extraction reflectors comprise plural sets of extraction reflectors, wherein, within each set of extraction reflectors, in the transverse direction the extraction reflectors extend partially across the extraction waveguide with successively shifted positions, the extraction reflectors of different sets overlapping in extent in the transverse direction.

24. An anamorphic near-eye display apparatus according to claim 3, wherein at least part of the extraction waveguide comprises plural constituent plates optically coupled together, and wherein the extraction reflectors are formed between the constituent plates.

25. An anamorphic near-eye display apparatus according to claim 3, wherein the extraction reflectors extend between the front and rear guide surfaces of the extraction waveguide.

26. An anamorphic near-eye display apparatus according to claim 3, wherein the extraction reflectors have the same reflective area.

27. An anamorphic near-eye display apparatus according to claim 3, wherein the extraction reflectors are patterned to have different reflective areas providing reflectivities defined across their overall area that increase with increasing distance along the optical axis.

28. An anamorphic near-eye display apparatus according to claim 3, wherein the extraction reflectors have a surface normal direction that is inclined with respect to the direction along the extraction waveguide by an angle in the range 20 to 40 degrees.

29. An anamorphic near-eye display apparatus according to claim 1, wherein the extraction waveguide comprises a transmissive element and a diffractive optical element optically coupled together, wherein the reflective extraction features comprise portions of the diffractive optical element.

30. An anamorphic near-eye display apparatus according to claim 29, wherein the diffractive optical element is a volume hologram.

31. An anamorphic near-eye display apparatus according to claim 1, wherein front and rear guide surfaces of the extraction waveguide have an anti-reflection coating.

32. An anamorphic near-eye display apparatus according to claim 1, wherein the extraction waveguide has a front guide surface and a rear guide surface, and the rear guide surface comprises extraction facets that are the reflective extraction features.

33. An anamorphic near-eye display apparatus according to claim 1, wherein the light reversing reflector is a reflective end of the intermediate waveguide.

34. An anamorphic near-eye display apparatus according to claim 1, wherein the lateral anamorphic component comprises the light reversing reflector.

35. An anamorphic near-eye display apparatus according to claim 1, wherein the optical system further comprises:
an input linear polariser disposed between the spatial light modulator and the partially reflective mirror; and
a polarisation conversion retarder disposed between the partially reflective mirror and the light reversing reflector, the polarisation conversion retarder being arranged to convert a polarisation state of light passing therethrough between a linear polarisation state and a circular polarisation state.

36. An anamorphic near-eye display apparatus according to claim 35, wherein the polarisation conversion retarder has a retardance of a quarter wavelength at a wavelength of visible light.

37. An anamorphic near-eye display apparatus according to claim 1, further comprising:
a polarisation conversion retarder disposed between the partially reflective mirror and the extraction waveguide, the polarisation conversion retarder being arranged to convert a polarisation state of light passing therethrough between a linear polarisation state and an orthogonal linear polarisation state.

38. An anamorphic near-eye display apparatus according to claim 37, wherein the further polarisation conversion retarder has a retardance of a half wavelength at a wavelength of visible light.

39. An anamorphic near-eye display apparatus according to claim 35, wherein the input linear polariser is arranged to pass light that is in an s-polarisation state in the extraction waveguide.

40. An anamorphic near-eye display apparatus according to claim 1, wherein the lateral anamorphic component comprises a lens.

41. An anamorphic near-eye display apparatus according to claim 1, wherein the input waveguide and the intermediate waveguide comprise no extraction features that are arranged to extract light guided therealong.

42. An anamorphic near-eye display apparatus according to claim 1, wherein the optical system comprises an input section comprising an input reflector that is the transverse anamorphic component and is arranged to reflect the light from the illumination system and direct it along the input waveguide.

43. An anamorphic near-eye display apparatus according to claim 42, wherein the transverse anamorphic component further comprises a lens.

44. An anamorphic near-eye display apparatus according to claim 42, wherein the input section further comprises an input face disposed on a front or rear side of the input waveguide and facing the input reflector, and the input section is arranged to receive the light from the illumination system through the input face.

45. An anamorphic near-eye display apparatus according to claim 44, wherein the input face extends at an acute angle to the front guide surface in the case that the input face is on the front side of the input waveguide or to the rear guide surface in the case that the input face is on the rear side of the input waveguide.

46. An anamorphic near-eye display apparatus according to claim 44, wherein the input face extends parallel to the front guide surface in the case that the input face is on the front side of the input waveguide or to the rear guide surface in the case that the input face is on the rear side of the input waveguide.

47. An anamorphic near-eye display apparatus according to claim 46, wherein the input face is coplanar with the front guide surface in the case that the input face is on the front side of the input waveguide or with the rear guide surface in the case that the input face is on the rear side of the waveguide.

48. An anamorphic near-eye display apparatus according to claim 44, wherein the input face is disposed outwardly of one of the front or rear guide surfaces.

49. An anamorphic near-eye display apparatus according to claim 48, wherein the input section further comprises a separation face extending outwardly from the one of the front or rear guide surfaces to the input face.

50. An anamorphic near-eye display apparatus according to claim 42, wherein the input section is integral with the input waveguide.

51. An anamorphic near-eye display apparatus according to claim 42, wherein
the input waveguide has an end that is an input face through which the waveguide is arranged to receive light from the illumination system, and
the input section is a separate element from the waveguide that further comprises an output face and is arranged to direct light reflected by the input reflector through the output face and into the waveguide through the input face of the waveguide.

52. An anamorphic near-eye display apparatus according to claim 1, wherein the transverse anamorphic component comprises a lens.

53. An anamorphic near-eye display apparatus according to claim 1, wherein the input waveguide has an end that is an input face through which the input waveguide is arranged to receive light from the illumination system.

54. An anamorphic near-eye display apparatus according to claim 53, wherein the transverse anamorphic component is disposed outside the waveguide, and the input waveguide is arranged to receive light from the transverse anamorphic component through the input face.

55. An anamorphic near-eye display apparatus according to claim 53, wherein the direction of the optical axis through the transverse anamorphic component is inclined with respect to the front and rear guide surfaces of the input waveguide.

56. An anamorphic near-eye display apparatus according to claim 53, wherein the input end of the input waveguide is inclined with respect to the front and rear guide surfaces of the input waveguide.

57. An anamorphic near-eye display apparatus according to claim 1, wherein the pixels of the spatial light modulator are distributed in the transverse direction so that the light output from the transverse anamorphic component is directed in the directions that are distributed in the transverse direction.

58. An anamorphic near-eye display apparatus according to claim 57, wherein the spatial light modulator comprises pixels having pitches in the lateral and transverse directions with a ratio that is the same as the inverse of the ratio of optical powers of the lateral and transverse anamorphic optical elements.

59. An anamorphic near-eye display apparatus according to claim 1, wherein the illumination system further comprises a deflector element arranged to deflect light output from the transverse anamorphic component by a selectable amount, the deflector element being selectively operable to direct the light output from the transverse anamorphic component in the directions that are distributed in the transverse direction.

60. An anamorphic near-eye display apparatus according to claim 1, wherein front and rear guide surfaces of the input waveguide are planar and parallel.

61. An anamorphic near-eye display apparatus according to claim 1, wherein front and rear guide surfaces of the extraction waveguide are planar and parallel.

62. An anamorphic near-eye display apparatus according to claim 1, wherein front and rear guide surfaces of the intermediate waveguide are planar and parallel.

63. An anamorphic near-eye display apparatus according to claim 1, wherein the reflective extraction features are inclined with respect to the first and second directions along the optical axis.

64. An anamorphic near-eye display apparatus according to claim 63, wherein the reflective extraction features are inclined at the same angle.

65. An anamorphic near-eye display apparatus according to claim 1, wherein the reflective extraction features have a varying pitch along the extraction waveguide.

66. An anamorphic near-eye display apparatus according to claim 1, wherein the reflective extraction features have a varying extent between front and rear guide surfaces of the extraction waveguide.

67. An anamorphic near-eye display apparatus according to claim 1, further comprising a control system arranged to operate the illumination system to provide light input in accordance with image data representing an image.

68. An anamorphic near-eye display apparatus according to claim 1, wherein the reflective extraction arrangement comprises two separated regions, each region being arranged to extract light guided along the extraction waveguide towards a respective eye of the viewer.

69. A head-worn display apparatus comprising an anamorphic near-eye display apparatus according to claim 1 and a head-mounting arrangement arranged to mount the anamorphic near-eye display apparatus on a head of a wearer with the anamorphic near-eye display apparatus extending across at least one eye of the wearer.

70. A head-worn display apparatus according to claim 69, further comprising lenses having optical power, the anamorphic near-eye display apparatus overlying one or each lens.

71. A head-worn display apparatus according to claim 69, wherein the head-worn display apparatus comprises a pair of spectacles.

72. A head-worn display apparatus according to claim 69, wherein the anamorphic near-eye display apparatus is a first anamorphic near-eye display apparatus and the head-worn display apparatus further comprises a second anamorphic near-eye display apparatus, wherein the second anamorphic near-eye display apparatus is arranged in series with the first anamorphic near-eye display apparatus.

73. A head-worn display apparatus according to claim 72, wherein a virtual image distance for light from the second anamorphic near-eye display apparatus is different to a virtual image distance for light from the first anamorphic near-eye display apparatus.

74. A head-worn display apparatus according to claim 69, further comprising a non-anamorphic near-eye display apparatus, wherein
the non-anamorphic near-eye display apparatus comprises a non-anamorphic spatial light modulator and a non-anamorphic magnifying optical system; and wherein
the non-anamorphic near-eye display apparatus is arranged in series with the anamorphic near-eye display apparatus.

75. A head-worn display apparatus according to claim 72, wherein a virtual image distance for light from the non-anamorphic near-eye display apparatus is different from a virtual image distance for light from the anamorphic near-eye display apparatus.

76. An anamorphic directional illumination device comprising:
an illumination system comprising a light source array, the illumination system being arranged to output light; and
an optical system arranged to direct light from the illumination system, wherein the optical system has an optical axis and has anamorphic properties in a lateral direction and a transverse direction that are perpendicular to each other and perpendicular to the optical axis, wherein the light source array comprises light sources distributed in the lateral direction, and the optical system comprises:
a transverse anamorphic component having positive optical power in the transverse direction, wherein the transverse anamorphic component is arranged to receive light from the light source array and the illumination system is arranged so that light output from the transverse anamorphic component is directed in directions that are distributed in the transverse direction;
an input waveguide arranged to receive light from the transverse anamorphic component;
a partially reflective mirror, the input waveguide being arranged to guide light from the transverse anamorphic component to the partially reflective mirror along the input waveguide, and the partially reflective mirror being arranged to reflect at least some of that light;
an intermediate waveguide arranged to receive at least some of the light reflected by the partially reflective mirror,
a lateral anamorphic component having positive optical power in the lateral direction, the intermediate waveguide being arranged to guide the light received from the partially reflective mirror to the lateral anamorphic component along the intermediate waveguide in a first direction;
a light reversing reflector that is arranged to reflect light that has been guided along the intermediate waveguide in the first direction so that the reflected light is guided along the intermediate waveguide in a second direction opposite to the first direction to the partially reflective mirror, the partially reflective mirror being arranged to transmit at least some of that light; and
an extraction waveguide arranged to receive at least some of the light transmitted by the partially reflective mirror that has been guided in the second direction along the intermediate waveguide,
wherein the extraction waveguide comprises at least one reflective extraction feature, the at least one reflective extraction feature being arranged to extract light guided along the extraction waveguide.

77. A vehicle external light device comprising an anamorphic directional illumination device according to claim 76.

78. A vehicle external light apparatus comprising:
a housing for fitting to a vehicle; and
a vehicle external light device according to claim 77 mounted on the housing.
